(19) United States
(12) Patent Application Publication
(10) Pub. No.: US 2020/0407060 A1
(43) Pub. Date: Dec. 31, 2020

(54) NOVEL AIRCRAFT DESIGN USING TANDEM WINGS AND A DISTRIBUTED PROPULSION SYSTEM

(71) Applicant: CRAFT AEROSPACE TECHNOLOGIES, INC., Burbank, CA (US)

(72) Inventor: Kaveh Hosseini, Burbank, CA (US)

(21) Appl. No.: 16/888,431

(22) Filed: May 29, 2020

Related U.S. Application Data
(60) Provisional application No. 62/854,145, filed on May 29, 2019.

(51) Int. Cl. B64C 39/06; B64D 27/24; B64C 11/00; B64C 1/26; B64C 9/14; B64C 13/38; B64C 29/00; B64D 35/02; B64C 11/44; B64D 41/00; B64D 27/10; B64D 27/04; B64C 11/46; G05D 1/10

(52) U.S. Cl. CPC B64C 39/068; B64D 2041/005; B64C 11/001; B64C 1/26; B64C 9/14; B64C 13/38; B64C 29/0025; B64D 35/02; B64C 11/44; B64D 41/00; B64D 27/10; B64D 27/04; B64C 11/46; G05D 1/101; B64D 27/24

(57) ABSTRACT

The subject matter described herein relates to aircraft designs and more particularly to aircraft designs using tandem wings and a distributed propulsion system. The embodiments described enable synergies between aerodynamics, propulsion, structure, and stability/control. In one embodiment, the tandem wings include a first wing set and a second wing set, each having a wing span with a set of thrustors placed along the wing spans.

### CROSS-REFERENCE TO RELATED APPLICATIONS

This application claims priority to U.S. Provisional Application Ser. No. 62/854,145, filed May 29, 2019, which is hereby expressly incorporated by reference in its entirety for all purposes.

### FIELD OF INVENTION

The subject matter described herein relates to aircraft designs and more particularly to aircraft designs using tandem wings, whether such wings are joined swept wings or separate wings, with a distributed propulsion system.

### BACKGROUND

Modern aircraft design is primarily based on two types of designs: fixed-wing or rotary wing. One of the most well-known forms of the fixed-wing aircraft is arguably the transonic jet airplane, an example of which is shown in FIG. 1a. This particular design has had the following features since 1947: swept-back wings, conventional aft-mounted empennage (control surfaces), and jet engines in individual pods hanging below and to the front of the wings (or sometimes to either side of the aft-fuselage). In the case of a rotary wing aircraft, the well-known form is the helicopter, as shown in FIG. 1b. Such rotary wing designs generally include single main rotor and anti-torque tail rotor.

Since the development of these designs, improvements have been largely incremental. Thus, modern aircraft still look very similar to the original designs in concept.

More detail on the state of the art can be found in U.S. Provisional Application Ser. No. 62/854,145, which has been incorporated by reference in its entirety.

Disclosed herein are novel aircraft designs that enable new synergies between aerodynamics, propulsion, structure, and stability/control.

### SUMMARY

Described herein are example aircraft designs that enable synergies between aerodynamics, propulsion, structure, and stability/control. In particular, preferred embodiments of the present invention are directed at an aircraft design with tandem wings, which are preferably joined swept swings. Further included is a distributed propulsion system.

In one embodiment, the tandem wings are joined swept wings that include a first wing set and a second wing set, each having a wing span with a set of thrustors placed along the wing spans.

In other embodiments, the distribution of thrustors are placed along a longitudinal axis, a lateral axis, and a vertical axis to provide a distributed differential thrust system. This can include reverse thrust as well and a corresponding distributed differential lift system to augment or fully replace traditional aerodynamic control surfaces in providing stability and control.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1a is a photo of a fixed wing aircraft known in the art.

FIG. 1b is a photo of a rotary wing aircraft known in the art.

FIG. 2 is a top view of tandem wing configurations in accordance with preferred embodiments of the present invention, using a low-mounted LW and a high-mounted TW.

FIG. 3 is an isometric view of the tandem wing configurations shown in FIG. 2 in accordance with preferred embodiments of the present invention, using a low-mounted LW and a high-mounted TW

FIG. 4 is a top view of tandem wing configurations in accordance with preferred embodiments of the present invention, using a high-mounted LW and a low-mounted TW.

FIG. 5 is an isometric view of the tandem wing configurations shown in FIG. 4 in accordance with preferred embodiments of the present invention, using a high-mounted LW and a low-mounted TW.

FIG. 5a is a top view of various wing configurations in accordance with preferred embodiments of the present invention.

FIG. 5b is a side view of wing configurations in accordance with preferred embodiments of the present invention.

FIG. 6 is an isometric view of a wing configuration in accordance with preferred embodiments of the present invention.

FIG. 7 is a top view of a wing configurations in accordance with preferred embodiments of the present invention.

FIG. 8 is a side view of a wing configurations in accordance with preferred embodiments of the present invention.

FIG. 9 is a front view of a wing configurations in accordance with preferred embodiments of the present invention.

FIG. 10 is a front view of dihedral and anhedral combinations for wing configurations in accordance with preferred embodiments of the present invention.

FIG. 10a is a front view of dihedral and anhedral combinations with a center-mounted single fuselage for wing configurations in accordance with preferred embodiments of the present invention.

FIG. 11 is an isometric view of a BWB configuration in accordance with preferred embodiments of the present invention.

FIG. 12 is a top view of a BWB configuration in accordance with preferred embodiments of the present invention.

FIG. 13 is a side view of a BWB configuration in accordance with preferred embodiments of the present invention.

FIG. 14 is a front view of a BWB configuration in accordance with preferred embodiments of the present invention.

FIG. 15 is an isometric view of a center-mounted double fuselage configuration in accordance with preferred embodiments of the present invention.

FIG. 16 is a top view of a center-mounted double fuselage configuration in accordance with preferred embodiments of the present invention.

FIG. 17 is a side view of a center-mounted double fuselage configuration in accordance with preferred embodiments of the present invention.

FIG. 18 is a front view of a center-mounted double fuselage configuration in accordance with preferred embodiments of the present invention.

FIG. 19 is an isometric view of a wingtip-mounted double fuselage configuration in accordance with preferred embodiments of the present invention.

FIG. 20 is a top view of a wingtip-mounted double fuselage configuration in accordance with preferred embodiments of the present invention.

FIG. 21 is a side view of a wingtip-mounted double fuselage configuration in accordance with preferred embodiments of the present invention.

FIG. 22 is a front view of a wingtip-mounted double fuselage configuration in accordance with preferred embodiments of the present invention.

FIG. 23 is an isometric view of a center-mounted single fuselage configuration in accordance with preferred embodiments of the present invention.

FIG. 24 is a top view of a center-mounted single fuselage configuration in accordance with preferred embodiments of the present invention.

FIG. 25 is a side view of a center-mounted single fuselage configuration in accordance with preferred embodiments of the present invention.

FIG. 26 is a front view of a center-mounted single fuselage configuration in accordance with preferred embodiments of the present invention.

FIG. 27 are isometric views of a triple fuselage configuration and a quadruple fuselage configuration.

FIG. 28 are diagrams of a turboshaft thrustor including a propulsor powered by a combustion turbine and a gearbox transmission and an electric ducted fan thrustor including a propulsor powered by an electric motor and a direct shaft transmission.

FIG. 29 are illustrations of gas turbine configurations.

FIG. 30 are photographs of various propulsors known in the art.

FIG. 31 is a diagram of electric propulsion systems known in the art.

FIG. 32 are photos of various electric aircraft powertrain designs known in the art.

FIG. 33 are photos of various proposed electric aircraft designs known in the art.

FIG. 34 are photos of various existing or proposed electric aircraft designs known in the art.

FIG. 35 is a diagram of general thrustor mounting stations along the span of a wing (lateral position).

FIG. 36 are photos of various aircraft designs known in the art illustrating thrustor mounting stations along the span of a wing.

FIG. 37 is a diagram of general thrustor mounting stations along the chord of a wing (longitudinal position).

FIG. 38 are photos of various aircraft designs known in the art illustrating thrustor mounting stations along the chord of a wing.

FIG. 39 is a diagram of general thrustor mounting stations along the thickness of a wing (vertical position).

FIG. 40 are photos of various aircraft designs known in the art illustrating thrustor mounting stations along the thickness of a wing.

FIG. 41 is a diagram of externally mounted electrofan and electroprop thrustors known in the art.

FIG. 42 are photos of various aircraft designs known in the art illustrating internally-mounted combustion thrustors.

FIG. 43 shows a hollowed-out wing to serve as ducting for an internally-mounted EF.

FIG. 44 shows a propulsor configuration at XMTE along the thickness and at XLE, LMC, and XMC along the chord in accordance with a preferred embodiment of internally-mounted EF configurations.

FIG. 45a shows an extruded duct for an internally-mounted EF.

FIG. 45b shows a set of internally-mounted EFs sharing an extruded duct.

FIG. 46a shows an individual internal duct and a straight row of individual dedicated internal ducts for internally-mounted EF.

FIG. 46b shows a set of internally-mounted EFs with individual dedicated ducts.

FIG. 47 is an isometric view of EFs with individual internal ducts in a BSW with TE section of the wing shown.

FIG. 48 is a top view of EFs with individual internal ducts in a BSW with lower surface section of the wing shown.

FIG. 49 is a front view of EFs with individual internal ducts in a BSW with shared LE inlet between upper and lower surfaces.

FIG. 50 is a rear view of EFs with individual internal ducts in a BSW with split TE outlet.

FIG. 51 shows a dense single-row ET distribution along span and thickness.

FIG. 52 shows a sparse single-row ET distribution along span and thickness.

FIG. 53 shows a dense double-row ET distribution along span and thickness.

FIG. 54 shows a sparse double-row ET distribution along span and thickness.

FIG. 55 shows a dense triple-row ET distribution along span and thickness.

FIG. 56 shows a sparse triple-row ET distribution along span and thickness.

FIG. 57 shows a single-row ET distribution along span and chord (dense on the left and sparse on the right).

FIG. 58 shows a double-row ET distribution along span and chord (dense on the left and sparse on the right).

FIG. 59 shows a triple-row ET distribution along span and chord (dense on the left and sparse on the right).

FIG. 60 shows an isometric view of a wing-fuselage-thrustor configuration in accordance with a preferred embodiment of the present invention featuring 6 EFs.

FIG. 61 shows a top view of a wing-fuselage-thrustor configuration in accordance with a preferred embodiment of the present invention featuring 6 EFs.

FIG. 62 shows a side view of a wing-fuselage-thrustor configuration in accordance with a preferred embodiment of the present invention featuring 6 EFs.

FIG. 63 shows a front view of a wing-fuselage-thrustor configuration in accordance with a preferred embodiment of the present invention featuring 6 EFs.

FIG. 64 shows an isometric view of a wing-fuselage-thrustor configuration in accordance with a preferred embodiment of the present invention featuring 14 EFs.

FIG. 65 shows a top view of a wing-fuselage-thrustor configuration in accordance with a preferred embodiment of the present invention featuring 14 EFs.

FIG. 66 shows a side view of a wing-fuselage-thrustor configuration in accordance with a preferred embodiment of the present invention featuring 14 EFs.

FIG. 67 shows a front view of a wing-fuselage-thrustor configuration in accordance with a preferred embodiment of the present invention featuring 14 EFs.

FIG. 68 shows an isometric view of a wing-fuselage-thrustor configuration in accordance with a preferred embodiment of the present invention featuring 30 EFs.

FIG. 69 shows a top view of a wing-fuselage-thrustor configuration in accordance with a preferred embodiment of the present invention featuring 30 EFs.

FIG. 70 shows a side view of a wing-fuselage-thrustor configuration in accordance with a preferred embodiment of the present invention featuring 30 EFs.

FIG. 71 shows a front view of a wing-fuselage-thrustor configuration in accordance with a preferred embodiment of the present invention featuring 30 EFs.

FIG. 72 shows an isometric view of a wing-fuselage-thrustor configuration in accordance with a preferred embodiment of the present invention featuring 6 EPs.

FIG. 73 shows a top view of a wing-fuselage-thrustor configuration in accordance with a preferred embodiment of the present invention featuring 6 EPs.

FIG. 74 shows a side view of a wing-fuselage-thrustor configuration in accordance with a preferred embodiment of the present invention featuring 6 EPs.

FIG. 75 shows a front view of a wing-fuselage-thrustor configuration in accordance with a preferred embodiment of the present invention featuring 6 EPs.

FIG. 76 shows an isometric view of a wing-fuselage-thrustor configuration in accordance with a preferred embodiment of the present invention featuring 12 EPs and 2 EFs.

FIG. 77 shows a top view of a wing-fuselage-thrustor configuration in accordance with a preferred embodiment of the present invention featuring 12 EPs and 2 EFs.

FIG. 78 shows a side view of a wing-fuselage-thrustor configuration in accordance with a preferred embodiment of the present invention featuring 12 EPs and 2 EFs.

FIG. 79 shows a front view of a wing-fuselage-thrustor configuration in accordance with a preferred embodiment of the present invention featuring 12 EPs and 2 EFs.

FIG. 80 shows an isometric view of a wing-fuselage-thrustor configuration in accordance with a preferred embodiment of the present invention featuring 60 internally-mounted EFs and 10 externally-mounted EFs.

FIG. 81 shows a top view of a wing-fuselage-thrustor configuration in accordance with a preferred embodiment of the present invention featuring 60 internally-mounted EFs and 10 externally-mounted EFs.

FIG. 82 shows a side view of a wing-fuselage-thrustor configuration in accordance with a preferred embodiment of the present invention featuring 60 internally-mounted EFs and 10 externally-mounted EFs.

FIG. 83 shows a zoomed front view of a wing-fuselage-thrustor configuration in accordance with a preferred embodiment of the present invention featuring 60 internally-mounted EFs and 10 externally-mounted EFs.

FIG. 84 shows a front view of a wing-fuselage-thrustor configuration in accordance with a preferred embodiment of the present invention featuring 60 internally-mounted EFs and 10 externally-mounted EFs.

FIG. 85 shows a zoomed perspective view of a wing-fuselage-thrustor configuration in accordance with a preferred embodiment of the present invention featuring 60 internally-mounted EFs and 10 externally-mounted EFs.

FIG. 86 shows a diagram of an aircraft's axes, moments, and forces.

FIG. 87 is a photo of an Airbus A400M variable pitch propeller.

FIG. 88 is a photo of an F-15's variable geometry exhaust nozzles.

FIG. 89 is a photo of a vectored thrust ducted propeller on the Piasecki X-49 SpeedHawk.

FIG. 90 is a diagram of a Gimbal-mounted rocket engine.

FIG. 91 is an isometric view of pitch down control via differential thrust of 2 high-mounted vs. 2 low-mounted ETs

FIG. 92 is a top view of pitch down control via differential thrust of 2 high-mounted vs. 2 low-mounted ETs

FIG. 93 is a side view of pitch down control via differential thrust of 2 high-mounted vs. 2 low-mounted ETs

FIG. 94 is a front view of pitch down control via differential thrust of 2 high-mounted vs. 2 low-mounted ETs

FIG. 95 is an isometric view of pitch down control via differential thrust of 14 high-mounted vs. 14 low-mounted ETs

FIG. 96 is a top view of pitch down control via differential thrust of 14 high-mounted vs. 14 low-mounted ETs

FIG. 97 is a side view of pitch down control via differential thrust of 14 high-mounted vs. 14 low-mounted ETs

FIG. 98 is a front view of pitch down control via differential thrust of 14 high-mounted vs. 14 low-mounted ETs

FIG. 99 is an isometric view of fine pitch down control via differential thrust of 2 high-mounted vs. 2 low-mounted ETs

FIG. 100 is an top view of fine pitch down control via differential thrust of 2 high-mounted vs. 2 low-mounted ETs

FIG. 101 is a side view of fine pitch down control via differential thrust of 2 high-mounted vs. 2 low-mounted ETs

FIG. 102 is a front view of fine pitch down control via differential thrust of 2 high-mounted vs. 2 low-mounted ETs

FIG. 103 is an isometric view of drastic pitch down control via differential thrust of 2 high-mounted ETs vs. 2 low-mounted ETs in thrust reversal mode

FIG. 104 is a top view of drastic pitch down control via differential thrust of 2 high-mounted ETs vs. 2 low-mounted ETs in thrust reversal mode

FIG. 105 is a side view of drastic pitch down control via differential thrust of 2 high-mounted ETs vs. 2 low-mounted ETs in thrust reversal mode

FIG. 106 is a front view of drastic pitch down control via differential thrust of 2 high-mounted vs. 2 low-mounted ETs

FIG. 107 is an isometric view of pitch up control via differential thrust of 2 high-mounted ETs vs. 2 low-mounted ETs

FIG. 108 is an isometric view of drastic pitch up control via differential thrust of 2 high-mounted ETs in thrust reversal mode vs. 2 low-mounted ETs

FIG. 109 is an isometric view of yaw to starboard control via differential thrust of wingtip mounted ETs.

FIG. 110 is a top view of yaw to starboard control via differential thrust of wingtip mounted ETs.

FIG. 111 is an isometric view of drastic yaw to starboard control via thrust reversal of starboard wingtip-mounted ET.

FIG. 112 is a top view of drastic yaw to starboard control via thrust reversal of starboard wingtip-mounted ET.

FIG. 113 is an isometric view of roll to port control via differential thrust and induced lift of midspan-mounted ETs.

FIG. 114 is a front view of roll to port control via differential thrust and induced lift of midspan-mounted ETs.

FIG. 115 is an isometric view of drastic roll to port control via differential thrust and induced lift of midspan-mounted ETs including thrust reversal of port midspan-mounted ETs.

FIG. 116 is a front view of drastic roll to port control via differential thrust and induced lift of midspan-mounted ETs using thrust reversal of port midspan-mounted ETs.

FIG. 117 is an illustration of slipping turn, coordinated turn, and skidding turn.

FIG. 118 is a diagram of conventional takeoff and landing.

FIG. 119 show examples of LE and TE high-lift devices.

FIG. 120 illustrates effects of flaps and slats on the lift coefficient.

FIG. 121 illusrates powered lift chronology.

FIG. 122 shows an aircraft known in the art.

FIG. 123 shows an aircraft known in the art.

FIG. 124 shows an aircraft known in the art.

FIG. 125 shows an aircraft known in the art.

FIG. 126 shows an aircraft known in the art.

FIG. 127 shows an aircraft known in the art.

FIG. 128 shows various combinations of ground roll and climb qualifying as STOL takeoff.

FIG. 129 shows an aircraft known in the art.

FIG. 130 shows an aircraft known in the art.

FIG. 131 shows an aircraft known in the art.

FIG. 132 shows an aircraft known in the art.

FIG. 133 shows an aircraft known in the art.

FIG. 134 shows an aircraft known in the art.

FIG. 135 shows an aircraft known in the art.

FIG. 136 shows an aircraft known in the art.

FIG. 137 shows an aircraft known in the art.

FIG. 138 shows an aircraft known in the art.

FIG. 139 shows a distributed mechanical shaft power system known in the art.

FIG. 140 shows an aircraft known in the art.

FIG. 141 shows an aircraft known in the art.

FIG. 142 shows an aircraft known in the art.

FIG. 143 shows an aircraft known in the art.

FIG. 144 shows an aircraft known in the art.

FIG. 145 shows an aircraft known in the art.

FIG. 146 shows an aircraft known in the art.

FIG. 147 shows an aircraft known in the art.

FIG. 148 illustrates helicopter normal takeoff from hover.

FIG. 149 illustrates helicopter maximum performance takeoff.

FIG. 150 illustrates heliport approach/departure and transitional surfaces.

FIG. 151 illustrates curved approach/departure and transitional surfaces.

FIG. 152 shows an aircraft known in the art.

FIG. 153 shows an aircraft known in the art.

FIG. 154 shows an aircraft known in the art.

FIG. 155 shows an aircraft known in the art.

FIG. 156 shows an aircraft known in the art.

FIG. 157 shows an aircraft known in the art.

FIG. 158 is a sideview of a wing configuration with deflected slipstream in accordance with preferred embodiments of the present invention.

FIG. 159 is a perspective view of a wing configuration with deflected slipstream in accordance with preferred embodiments of the present invention.

FIG. 160 shows LE and TE high-lift devices in accordance with preferred embodiments of the present invention.

FIG. 161 shows a rear ¾ perspective view of a wing configuration with extended LE and TE high-lift devices in accordance with preferred embodiments of the present invention.

FIG. 162 is an isometric view of a wing configuration with extended LE & TE high-lift devices in accordance with preferred embodiments of the present invention.

FIG. 163 is a top view of a wing configuration with extended LE & TE high-lift devices in accordance with preferred embodiments of the present invention.

FIG. 164 is a side view of a wing configuration with extended LE & TE high-lift devices in accordance with preferred embodiments of the present invention.

FIG. 165 is a front view of a wing configuration with extended LE & TE high-lift devices in accordance with preferred embodiments of the present invention.

FIG. 166 is a side illustration of hover in-place using reverse thrust from wingtip thrustors using a wing configuration in accordance with preferred embodiments of the present invention.

FIG. 167 shows an internal EF with high-lift devices in normal operation (forward thrust) using a wing configuration in accordance with preferred embodiments of the present invention.

FIG. 168 shows an internal EF with high-lift devices in high-lift mode using a wing configuration in accordance with preferred embodiments of the present invention.

FIG. 169 shows an internal EF in shutdown low-drag cruise mode using a wing configuration in accordance with preferred embodiments of the present invention.

FIG. 170 shows an aircraft known in the art.

FIG. 171 shows an aircraft known in the art.

FIG. 172 shows an aircraft known in the art.

FIG. 173 shows an aircraft known in the art.

FIG. 174 illustrates an aircraft in accordance with a preferred embodiment of the present invention.

FIG. 175 illustrates an aircraft in accordance with a preferred embodiment of the present invention.

FIG. 176 illustrates an aircraft in accordance with a preferred embodiment of the present invention.

FIG. 177 illustrates an aircraft in accordance with a preferred embodiment of the present invention.

FIG. 178 is a sideview of an aircraft in accordance with a preferred embodiment of the present invention.

FIG. 179 is a top view of an aircraft in accordance with a preferred embodiment of the present invention.

FIG. 180 is an isometric view of an aircraft in accordance with a preferred embodiment of the present invention.

FIG. 181 is a front view of an aircraft in accordance with a preferred embodiment of the present invention.

FIG. 182 is a rear view of an aircraft in accordance with a preferred embodiment of the present invention.

FIG. 183 is an isometric view of an aircraft in accordance with a preferred embodiment of the present invention.

FIG. 184 is a side view of an aircraft with extended flaps in accordance with a preferred embodiment of the present invention.

FIG. 185 is a front view of an aircraft with extended flaps in accordance with a preferred embodiment of the present invention.

FIG. 186 is a rear view of an aircraft with extended flaps in accordance with a preferred embodiment of the present invention.

FIG. 187 is a top view of an aircraft with extended flaps in accordance with a preferred embodiment of the present invention.

FIG. 188 is an isometric view of an aircraft with extended flaps in accordance with a preferred embodiment of the present invention.

FIG. 189 is an isometric view of an aircraft with extended flaps in accordance with a preferred embodiment of the present invention.

FIG. 190 is an isometric view of an aircraft with extended flaps in accordance with a preferred embodiment of the present invention.

FIG. 191 is an isometric view of an aircraft in accordance with a preferred embodiment of the present invention.

FIG. 192 is a top view of an aircraft in accordance with a preferred embodiment of the present invention.

FIG. 193 is a front view of an aircraft in accordance with a preferred embodiment of the present invention.

FIG. 194 is a side view of an aircraft in accordance with a preferred embodiment of the present invention.

FIG. 195 are illustrations of an aircraft in accordance with a preferred embodiment of the present invention.

FIG. 196a are illustrations of aircrafts in accordance with a preferred embodiment of the present invention.

FIG. 196b are illustrations of aircrafts in accordance with a preferred embodiment of the present invention.

FIG. 197 is a diagram of the components of an aircraft in accordance with preferred embodiments of the present invention.

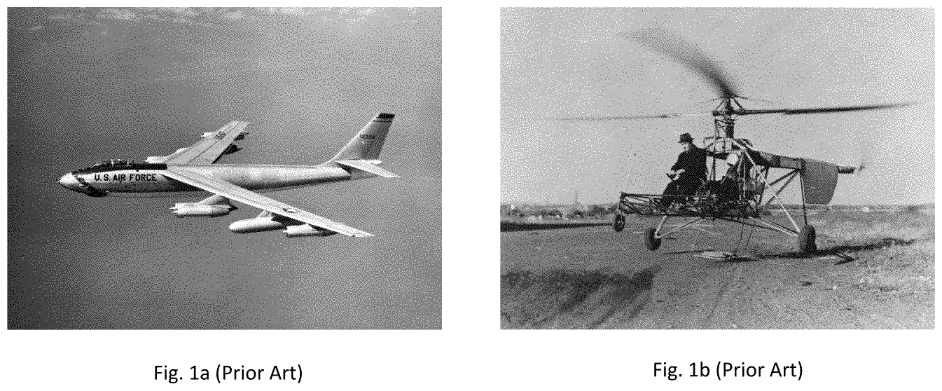

### DETAILED DESCRIPTION

Described herein are example aircraft designs that enable synergies between aerodynamics, propulsion, structure, and stability/control. Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a,” “an,” and “the” include plural referents unless the context clearly dictates otherwise.

Terminology

| | |
|---|---|
| Aircraft | All flying machines whether they have fixed wings |
| | (e.g. airplanes), rotary wings (e.g. helicopters), |
| | lifting bodies, or any other aerodynamic surfaces |
| | that produce lift. Although this can include |
| | lighter-than-air (e.g. airships), for the purpose |
| | of this document, the primary focus will be |
| | heavier-than-air aircraft. |
| Airplane | Fixed wing aircraft. |
| Convertiplane | An aircraft using rotor lift for vertical takeoff |
| | and landing, converting to fixed-wing lift in |
| | horizontal cruise flight. This includes tilt-wing |
| | and tilt-rotor aircraft. |
| Fan | Short for “ducted fan”. A ducted rotary blade |
| | system that provides horizontal thrust (unless |
| | specified otherwise). |
| Liftfan | Ducted rotary blade system optimized for vertical |
| | lifting/hovering capability. |
| Propeller | Short for aircraft propeller (unless specified |
| | otherwise). Small-sized rotary blade system that |
| | provides forward thrust for an aircraft. |
| Proprotor | A hybrid between a propeller and a rotor. Medium- |
| | sized rotary blades used as both an airplane-style |
| | propeller and a helicopter-style rotor, for example |
| | in the case of a tiltrotor or tiltwing |
| | convertiplane. They typically appear oversized |
| | compared to traditional airplane propellers and |
| | undersized compared to traditional helicopter main |
| | rotors. |
| Propulsor | A rotary blade system (including its associated |
| | ducting if any) that creates thrust by increasing |
| | the velocity and/or pressure of a column of fluid |
| | including propellers, ducted fans, rotors, |
| | proprotors, etc. Ideally, the word propulsor |
| | applies only to the rotary blade system and |
| | excludes the engine/motor and transmission that |
| | power the shaft of the system. |
| Rotor | Short for helicopter main rotor or drone rotor |
| | (unless specified otherwise such as tail anti- |
| | torque rotor). Rotary blade system optimized for |
| | vertical lifting/hovering capability. |
| Rotorcraft | Rotary wing aircraft, often a helicopter. |
| Thrustor | A system that includes a propulsor plus the motor |
| | that drives its shaft, plus a direct or geared |
| | transmission. Typical examples are a turbofan |
| | engine, a turboprop engine (including its |
| | propeller), an electric ducted fan in a model |
| | aircraft, etc. |

Acronyms

| Acronym | Definition |
|---|---|
| AoA | Angle of Attack. |
| BL | Boundary Layer. |
| BLI | Boundary Layer Ingestion. |
| BPR | Bypass Ratio (of a turbofan engine). |
| BSW | Backward-Swept Wing. |
| BWB | Blended Wing-Body. |
| CG | Center of Gravity. |
| CTOL | Conventional Take-Off and Landing. |
| DEP | Distributed Electric Propulsion. |
| DOD | (US) Department of Defense |
| EDF | Electric Ducted Fan. Same as EF. |
| EDPR | Electric ducted proprotor. |
| EF | Electric fan or electrofan. Same as EDF. |
| | The electric counterpart to the turbofan engine. |
| ELF | Electric liftfan. |
| EP | Electric propeller or electroprop. |
| | The electric counterpart to the turboprop engine. |
| EPR | Electric proprotor. |
| ER | Electric Rotor. |
| ET | Electric thrustor. |
| eVTOL | Electric Vertical Take-Off and Landing. |
| FAA | Federal Aviation Administration. |
| FSW | Forward-Swept Wing. |
| ICAO | International Civil Aviation Organization. |
| JSW | Joined Swept Wings. |
| JW | Joined Wings. |
| LE | Leading Edge. |
| LSA | Light Sport Aircraft |
| LW | Leading Wing. |
| MDLW | Maximum design landing weight. |
| MTOW | Maximum takeoff weight. |
| NATO | North Atlantic Treaty Organization. |
| RC | Radio Control. |
| RPM | Revolutions Per Minute. |
| STOL | Short Take-Off and Landing. |
| STOVL | Short Take-Off and Vertical Landing. |
| | Sometimes used on aircraft carriers. Takeoff is |
| | accomplished using a short runway with a ramp at the end. |
| | Landing is accomplished vertically. |
| TE | Trailing Edge. |
| TW | Trailing Wing. |
| UAM | Urban Air mobility. |
| USW | Un-swept wing (straight wing). |
| V/STOL | Vertical and/or short take-off and landing aircraft. |
| | The aircraft has the option to choose whether it wants |
| | to take off and/or land in short mode or vertical mode |
| | depending on runway availability and fuel-efficiency |
| | requirements. |
| VTOL | Vertical Take-Off and Landing. |
| XSTOL | Extreme(ly) Short Take-Off and Landing. |

I. Wing configurations

Tandem/Joined Wings

Most traditional aircraft use a wing mounted mid-fuselage and a horizontal stabilizer (also named tailplane) mounted aft-fuselage. The wing produces upward lift while the tailplane usually produces downward lift for stability and control. Some less conventional designs use two sets of wings instead:

A set of front-mounted leading wings or LW

A set of aft-mounted trailing wings or TW

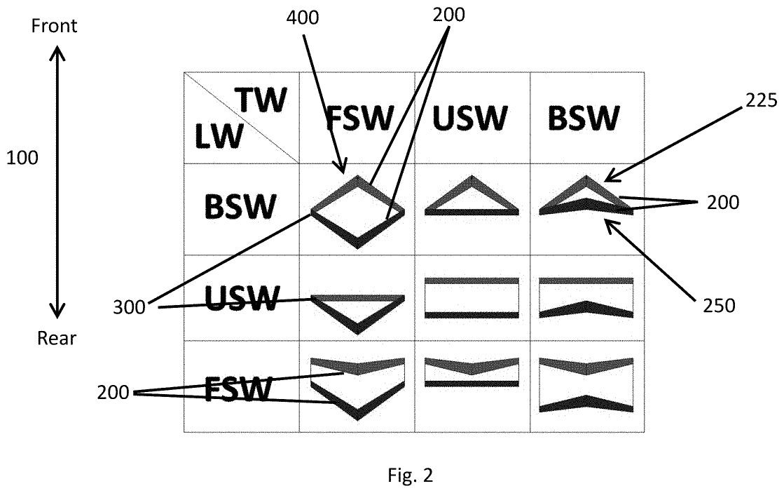

When the LW is much smaller than the TW, it is known in the art as a canard. When the LW and the TW are similar in size, the configuration is called a tandem wing. Joined wings 200 (JW) are a special case of the canard or the tandem wing 200 configuration where the LW and TW are joined at the wingtips by shared winglets 300, as shown in FIG. 2, as an example.

Wing Sweep and Mounting Location

In a JW configuration, one or both wings 200 can be swept forward (FSW), swept backward (BSW), or un-swept (straight) (USW). Also, in most JW configurations, one of the wings 200 is mounted high on the fuselage (not shown) while the other one is mounted low. FIGS. 2, 3, 4, and 5 show eighteen possible configurations in terms of sweep and mounting locations in accordance with embodiments of the present invention.

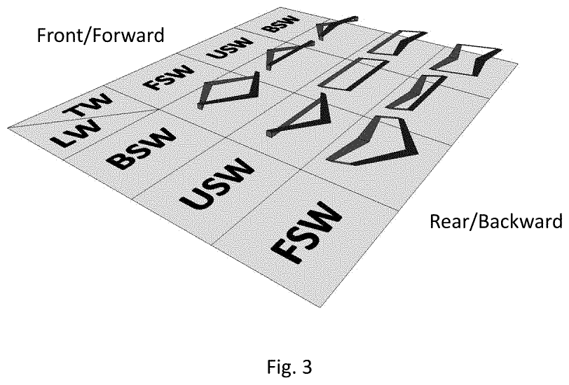

FIGS. 2 and 3 show nine configurations where the LW is low-mounted (wings 200 at 225 for each configuration) while the TW is high-mounted (wings 200 at 250 for each configuration), using nine combinations of backward-swept (BSW), un-swept (USW), and forward-swept (FSW) choices. These low-LW with high-TW configurations 150 ensure that the downwash from the LW is not affecting the TW in level flight. Care must be applied in the detailed design of any specific application of these wing configurations such that the TW is not negatively impacted by the wake of the LW in situations requiring flight at high angles of attack (AoA).

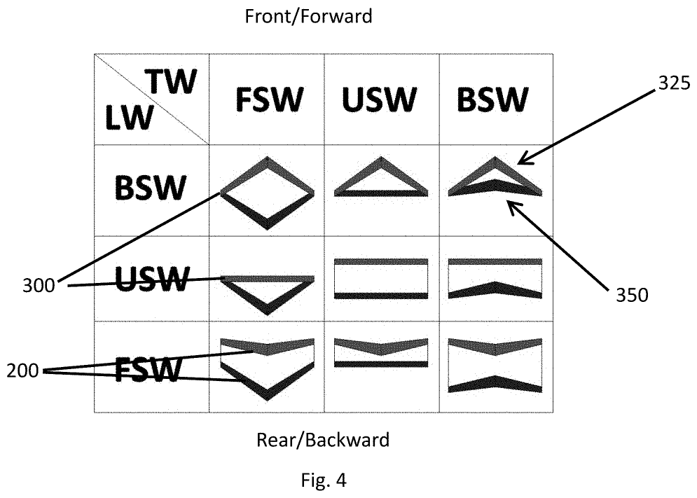

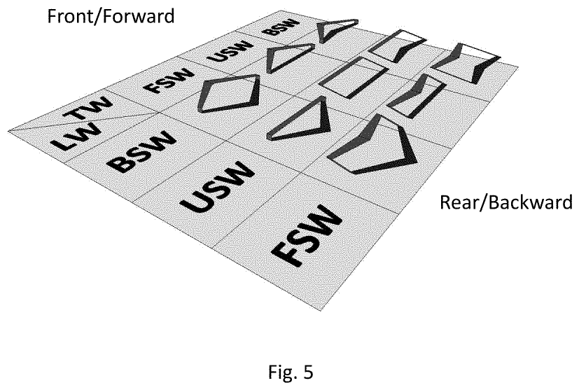

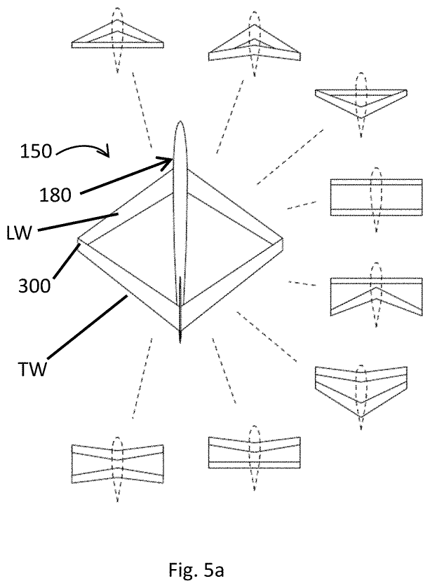

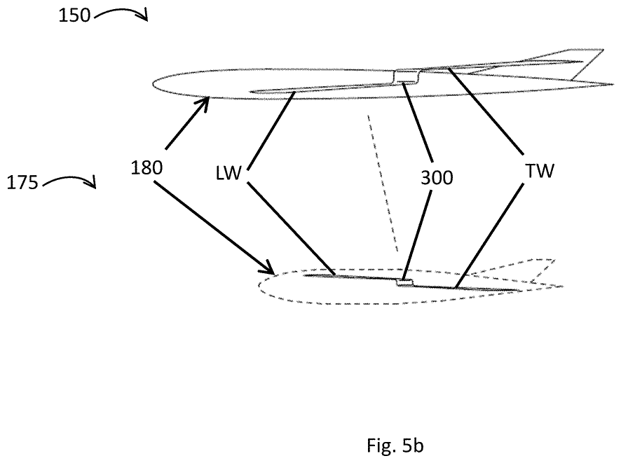

Alternatively, the LW can be high-mounted (wings 200 at 325 for each configuration), and the TW can be low-mounted (wings 200 at 350 for each configuration) as shown in the nine configurations of FIGS. 4 and 5. These configurations 175 avoid or diminish the high-AoA wake problem described above, but care must be applied such that the TW is mounted at an incidence angle that ensures the downwash from the LW is taken into consideration.

Joining the LW to the TW in some of the configurations above result in very stretched winglets 300 along the longitudinal axis 100 of FIG. 2. To minimize negative interactions between the wings 200 while keeping the winglets 300 small, one preferable approach is where the LW is a low-mounted Backward-Swept Wing (BSW) while the TW is a high-mounted Forward-Swept Wing (FSW), configuration at 400 in FIG. 2. The following description will focus on this particular configuration 400, which, as one of ordinary skill in the art would appreciate, is one of several possible configurations in accordance with embodiments of the present invention.

Turning to FIG. 5a, wing configurations described above are shown with a fuselage 180 (top view). The center-mounted single fuselage design 150 shows wing configuration 400 (with a low-mounted, backward-swept BSW leading wing LW and a high-mounted, forward-swept FSW trailing wing TW, connected at winglets 300). The surrounding designs correspond to other wing configurations shown in the tables (FIGS. 2, 3, 4 & 5) with a center-mounted single fuselage 180.

Turning to FIG. 5b, wing configuration designs 150 and 175 are shown, in sideview, illustrating the different configurations above with a center-mounted single fuselage 180. Aircraft 150 shows a wing configuration with a low-mounted leading wing, LW, and a high-mounted trailing wing, TW, connected at winglet 300 (see also FIGS. 2 and 3). Aircraft 175 shows a wing configuration with a high-mounted leading wing, LW, and a low-mounted trailing wing, connected at winglet 300 (see also FIGS. 4 and 5).

Joined Swept Wings (JSW) of Configuration 400

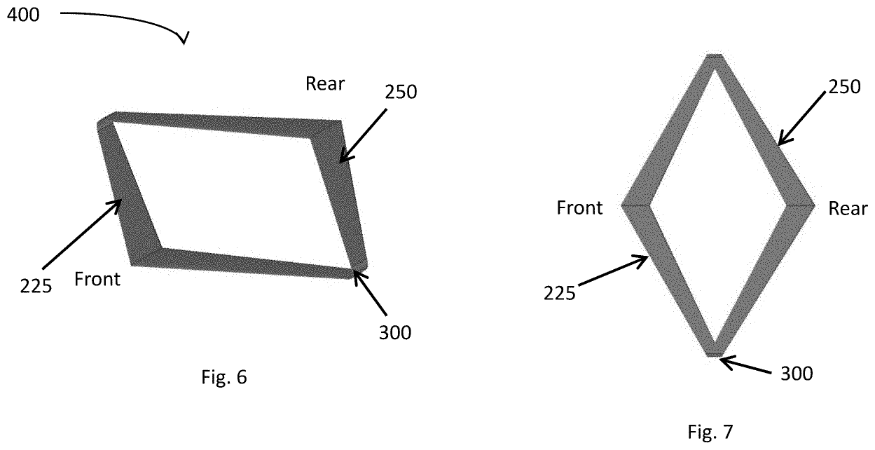

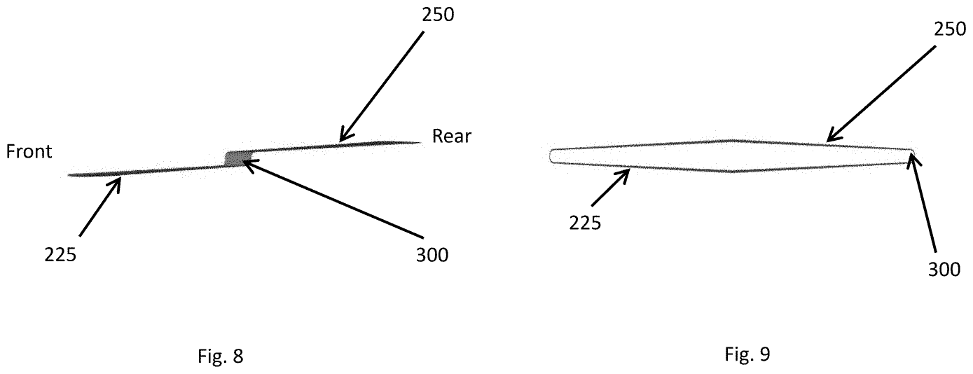

One feature of configuration 400 is the use of joined swept wings 200 as shown in FIGS. 6, 7, 8, and 9. The aircraft uses at least two sets of wings 200 as follows:
A low-mounted LW 225 in BSW configuration at the front;
A high-mounted TW 250 in FSW configuration at the rear;
The wings 200 are joined at the wingtips through shared winglets 300.

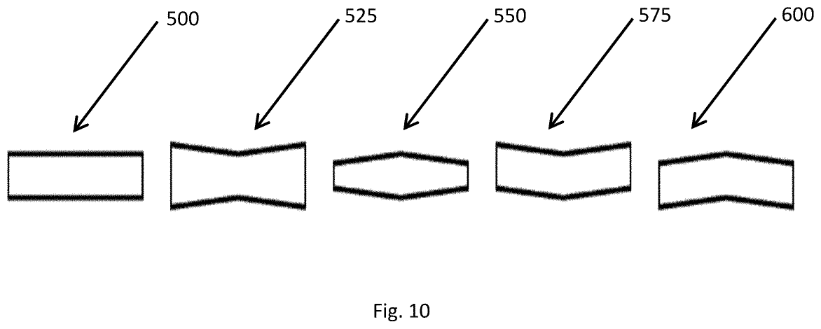

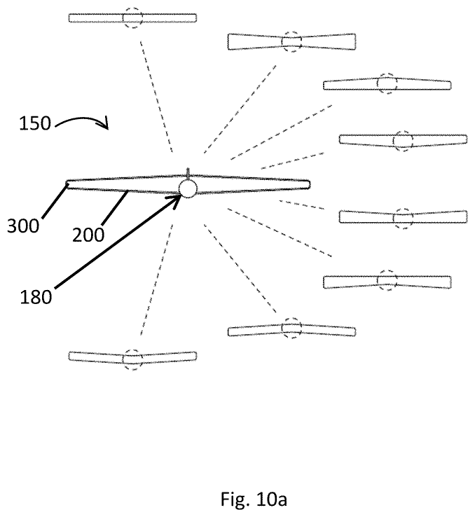

Note that in the configuration 400 shown in FIGS. 6, 7, 8, and 9, the LW 225 features dihedral while the TW 250 features anhedral. This is just one example. The adequate dihedral or anhedral on each wing set 200 can depend on the final configuration of each application as a function of control and stability requirements, CG position, etc. Alternate configurations are shown in FIG. 10. From left to right, zero dihedral/anhedral 500, anhedral on low-mounted wing and dihedral on high-mounted wing 525, dihedral on low-mounted wing and anhedral on high-mounted wing 550, dihedral on both low-mounted and high-mounted wings 575, and anhedral on both low-mounted and high-mounted wings 600. Turning to FIG. 10a, wing configurations just described are shown with a center-mounted single fuselage 180 (front view). The center-mounted single fuselage design 150 shows possible high mounted and low mounted wing 200 configurations connected at winglet 300. The surrounding designs show other possible high mounted and low mounted wing configurations featuring various combinations of the dihedral and anhedral mounting angles.

Some of the advantages of using these configurations, including configuration 400 include:

Structure: The joined wings 200 constitute a very strong and stiff structure with great strength in torsion and bending. This may reduce the structural mass and complexity, in particular compared to traditional cantilevered wings.

This structure may allow for shorter chords, therefore the distribution of the total wing lifting area between four very high aspect ratio wings instead of wings with larger chords and shorter aspect ratios. The high aspect ratio will reduce lift-induced drag and can potentially allow for total aircraft L/D much higher than 20. As an example, competition gliders with very high aspect ratio wings commonly reach L/D in excess of 60-70.

This structure may also allow for thinner roots, which will in turn reduce drag. In particular, it may reduce the need to adopt very high sweep angles for transonic flight.

The shorter chord may allow for designs that avoid separation and/or turbulent flow, thus reducing both form drag and friction drag.

The distribution of propulsion (which preferably may be electric) as described infra may reduce the chances of stall and may allow for roll control without the need for ailerons, therefore reducing the need for wings 200 with large surface areas, effectively reducing structural mass and friction drag.

Both the LW 225 and the TW 250 (FIGS. 3, 6, 7, 8, & 9) will be lifting wings, as in the case of aircraft in canard configuration, and as opposed to the traditional empennage where the horizontal stabilizer produces negative lift. Once again, the wings 200 of configuration 400 as a whole may require less lifting area.

Having swept wings 200 may also provide the capability to fly fast, up to transonic speeds, due to the presence of sweep in the wings. Supersonic flight may also be possible with the right combination of sweep angle, airfoil choice and thickness, propulsion inlet and exhaust design, etc.

II. Fuselage configurations

FIGS. 6, 7, 8, and 9 show wings 200 without any fuselages or control surfaces. Further, the proportions, dimensions, angles, and aspect ratios may change as a function of a specific application. In particular, note that these configurations, including configuration 400 may be adapted and adjusted to a wide range of scales from handheld remote-control drones to large passenger aircraft, as examples.

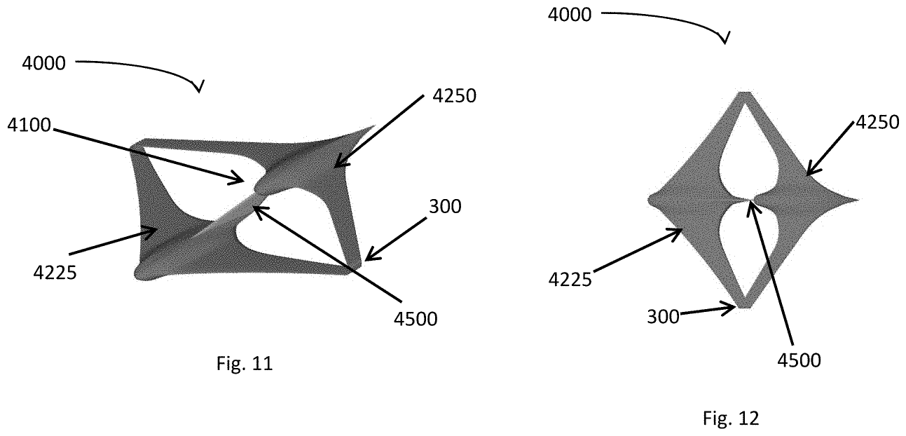

An example fuselage 4100 is shown in FIG. 11. The fuselage 4100 is typically an enclosure that holds part or all of the useful load, in addition to all the mechanisms necessary for the aircraft's operation such as avionics, actuators, electric cables, pneumatics, hydraulics, mechanical cables, rods, pulleys, environmental control and life support (ECLS), amenities, etc. The useful load is usually divided into payload and energy storage. Payload can be passengers, cargo, or a mixture. Energy storage compartments are typically in the form of chemical fuel in tanks, or electric batteries in packs. Energy storage compartments can be placed within the fuselage and/or any other enclosure other than the fuselage such as the interior of the wings, external tanks, etc.

Double Blended Wing (BWB)

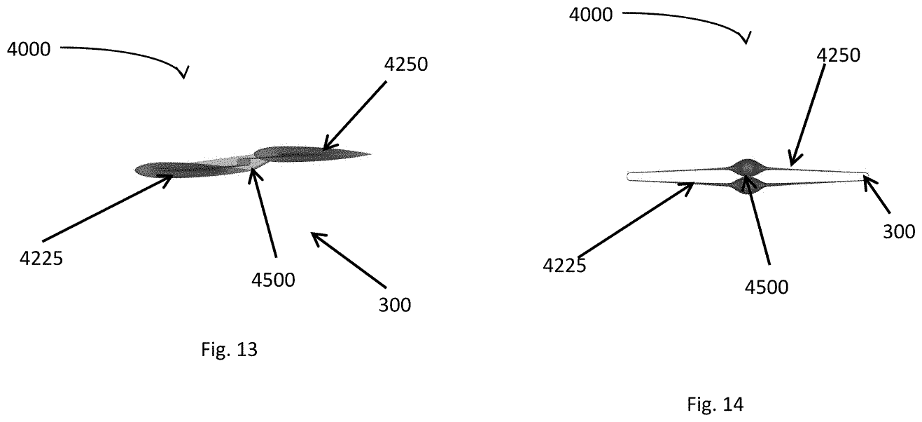

One aspect of a preferred embodiment combines aerodynamic advantages with structural ones, which is known in the art as flying wing or Blended-Wing Body (BWB), in which the fuselage 4100 and the wing 4225 are blended together. The B-2 bomber is a well-known BWB example. In this configuration the fuselage produces lift instead of being just dead mass. Also, the structural stresses at the wing root (wing-fuselage junction) do not sharply increase as in the case of all current transonic airplanes. Even though the single BWB by itself is a good candidate for distributed propulsion, the JSW configuration provides better distributed control authority and potentially V/STOL advantages. As shown in FIGS. 11, 12, 13, and 14, wing configuration 400 is shown with a BWB fuselage 4100 structure.

In this configuration 4000, there is a front-mounted BWB using BSW 4225 connected to an aft-mounted BWB using FSW 4250. The two sets of wings 4225 and 4250 are connected by shared winglets 300 at the wing tips as well as along the centerline of the aircraft 4000 by a structural element 4500 that can simultaneously act as structural stiffener, vertical stabilizer, and a conduit for all connections such as cables, piping, etc.

Center-Mounted Double Fuselage

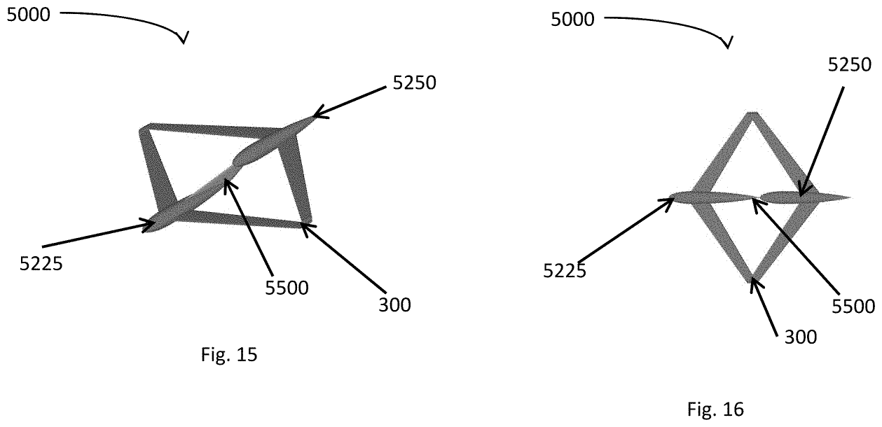

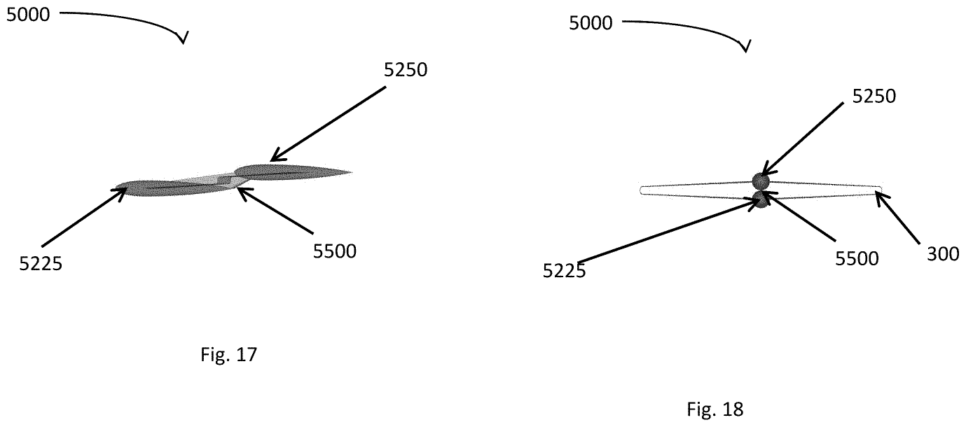

FIGS. 15, 16, 17, and 18 show a center-mounted double fuselage configuration 5000. It is similar to the double BWB configuration 4000, but has more traditional fuselage pods that do not blend with the wings. It features a front fuselage at the LW 5225, an aft-mounted fuselage at the TW 5250, and a structural element 5500 providing the same benefits as in the BWB configuration 5000.

Some of its potential advantages are:
More modular design;
Ease of manufacturing and assembly;
Lower induced drag due to high aspect ratio wings;
Lower friction drag due to reduced wetted area;
Laminar flow airfoil due to short chord wings;
Segregation of payload volume from equipment volume (energy storage, avionics, power electronics, etc.) for increased safety and ease of service and maintenance;
Note that the front fuselage 5225 tapers off before the aft fuselage 5250 starts, ensuring good control of form drag as the longitudinal cross-section of the aircraft 5000 varies smoothly.

Wingtip-Mounted Double Fuselage

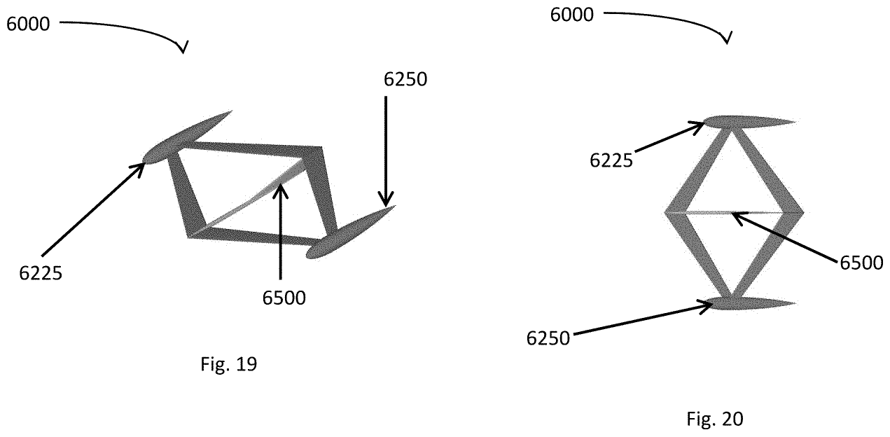

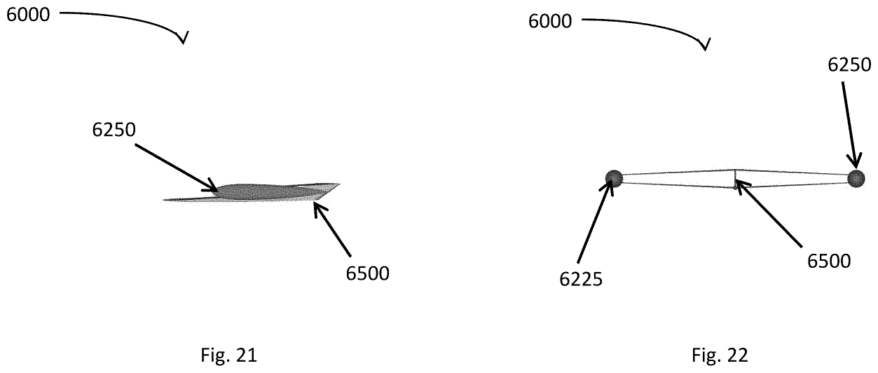

FIGS. 19, 20, 21, and 22 show a wingtip-mounted double fuselage configuration 6000. This configuration 6000 is similar to the center-mounted double fuselage configuration 5000 and has many of the same advantages. One fuselage is mounted at the starboard wingtip 6225, the other at the port wingtip 6250, and a structural element 6500 provides the same benefits as in the BWB 4000 and center-mounted double fuselage 5000 configurations.

Potential advantages:
The ability to mount large propulsors at the wingtips for increased yaw authority.
Strengthening of wing junctions at winglets.

Center-Mounted Single Fuselage

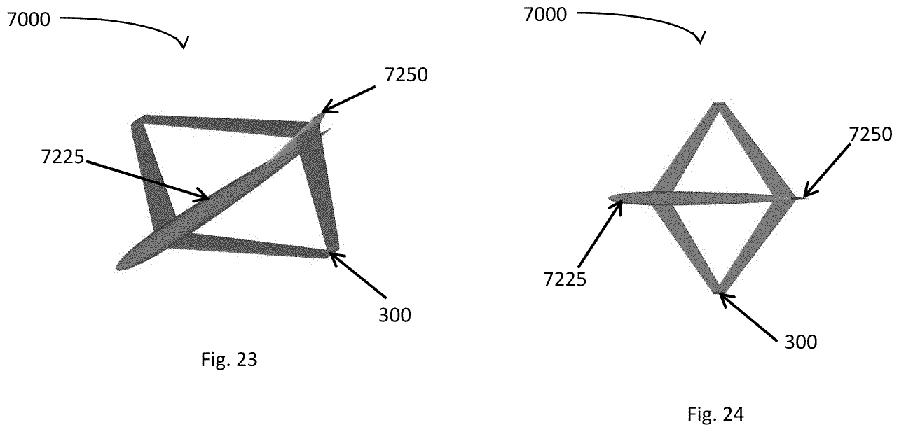

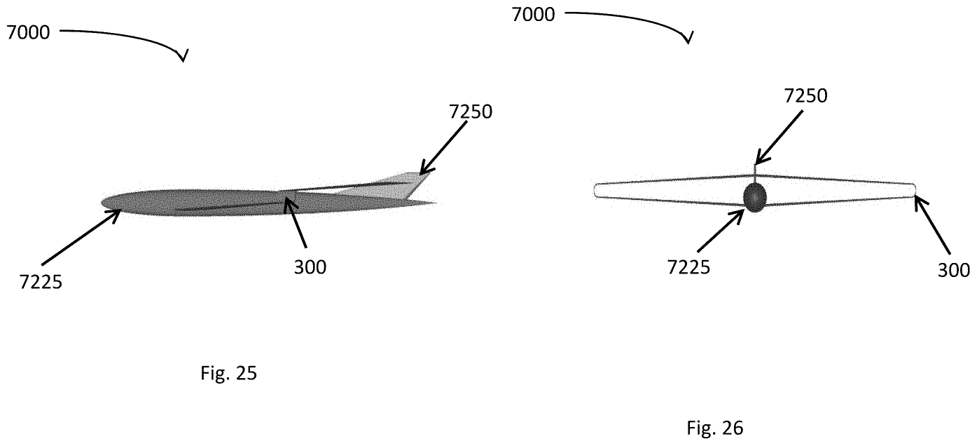

FIGS. 23, 24, 25, and 26 show a center-mounted single fuselage configuration 7000. This configuration 7000 is conventional in terms of fuselage design with wing configuration 400 and practical in terms of manufacturing. It features a single long fuselage along the centerline 7225 and a structural element 7250 that can simultaneously act as structural stiffener and a vertical stabilizer. It features most of the advantages of the previous configurations while keeping form drag low. It retains the simplicity found in most other airplane fuselages.

Other Fuselage Configurations

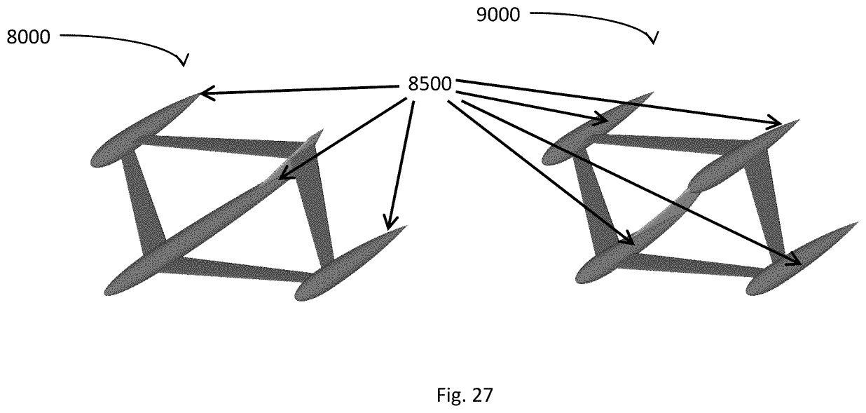

Shown in FIG. 27 are configurations 8000 and 9000, which combine some of the advantages of the above configurations. Configuration 8000 includes 3 segregated fuselages 8500 and configuration 9000 includes 4 segregated fuselages 8500.

All of the configurations shown in FIGS. 11-27 may be included in preferred embodiments of the present invention.

III. Propulsion

For this section, key concepts are provided below to facilitate explanation of various embodiments of the present invention. In particular, the terms “thrustor” and “propulsor” are explained to distinguish one from another and to explain concepts and components of embodiments of the present invention. Similarly, the terms “ducted” and “ductless” rotary blade systems are explained as they pertain to horizonal flight and vertical flight.

Thrustor

Aircraft propulsion systems generally include three distinct functions:

1. The motor provides energy/power conversion. In conventional propulsion, a reciprocating piston engine or a gas turbine can act as a powerplant. It extracts chemical energy of hydrocarbon fuel through combustion and converts it into mechanical energy. In electric propulsion, electric energy is converted into mechanical energy as electric current passes through the windings/coils of electromagnets. In both cases, the mechanical energy takes the form of:
i. rotating shaft power; and/or
ii. gas flow though ducts.

2. The transmission transfers the converted energy/power to where it can produce thrust:
i. the mechanical shaft power is transmitted to a set of rotary blades either directly through a common shaft or through a mechanical gearbox;
ii. the air flow is either directed to rotary blades or directed to an exhaust nozzle/duct;

3. The propulsor is a set of rotary blades and its associated inlet/exhaust ducts (if any). Typically, it is a propeller, a rotor, or a fan that produces thrust by increasing the velocity and/or pressure of a stream of air.

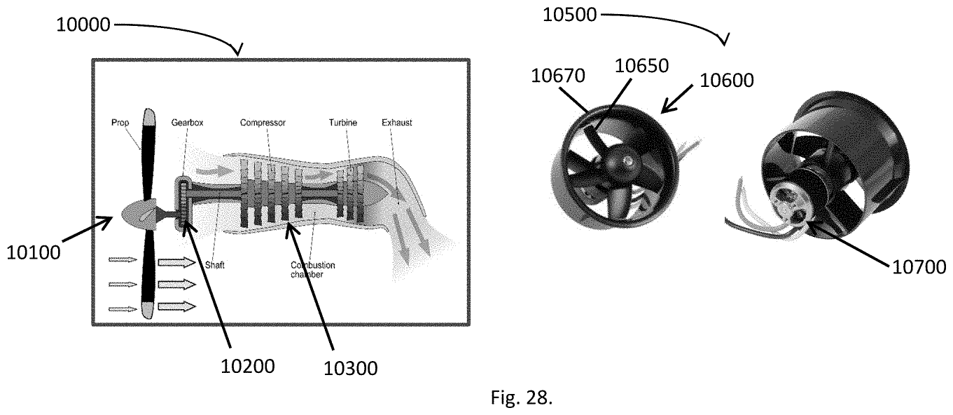

The term “thrustor” is used when referring specifically to the whole system, and generally includes all three of the functions together. Turning to FIG. 28, examples of a turboshaft thrustor 10000 and an electric ducted fan thrustor 10500 are shown. The turboshaft thrustor includes a propulsor 10100 in the form of a propeller, coupled to a gear box 10200 coupled to a gas turbine combustion motor 10300. The electric ducted fan thrustor 10500 includes a propulsor 10600 that includes rotary surfaces (blades) 10650 and fixed surfaces (ducting) 10670 surrounding the rotary surfaces 10650. The rotary blades of the propulsor 10600 are coupled to an electric motor 10700 with a direct shaft transmission.

Engine Types

i. Spectrum from Reaction Engines to Shaft Engines

In conventional aircraft propulsion using combustion engines, there is a wide spectrum of approaches to accomplish the above three functions of the thrustor. On one end of the spectrum, the functions are fully integrated. For instance, the propulsion system can be a pure reaction engine where the elements that participate in the thermodynamic combustion cycle (compressors, combustion chambers, turbines, and their corresponding ducts) produce the thrust (e.g. turbojet engine). In other words, all the air that produces thrust is burnt in the combustion chemical reaction. On the other end of the spectrum, the engine is just a shaft engine where the energy conversion function is completely segregated from the propulsor function (e.g. a general aviation reciprocating piston engine driving the shaft of a propeller).

ii. Turbines

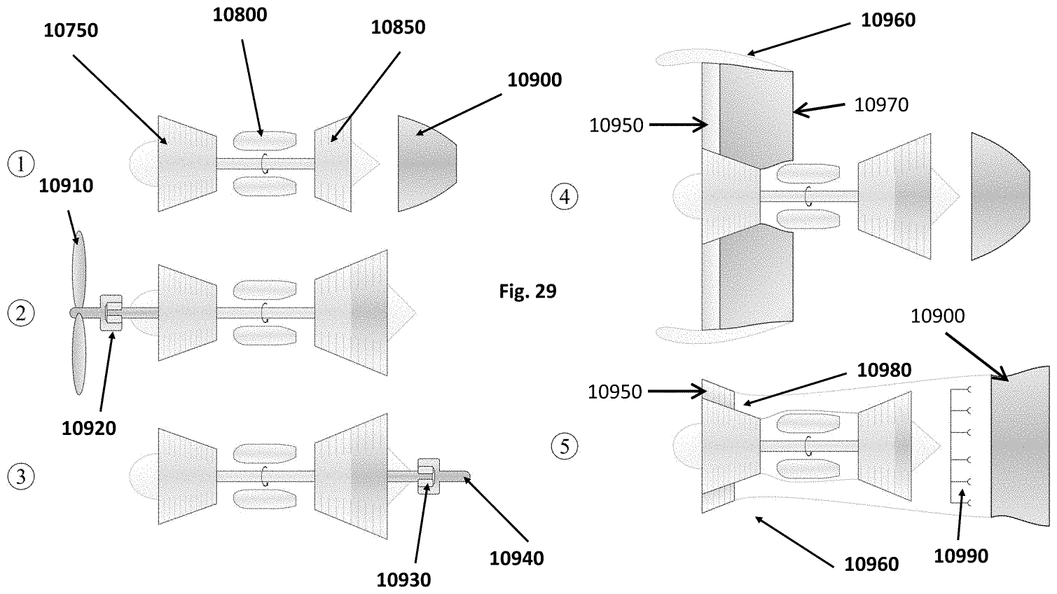

In the current state of the art, the most common passenger and cargo air transport utilizes gas turbines, e.g., jet engines. Turning to FIG. 29, examples of gas turbine configurations are shown. Each gas turbine configuration (1), (2), (3), (4), and (5) includes a compressor 10750 operatively coupled to a combustion chamber 10800, which is operatively coupled to a turbine 10850, which is operatively coupled to a jet exhaust 10900:

(1) Turbojet engines—the main thrust comes from exhaust “burnt air”. The air contributing to propulsion is the same air going through a thermodynamic cycle of compression, combustion, and expansion.

(2) Turboprop engines:
The turbine shaft powers a propeller 10910, which is operatively coupled to a gearbox 10920.
It necessitates the mechanical reduction gearbox 10920 to slow down the RPM of the turbine (tens of thousands) to a more manageable RPM for the propeller (thousands).
The turboprop can almost be considered a turbofan (4) and (5) with no duct, fewer blades, and an extremely high BPR (50-100 range).
Turboprops are more fuel-efficient than turbofans (4) and (5) in the Mach 0.5-0.6 range, but they usually cannot operate at the higher transonic speeds of turbofans (Mach 0.7-0.9). They are also generally noisier than turbofans (4) and (5).

(3) Turboshaft engines: the turbine shaft 10940 powers a rotor. It necessitates an even more drastic mechanical reduction gearbox 10930 to slow down the RPM of the turbine (tens of thousands) to a more manageable RPM for the rotor (hundreds).

(4) and (5) Turbofan engines (FIG. 29 shows a high-bypass turbofan at (4) and a low-bypass afterburning turbofan at (5)). Each of the turbofan engines (4) and (5) includes a fan 10950 with ducting 10960.
A major part of the thrust comes from unburnt air that bypasses the core of the engine.
The bypass ratio (BPR) of a turbofan engine is the ratio between the mass flow rate of the bypass stream to the mass flow rate entering the core.
High bypass turbofans (4) typically power transonic aircraft (such as commercial passenger jets) and provide high bypass flow around the core 10970. Modern transonic engine BPRs are so high (8-12.5 range) that the fan 10950 can essentially be considered as a ducted propeller with a large number of blades.
Low bypass turbofans (5) usually power supersonic aircraft (such as military jets) and provide low bypass flow 10980 and may include an afterburner 10990.

iii. Engine Design Trend

The drive toward propulsion efficiency of the past few decades has favored a continuous shift toward shaft engines over reaction engines. The primary job of most modern gas turbine jet engines is to provide shaft power to drive a propeller, a ducted fan, or a rotor. The only jet engines where a large part of the propulsive force comes from the actual “jet” are “turbojets”, and the “low-bypass turbofans”.

Even though a high-bypass turbofan engine (4) appears to be a “jet” engine, in reality, it is a blend between a reaction engine and a shaft engine that is much closer to a shaft engine than a reaction engine on the spectrum, because most of its thrust comes from its ducted fan. In fact, one of the highest BPRs in a modern turbofan engine has been achieved using a reduction gearbox, which blurs the boundary between turbofan and turboprop even further.

Therefore, for embodiments of the present invention, the next natural step in fully freeing the requirements of the “motor” function from the “transmission” and “propulsor” functions is to avoid complex conversion and transmission systems altogether and use electric motors as shaft engines and electric cables as transmission. Whether the electric power comes from batteries, a generator running on hydrocarbon fuel, hybrid motor/battery configuration, fuel cells, and so on, can depend on the range and payload requirements.

Propulsor Concept—Rotary Blade Systems.

The definition between a propeller versus a rotor or a fan does not have a bright line rule. In general, any system of rotary blades can be used for horizontal/forward thrust and/or vertical lift. Also, they can either have a duct/shroud around them or be ductless.

For the purposes of explaining various embodiments of the present invention, the term “propulsor” is used to refer to a general system of rotary blades, whether it is ducted (like a fan), or ductless (like a propeller), whether it is intended for forward thrust, vertical lift, or both. The term propulsor includes the aerodynamic rotary surfaces (blades) and fixed surfaces (ducting, stators, vanes, etc.), but does not encompass the motor and the transmission. The term “thrustor” on the other hand includes all three elements: motor, transmission, and propulsor as previously seen and noted.

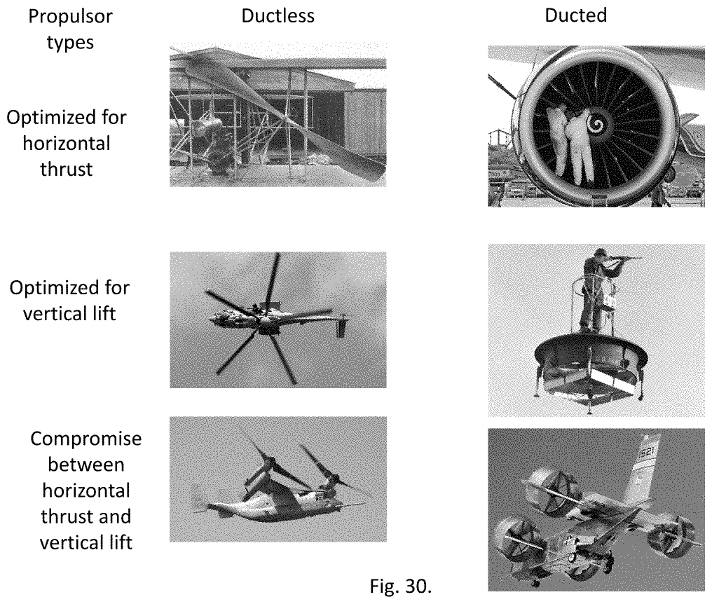

Table 1 below offers naming conventions for the purpose of explaining concepts in the present application. Turning to FIG. 30, examples of rotary blade systems that may be used in various embodiments of the present invention are shown, which illustrates concepts in Table 1 below:

TABLE 1
Naming conventions for categories of rotary blades.

| Propulsor types | Ductless | Ducted |
|---|---|---|
| Optimized for horizontal | Propeller | “Ducted fan” or simply |
| thrust | | “Fan” |
| Optimized for vertical | Rotor | “Ducted rotor” or |
| lift | | “Ducted liftfan” or |
| | | simply |
| | | “Liftfan” |
| Compromise between | Proprotor | Ducted proprotor |
| horizontal thrust and | | |
| vertical lift (usually | | |
| involves tilting) | | |
| Number of blades | Usually small. | Often large. |
| | Commonly 2 to 8 | More than 8 is not |
| | | uncommon. |

iv. Number of Engines

Most modern aircraft have 1 or 2 combustion engines. Aircraft with 3 or 4 combustion engines are gradually disappearing, especially after the governing bodies such as ICAO and FAA issued and updated ETOPS regulations. Aircraft with 5 or more combustion engines are extremely rare, usually old military designs.

Combustion engines are complex and costly to repair/maintain, therefore the drive to have only a minimal number of engines, e.g., 1 or 2 of them, on an aircraft is understandable. Also, large diameter turbines are usually more efficient than smaller ones, which is another factor why almost all modern transonic aircraft are twinjets. For all the advantages that a small number of combustion engines brings, it also limits the conceptual aircraft design space. In particular, the small number of engines forces the engines into a segregated propulsion role and removes the freedom to let them be an integral part of stability and control or aerodynamics.

The assumptions that govern combustion engines do not necessarily apply to electric motors. Electric motors are relatively simple and reliable, require little maintenance, have very high efficiency, are responsive to quick RPM increase/decrease, and provide high torque at almost any RPM. In one embodiment of the present invention, for the wing configurations above, such as configuration 400 in FIG. 2, many smaller electric thrustors maybe placed around strategic locations on the aircraft's wings and fuselage to finely control aerodynamic loads at a local level. Their distributed nature can also augment or fully replace traditional aerodynamic or mechanical guidance and control systems.

v. Energy Source: Hybrid Electric

Battery energy density has consistently improved over the past few decades, but the rate of improvement has been relatively slow. For niche aircraft applications where limited range and/or limited payload are acceptable, the source of energy may include onboard batteries. Many drones currently correspond to these niche applications. For most practical applications though, significant range and/or payload is required to compete with existing airplanes and helicopters.

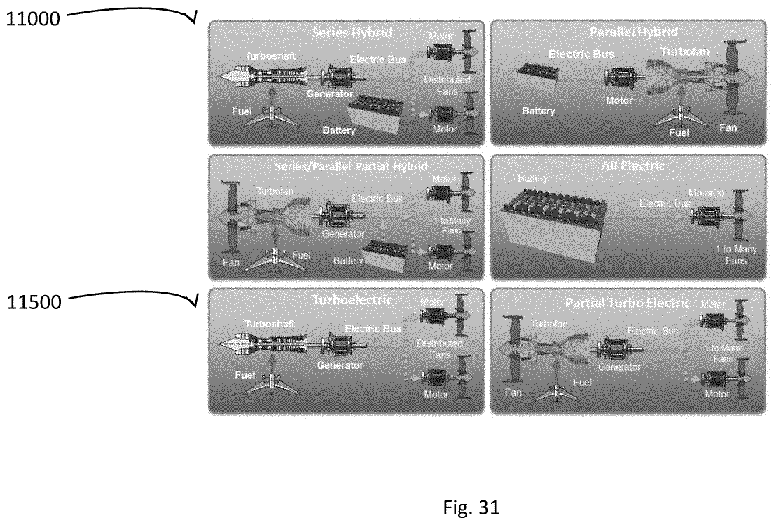

In one approach, the energy source may include hydrocarbon fuel converted to mechanical shaft power and then to electricity through the use of gas turbines or other combustion engines such as reciprocating piston engines, Wankel engines, etc. The wing configurations described above, including configuration 400 in FIG. 2, of various embodiments of the present invention may be powered by 1 or 2 turbines that drive electric power generators feeding a multitude of small electric motors distributed along the aircraft's wings and fuselage. There are multiple electric propulsion architectures and strategies to choose from. The six most common electric propulsion architectures known in the art are shown in FIG. 31. Two of these configurations may be particularly well-adapted to the creation of synergies between aerodynamics, propulsion, structures, and stability/control as described above using any of the wing-fuselage configurations described above: “turbo-electric” 11500 and “series hybrid” 11000. The main difference between the two is the presence of a “small” battery in the circuit. The battery can provide extra power boost when needed (for example during takeoff or emergency) and recover energy when appropriate (for example recharge during descent or trickle charge during low-power cruise). The battery can also provide a mechanism to use a smaller gas turbine (such as an Auxiliary Power Unit) than a configuration relying solely on combustion engines for propulsion. This can help in the reduction of acquisition costs, operational costs, mass, noise, etc. . . .

One advantage of using a hybrid architecture is that electric motors and combustion engines can rotate at independent RPMs, regardless of thrust needs. Electric motors are extremely responsive and can produce high torques for very wide ranges of RPM. Not only will this allow electric motors to be spun up or down in RPM very quickly, but this will not have any adverse effect on the combustion engines (such as compressor stall, poor thermal efficiency in off-nominal regimes, etc.). The combustion engines can rotate at an independent RPM optimized for electricity production in an electric generator. More detail about possible energy sources that can be included in embodiments of the present invention can be found in the following articles, (1) National Academies of Sciences, Engineering, and Medicine 2016. Commercial Aircraft Propulsion and Energy Systems Research: Reducing Global Carbon Emissions. Washington, D.C.: The National Academies Press. https://doi.org/10.17226/23490 and (2) “Turbo- and Hybrid-Electrified Aircraft Propulsion Concepts for Commercial Transport,” by Cheryl L. Bowman, James L. Felder, and Ty V. Marien, https://ntrs.nasa.gov/search.jsp?R=20180005437 2020-04-15T22:20:11+00:00Z, both of which are herein incorporated by reference in their entirety. Note that these references have been included with the filing of this application in an IDS.

vi. Electric Thrustors or Electro-Thrustors (ET)

The thrustor of various embodiments of the present invention may include any of the propulsors described in Table 1 and FIG. 30 combined with an electric motor as a shaft engine. This system can be referred to as an electro-thrustor or electric-thrustor (“ET”). The ET configuration may include an electric propeller, which can be referred to as a electrorprop or (“EP”), an electric fan, which can be referred to as electrofan (“EF”) or electric ducted fan (“EDF”). Other elements include electric rotor (“ER”), electric liftfan (“ELF”), electric proprotor (“EPR”), and electric ducted proprotor (“EDPR”).

TABLE 2
Classification and abbreviations of electric thrustors.

| Electric Thrustor | | |
|---|---|---|
| (ET) types | | |
| Electric Motor + | | |
| Propulsor | Ductless | Ducted |
| Optimized for | Electric propeller | Electric (ducted) fan |
| horizontal thrust | Electroprop | Electrofan |
| | EP | EF (or EDF) |
| Optimized for | Electric rotor | Electric Liftfan |
| vertical lift | ER | ELF |
| Compromise between | Electric Proprotor | Electric ducted proprotor |
| horizontal thrust | EPR | EDPR |
| and vertical lift | | |
| (usually involves | | |
| tilting) | | |

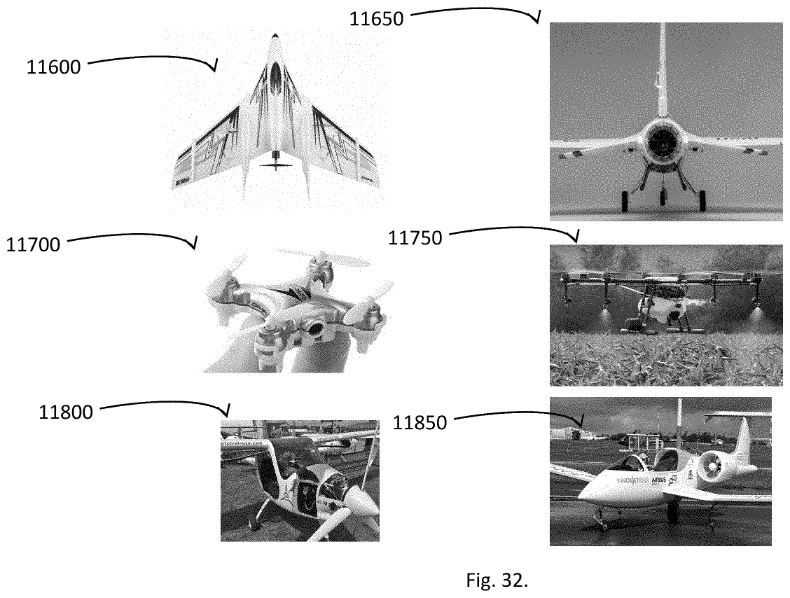

ETs have been used in hobby radio control (RC) aircraft and unmanned drones for decades. Typical examples are shown in FIG. 32. Aircrafts 11600 and 11650 show fixed-wing hobby applications while aircrafts 11700 and 11750 show rotary-wing applications. Aircraft 11600 uses an electroprop (EP). Aircraft 11650 uses an electrofan (EF or EDF). Aircraft 11700 shows one of the smallest camera toy drones with electric rotors (ER) in quad configuration. Aircraft 11750 shows a large commercial agricultural multi-copter drone also using ERs.

The use of ETs in passenger-carrying aircraft is more recent and rare. Two notable examples are the Pipistrel Alpha Electro of 2015 shown at 11800 using an electroprop and the Airbus E-fan of 2014 shown at 11850 using two electrofans.

vii. Propulsion Distribution

Both the Alpha Electro 11800 and E-fan 11850 feature “traditional” airplane architectures from the perspective of the interactions between propulsion, aerodynamics, and stability/control, because they use small numbers of electro-thrustors (ET). The Alpha Electro 11800 features a single ET, a nose-mounted electroprop (EP), while the E-fan 11850 features two ETs in the form of electrofans (EF) mounted to either side of the aft-fuselage. In order to take full advantage of the design possibilities enabled by ETs, one can distribute a large number of ETs along strategic locations of the wings and the fuselage. The term Distributed Electric Propulsion (DEP) is used to refer to aircraft that use a large number of ETs, whether their use is solely intended for propulsion alone or done in a synergistic fashion to provide additional advantages in terms of aerodynamics, structures, stability/control, and takeoff/landing performance.

It is possible to adopt a fuselage-mounted ET approach as well as a wing-mounted ET approach with preferred embodiments. In order to extract synergies between aerodynamics, structures, stability/control, and propulsion in the design of such an electric aircraft using Distributed Electric Propulsion, wing-mounted ETs offer significant advantages over fuselage-mounted ETs. In one embodiment of the present invention, a propulsor, as described above and shown in Table 1 and FIG. 30 is coupled with the wing configurations described above, including configuration 400 shown in FIGS. 2 and 6 along with an electric motor as a shaft engine to create a wing-thrustor configuration.

Fuselage-Mounted ETs

Fuselage-mounted thrustors may offer helpful ET distribution, but the advantages may be somewhat limited to thrust production and drag reduction. Boundary layer ingestion (BLI) using aft fuselage-mounted thrustors introduce novel fuselage-mounted concepts. Such an approach has potential drag reduction benefits and may be incorporated into the wing designs describe above, including configuration 400 (at FIGS. 2 and 6).

Wing-Mounted ETs: Examples

The wing and fuselage configurations above, including configuration 400 at FIGS. 2 and 6, may be achieved while featuring wing-distributed ETs. This will provide a number of advantages in terms of propulsion, aerodynamics, stability/control, structures, and takeoff/landing performance.

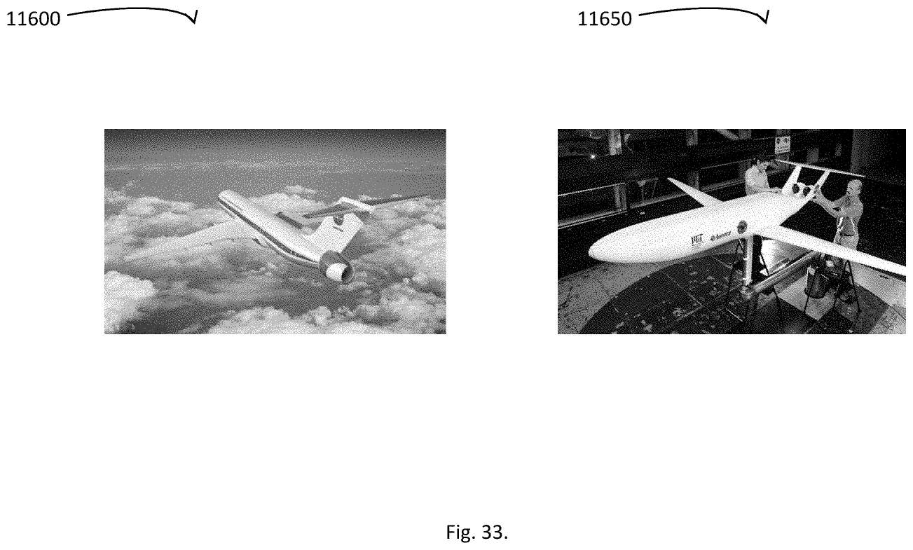

The past decade has seen an explosion of designs and startups in eVTOL (electric VTOL). Some have fixed wings while others use rotary wings. Most are pure battery electric while others are hybrid electric. Currently, there are approximately 100-200 eVTOL projects throughout the world that are different from the more traditional non-VTOL airplanes, such as those shown 11800 and 11850 in FIGS. 32 and 11600 and 11650 shown in FIG. 33. Information on these eVTOL projects can be found at https://evtol.news and https://transportup.com.

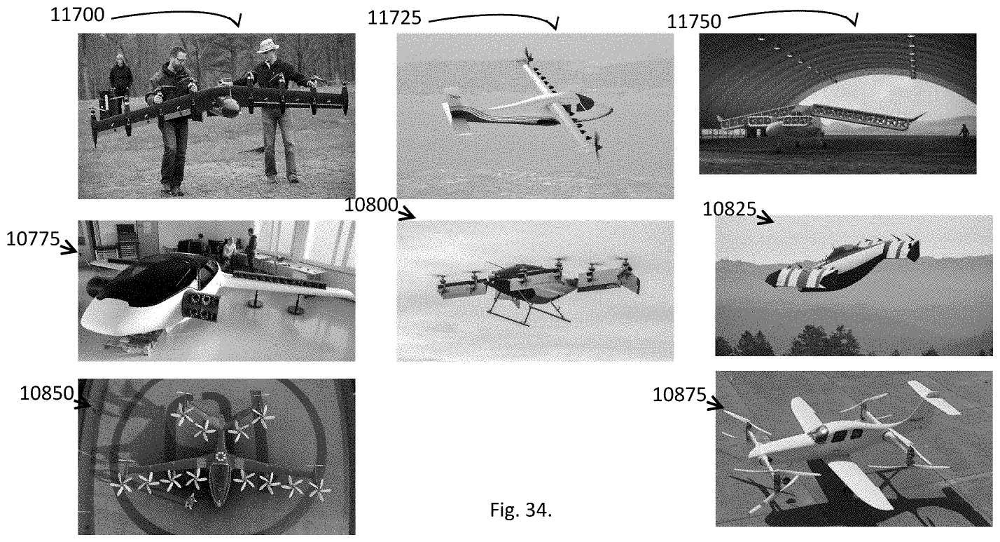

Excluding the rotary wing designs and the designs that use dedicated lift/hover propulsors (sometimes known as “lift+cruise” in the art), the most notable fixed-wing designs using some form of distributed wing-mounted propulsion are listed in Table 3 and are shown in FIG. 34, which include the NASA GL-10 Greased Lightning 11700, the NASA X-57 Maxwelll 11725, the Aurora XV-24A LightningStrike 11750, the Lilium Jet 11775, the Airbus A³ Vahana 11800, the Opener Blackfly 11825, the Joby Aviation S2 11850, and the Beta Technologies Ava 11875.

TABLE 3
Recent examples of DEP fixed-wing aircraft.

| | | NASA, Joby, | Aurora Flight | | | | | Beta |
|---|---|---|---|---|---|---|---|---|
| Manufacturer | NASA | and ESAero | Sciences | Lilium | Airbus A³ | Opener | Joby Aviation | Technologies |
| Name | GL-10 | X-57 | XV-24A | Lilium Jet | Vahana | Blackfly | S2 & S4 | Ava |
| | Greased | Maxwell | LightningStrike | | | | | |
| | Lightning | | | | | | | |
| Wing | Conventional: | Conventional: | Canard: | Canard: | Tandem | Tandem | Conventional: | Triple/Quadruple |
| configuration | Front wing, | Front wing, | Large aft wing, | Large aft | wing: | wing: | Front wing, | wing: |
| | aft tail | aft tail | small front | wing, small | Similarly | Similarly | aft V tail | Tilting front and |
| | | | canard | front canard | sized front | sized front | | aft wings, fixed |
| | | | | | and aft | and aft | | mid wing, and |
| | | | | | wings | wings | | aft T-tail. |
| Propulsion type | Hybrid diesel | Battery | Hybrid | Battery | Battery | Battery | Battery | Battery Electric |
| | electric | electric | turboelectric | Electric | Electric | Electric | Electric | |
| VTOL | Yes | No | Yes | Yes | Yes | Yes | Yes | Yes |
| VTOL technology | Wing tilting | N/A | Wing tilting | Tilting of | Wing | Tilting of | Rotor tilting | Wing tilting |
| | | | | ducted | tilting | entire | | |
| | | | | proprotors | | aircraft | | |
| Passengers | Unmanned | Up to 4 | Unmanned | 2 to 5 | 1 | 1 | S2: 2 | 1-2 (guess) |
| | | | | | | | S4: 4 | |
| Number of ETs | 10 | 14 | 24 | 36 | 8 | 8 | S2: 16 | 8 |
| | | | | | | | S4: 6 | |
| Ducting | Ductless | Ductless | Ducted | Ducted | Ductless | Ductless | Ductless | Ductless |
| Propulsor type | Proprotor | Propeller | Ducted | Ducted | Proprotor | Proprotor | Proprotor & | Proprotor |
| | | | proprotor | proprotor | | | Propeller | |
| ET details | 10 EPRs: | 14 EPs: | 24 EDPRs: | 36 EDPRs: | 8 EPRs: | 8 EPRs | S2 has 16 | 8 EPRs: |
| | −8 on wing | −12 smaller | −18 on TW | −24 on TW | −4 on LW | −4 on LW | ETs: | −4 on LW |
| | −2 on | EPs (for | −6 on LW | −12 on LW | −4 on TW | −4 on TW | −12 tilting | −4 on TW |
| | horizontal | takeoff and | | | | | EPRs (8 on | |
| | stabilizer | landing only) | | | | | wing + 4 on | |
| | | −2 larger | | | | | tail) | |
| | | wingtip- | | | | | −4 pusher | |
| | | mounted | | | | | EPs (2 on | |
| | | cruise EPs | | | | | wing + 2 on | |
| | | | | | | | tail) | |
| | | | | | | | S4 has 6 | |
| | | | | | | | tilting EPRs | |
| Has it flown? | Yes. | Not yet. | Yes (20% scale | Yes (Eagle | Yes. | Yes. | Allegedly S4 | Yes. |
| Was it manned or | Unmanned | Retrofit of an | demonstrator) | demonstrator). | Unmanned. | Manned. | has | Maimed. |
| unmanned? | | existing twin- | Full-scale | Unmanned | | | performed | (alleged) |
| | | engine | cancelled. | | | | manned | |
| | | Tecnam | | | | | flights. | |
| | | 2006T. | | | | | | |
| Application | Research | Research | Military | Civilian | Civilian | Civilian | Civilian | Civilian |
| | | | | (Urban Air | (Urban Air | (ultralight) | (Urban Air | (hospital organ |
| | | | | Mobility) | Mobility) | | Mobility) | delivery |
| | | | | | | | | claimed) |

Some data points about these 8 airplanes (fixed-wing aircraft) and their DEP systems are:
Battery electric vs. hybrid electric:
   6 out of 8 are pure battery electric;
   2 are hybrid:
      One uses turboelectric;
      The other uses diesel electric.
They all have large numbers of ETs, at least 8 and up to 32;
Ducting:
   6 out of 8 use ductless propulsors;
   The 2 that use ducting (EDPRs) are also the ones that use the largest number of propulsors (the Aurora LightningStrike 11750 uses 24 EDPRs while the Lilium Eagle Jet 11775 uses 36 EDPRs);
VTOL vs. CTOL: Only 1 is a CTOL: X-57 Maxwell 11725
The other 7 accomplish VTOL by tilting the propulsors 90 degrees:
   By tilting the entire wing/tail:
      GL-10 Greased Lightning 11700
      XV-24A LightningStrike 11750
      Vahana 11800
      Ava 11875
   By tilting the thrustors: Lilium Jet 11775, S2 & S4
   By tilting the entire aircraft: Blackfly 11825

In short, wing-distributed DEP may be helpful for fixed-wing applications in both CTOL and VTOL.

viii. Background on Possible Positioning of Traditional Wing-Mounted Thrustors

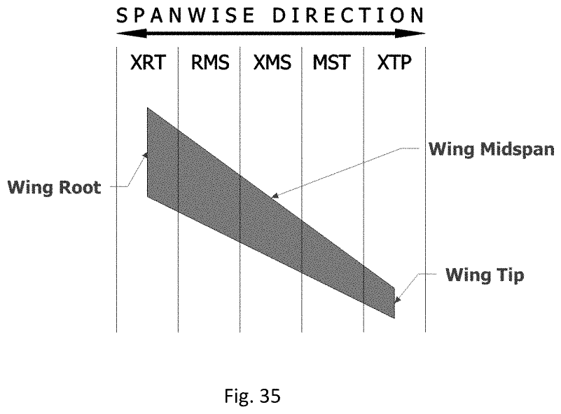

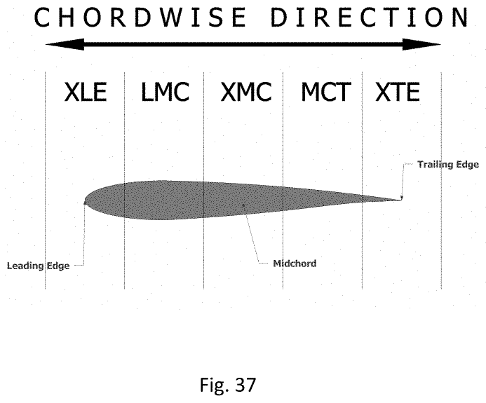

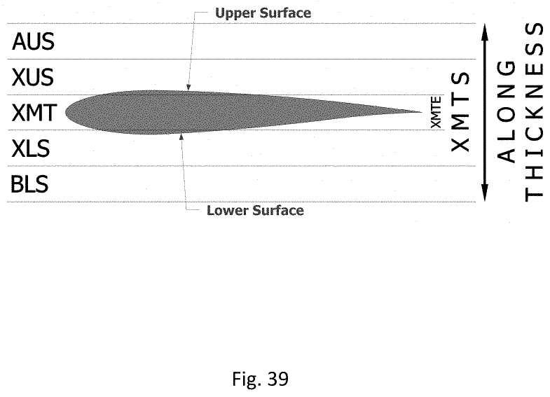

There are many possible choices for a single thrustor position on a wing. FIGS. 32 33, and 34 illustrate some of the DEP solutions contemplated by various recent designers. Regardless of whether one chose a ducted or a ductless solution, it may be useful to classify and categorize various thrustor positions along 3 primary directions:
Along the span of a wing (lateral position) as seen in FIGS. 35 & 36
Along the chord of a wing (longitudinal position) as seen in FIGS. 37 & 38
Along the thickness of a wing (vertical position) as seen in FIGS. 39 & 40.

We can then define 125 “general positions” for a single thrustor (5 slices along the span, 5 slices along the chord, and 5 slices along the thickness) as follows:
The wing can be sliced from root to tip along its span into 5 general lateral stations:
   A thrustor's spanwise location can be categorized as described in FIG. 35 (which shows general thrustor mounting stations along the span of a wing—lateral position) and Table 4:

TABLE 4
General classification of thrustor mounting position
along the span of a wing (lateral position).

| Station | Station | | |
|---|---|---|---|
| number | name | Station along span | Potential advantage |
| S1 | XRT | At root | Structure. |
| | | | Proximity to centerline |
| | | | if one side inoperable. |
| S2 | RMS | Between root and | Structure. |
| | | mid-span | Proximity to centerline |
| | | | if one side inoperable. |
| S3 | XMS | At mid-span | |
| S4 | MST | Between mid-span | Some yaw control. |
| | | and tip | |
| S5 | XTP | At tip | Yaw control. |

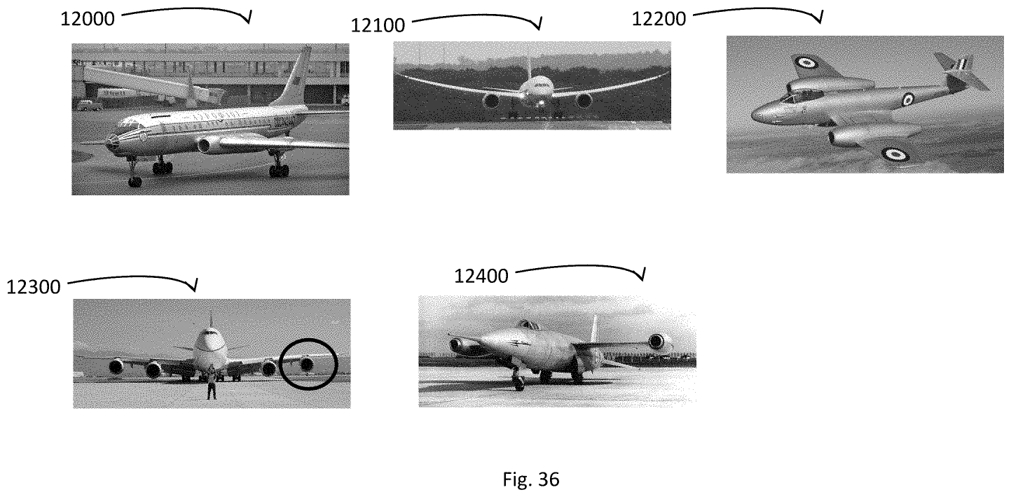

Examples are shown in FIG. 36 with examples of wing-mounted thrustor positions along the wing span:

| | Station | |
|---|---|---|
| Code | along span | Example |
| S1/XRT | At root | Tupolev Tu-104 “Camel”, 12000 at FIG. 36. |
| S2/RMS | Between root | Boeing 787 Dreamliner 12100 at FIG. 36. |
| | and mid-span | |
| S3/XMS | At mid-span | Gloster Meteor 12200 at FIG. 36. |
| S4/MST | Between mid- | Boeing 747-8, 12300 at FIG. 36. |
| | span and tip | |
| S5/XTP | At tip | SNCASO Trident, 12400 at FIG. 36. |

The wing can be sliced from leading edge to trailing edge along its chord into 5 general longitudinal stations:
   A thrustor's chordwise location can be categorized as described in FIG. 37 (which shows longitudinal classification of thrustor mounting positions along the chord of a wing) and Table 6 below.

TABLE 6
General classification of thrustor mounting position
along the chord of a wing (longitudinal position).

| Station | Station | Station | |
|---|---|---|---|
| number | name | along chord | Potential advantage |
| C1 | XLE | At or near | Structure (relief moment and |
| | | leading edge | flutter). |
| | | | Wing in slipstream including |
| | | | Coandă effect. |
| C2 | LMC | Between leading | Structure (relief moment and |
| | | edge and mid-chord | flutter). |
| | | | Wing in slipstream including |
| | | | Coandă effect. |
| C3 | XMC | At mid-chord | Potentially reattach BL. |
| C4 | MCT | Between mid-chord | Potentially reattach BL. |
| | | and trailing edge | |
| C5 | XTE | At or near | Potentially reattach BL. |
| | | trailing edge | |

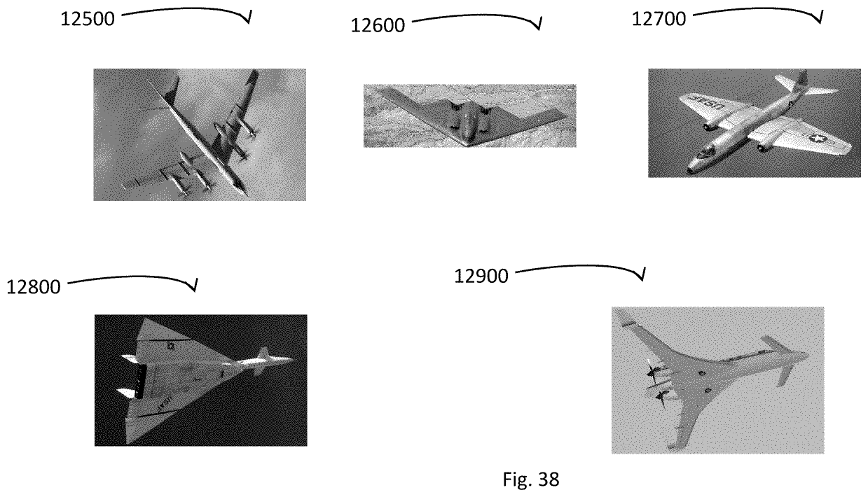

Examples are shown in FIG. 38.

| Code | Station along chord | Example | Note/prevalence |
|---|---|---|---|
| C1/XLE | At or near | Tupolev Tu-95 “Bear”, 12500 at | Very common due to its |
| | leading edge | FIG. 38 | structural advantage |
| | | | (balancing out the wing |
| | | | twist due to |
| | | | aerodynamic forces). |
| | | | Most turbofans and |
| | | | turboprops use this |
| | | | position. |
| C2/LMC | Between leading | Northrop B-2 Spirit, 12600 at | Not very common. |
| | edge and mid- | FIG. 38. | |
| | chord | | |
| C3/XMC | At mid-chord | Martin B-57 Canberra, 12700 at | Not very common. |
| | | FIG. 38 | |
| C4/MCT | Between mid- | North American XB-70 Valkyrie, | Not common on |
| | chord and | 12800 at FIG. 38. | subsonic airplanes. |
| | trailing edge | | More common on |
| | | | supersonic airplanes. |
| C5/XTE | At or near | Beechcraft Starship, 12900 at | Often on pusher |
| | trailing edge | FIG. 38. | configurations, |
| | | | especially for canards |
| | | | and flying wings. |

The wing can be sliced from lower surface to upper surface along its thickness into 5 general vertical stations:
   thrustor's location along the thickness can be categorized as described in FIG. 39 (which shows vertical classification of thrustor mounting positions along the thickness of a wing) and Table 8:

TABLE 8
General classification of thrustor mounting position
along the thickness of a wing (vertical position).

| Station | Station | | |
|---|---|---|---|
| number | name | Along thickness | Advantage |
| T1 | BLS | Fully below lower surface | Low interference aerodynamics. |
| T2 | XLS | At lower surface (flush with or | Powered lift through flap/slat |
| | | protruding from lower surface) | deflection of slipstream. |
| T3S & | XMTS & | At mid-thickness: | XMTS: Blown upper and lower |
| T3E | XMTE | Straddling upper and lower | surfaces. |
| | | surfaces; or | XMTE: Low form drag. |
| | | Embedded in wing | |
| T4 | XUS | At upper surface (flush with or | Blown upper surface Coandă effect. |
| | | protruding from upper surface) | Boundary layer separation control. |
| T5 | AUS | Fully above upper surface | Low interference aerodynamics. |

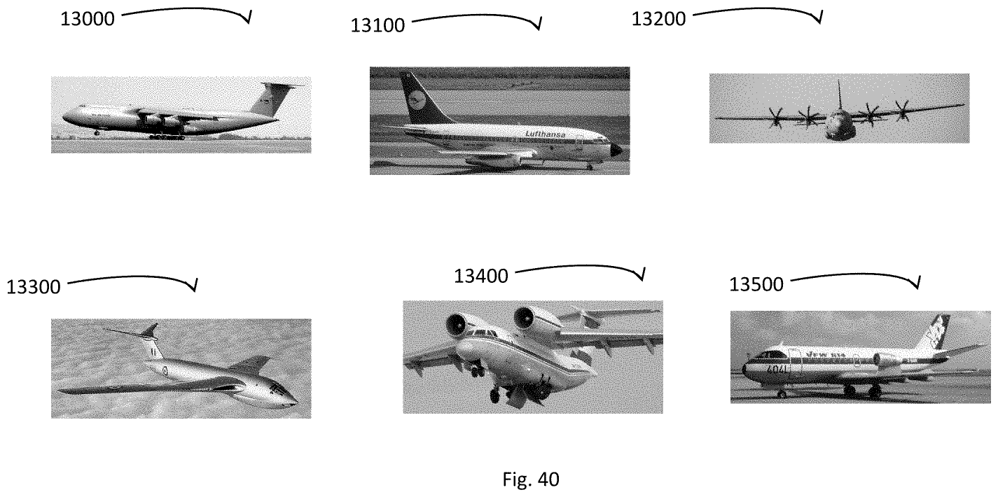

Examples are shown in FIG. 40.

| Code | Station along thickness | Example | Note/Prevalence |
|---|---|---|---|
| Tl/BLS | Fully below lower surface | Lockheed C-5 Galaxy, 13000 | Most common on transonic |
| | | at FIG. 40. | airplanes. |
| T2/XLS | At lower surface (flush with | Boeing 737-100, 13100 at | Common on older small |
| | or protruding from lower | FIG. 40. | diameter turbojets. Less |
| | surface) | | common today. |
| T3S/XMTS | At mid-thickness straddling | Lockheed C-130 Hercules, | Very common withpropeller- |
| | upper and lower surfaces | 13200 at FIG. 40. | based designs, especially |
| | | | turboprops. |
| T3E/XMTE | At mid-thickness embedded | Handley Page Victor, 13300 | Many designs in the 1950s, |
| | in wing | at FIG. 40 | especially with small diameter |
| | | | turbojets. Uncommon today, |
| | | | with large diameter turbofans. |
| T4/XUS | At upper surface (flush with | Antonov An-72 “Coaler”, | Not very common. Can have |
| | or protruding from upper | 13400 at FIG. 40 | STOL benefits using the |
| | surface) | | Coandă effect (blown upper |
| | | | surface). |
| T5/AUS | Fully above upper surface | VFW-Fokker 614, 13500 at | Extremely uncommon. |
| | | FIG. 40. | |

In all of these examples, the number of thrustors range from 2 to 6. The most prevalent/common traditional wing-mounted thrustors are at the following stations: S2 (RMS) along the span, C1 (XLE) along the chord, T1 (BLS) along the thickness for turbofan-based design, and T3 S (XMTS) along the thickness for propeller-based designed.

ix. Positioning and Density of Non-Traditional Wing-Mounted ETs.

Many of the most common traditional wing mounting positions discussed above are determined based on assumptions associated with thrustors using combustion engines:
The number of thrustors is small because combustion engines are expensive and complex;
Combustion thrustors are heavy;
Combustion thrustors have large dimensions in terms of length and/or diameter;
It is rare to have the mechanical power of one combustion engine distributed to multiple propulsors, because of the complexity and weight of the required mechanical transmission.

In embodiments of the present invention, replacing 2 to 4 large and heavy wing-mounted combustion thrustors with tens of ETs fundamentally changes many of the mounting positions and the above assumptions. Each individual ET can be comparatively lighter, shorter in length, and smaller in diameter. Whether the electric power for the ETs is provided directly by a battery, or by 1 or 2 combustion engine generators, or fuel cells, the power transmission through electrical cables can be more practical than a mechanical transmission.

ET Distribution Opportunities

The longest dimension in most wings is generally the span. Therefore, distributing a large number of ETs along the wing span is a natural choice that lends itself to several potential advantages:
Subjecting a large portion of the wing, potentially its entirety, to the propulsors slipstream;
Active aerodynamic control of the entire wing at a local level in all flight regimes;
Boundary layer control and stall prevention in all potential challenging areas, regardless of whether they are inboard or outboard, near the LE or the TE;
Stability and control augmentation (or potentially even replacement) through differential thrust and/or thrust-vectoring;
Reduction or prevention of spanwise flow in the case of swept wings.

Externally-Mounted ET

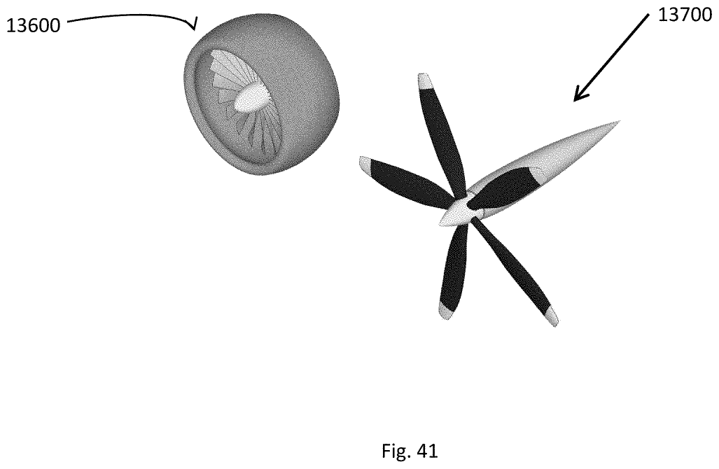

There are two externally-mounted ETs known in the art, ducted and ductless, in the form of an electrofan (EF) 13600 or electroprop (EP) 13700, as shown in FIG. 41. Depending on the aircraft's mission profile and requirements, the configurations above, including configuration 400 as shown in FIG. 2, preferably use EFs 13600, EPs 13700, or a combination thereof. One of the key aspects of both EFs 13600 and EPs 13700 is that the electric motor in the thrustor core can be significantly slimmer than its combustion counterpart and thus provide form drag reduction benefits. In the case of the EF 13600, the electric motor can potentially even be built into the duct rather than the center core.

Internally-Mounted Electrofan

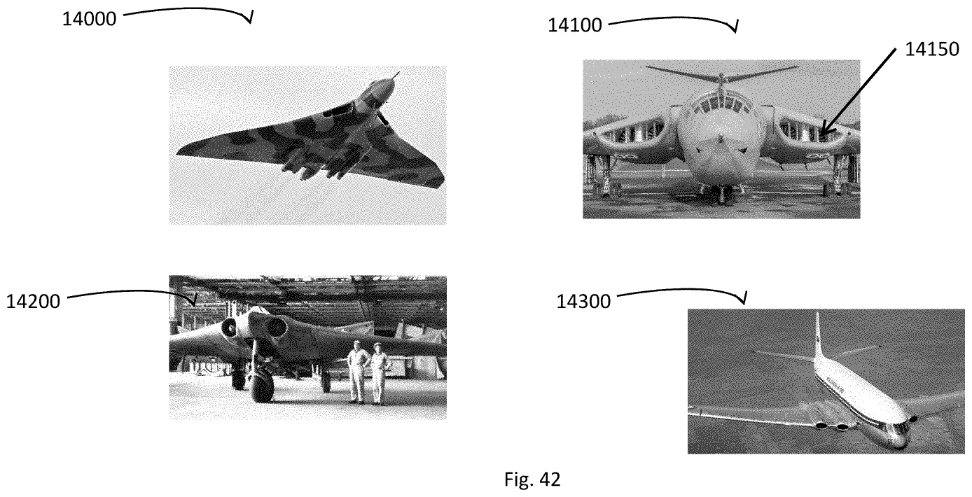

Most wing-mounted thrustors are so large in diameter that they must be placed outside the confines of the wings. Prior to the development of highly efficient high BPR turbofans, when the only jet engines available were small-diameter turbojets, several designs featured thrustors fully embedded in the wings (at the XMTE mounting position along the thickness). These designs typically mounted the thrustors near the wing root where the wings are generally thicker, thus have more volume available, and where the mounting position has structural benefits (e.g. the small lever arm does not produce much bending moment). FIG. 42 shows some examples of such designs. The airplane design shown in 14100 shows a craft where the compressor blades 14150 of the engine are visible through the inlet duct.

This configuration may be applicable for ETs and applied to DEP. One of the dimensional advantages of ETs is that they can be made small enough to be fully embedded within a wing 200. Beyond the drag reduction benefits of such a design, this can also provide potential boundary layer control benefits. In particular, the cool air blown by an embedded EF does not create the thermal restrictions of its combustion counterpart.

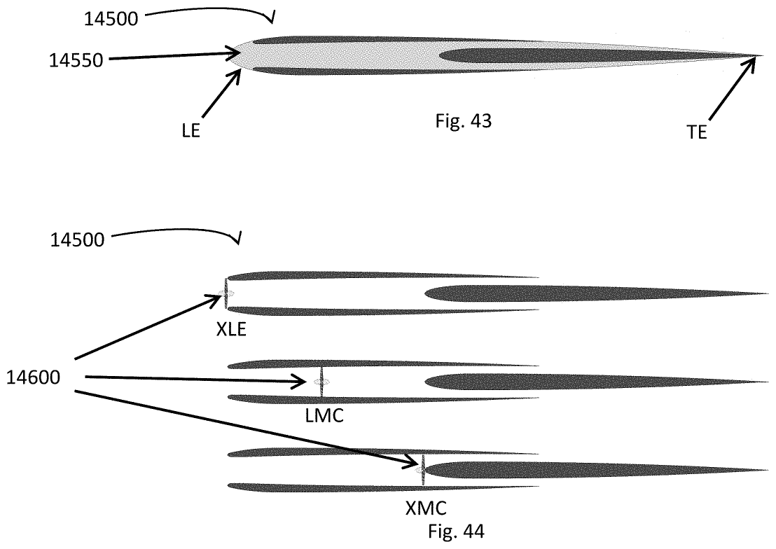

Turning to FIG. 43, an airfoil 14500 is shown. Airfoil 14500 is hollowed out in such a way that the upper and lower surfaces form a single duct 14550 near the LE. The duct splits into two separate channels near the TE such that air can be blown internally onto both the upper and lower surfaces simultaneously.

Turning to FIG. 44, propulsor 14600 is added to airfoil 14500 in the cavity at XMTE along the thickness and at XLE, LMC, or XMC along the chord. One can even place multiple rows of propulsors back to back at various positions along the chord if needed.

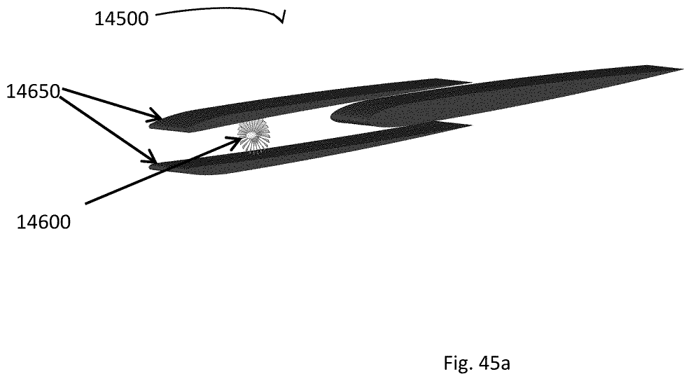

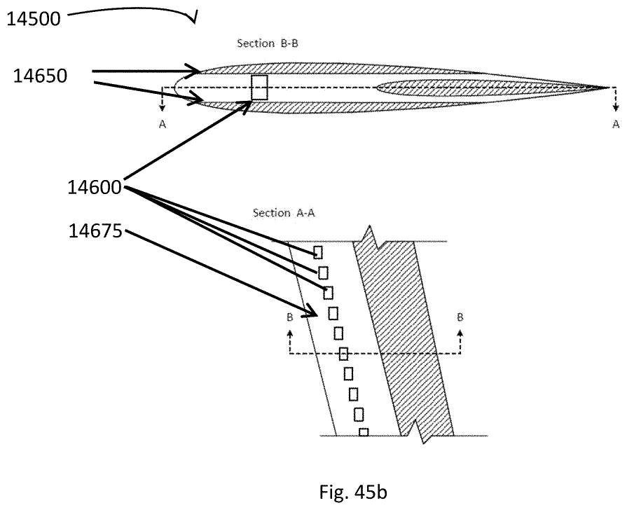

There are various ways ducting can be achieved around the propulsor 14600 in accordance with embodiments of the present invention. A simple shared duct can be achieved by extruding the above wing 200 surfaces 14650, as shown at FIG. 45a. Turning to FIG. 45b, airfoil 14500 is shown with a number of propulsors 14600 sharing a duct 14675 distributed along the wingspan.

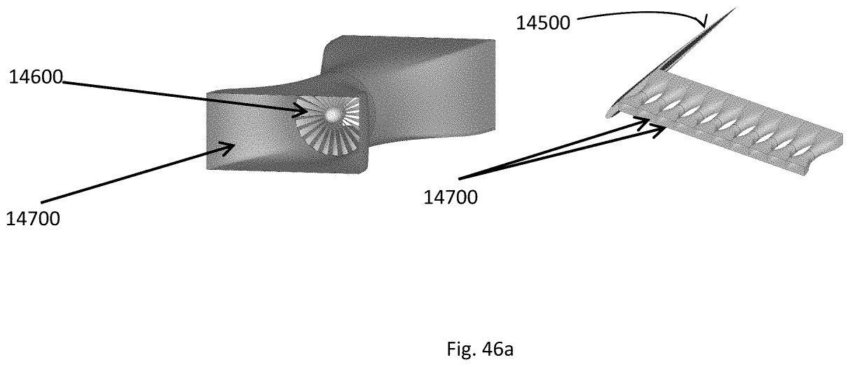

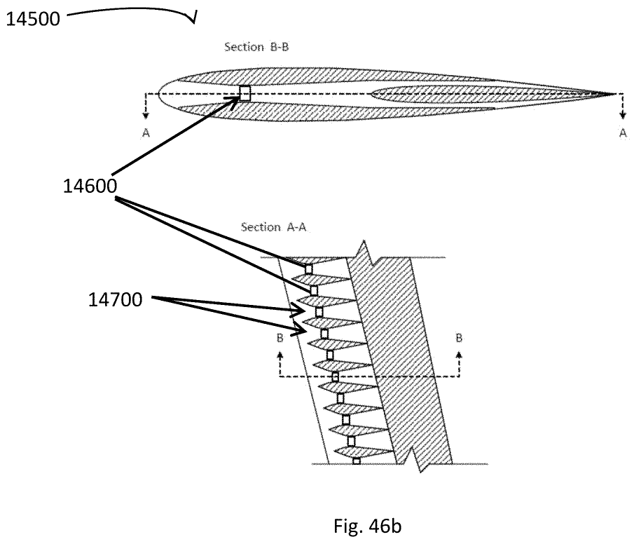

A more elaborate individual duct 14700 can be tailored for each propulsor 14600, as shown in FIG. 46a. Further, rows of such ducts 14700 can be stacked along the span of airfoil 14500 and be fully encased within a wing. Turning to FIG. 46b, another side view of wing 14500 is shown with multiple EFs 14600, each encased in individual ducts 14700 distributed along the wingspan.

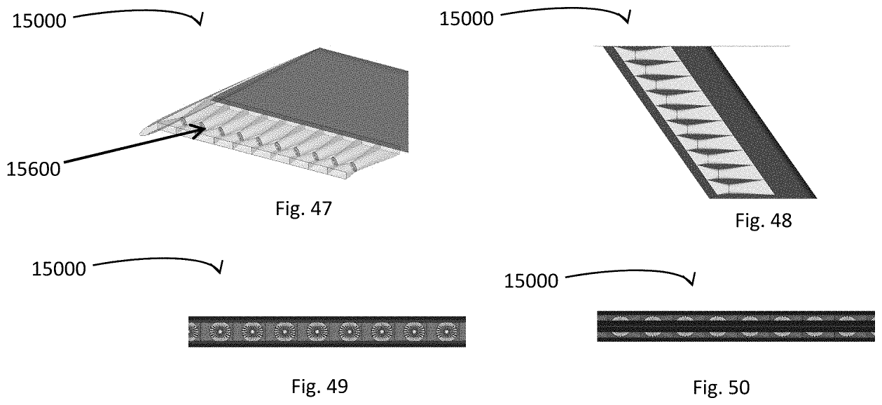

Other embodiments may include swept and tapered wing design 15000 as shown in FIGS. 46b, 47, 48, 49, and 50. FIG. 47 shows swept and tapered wing 15000 with plurality of propulsor ducts 15600. FIG. 47 is an isometric view of EFs with individual internal ducts 15600 in a BSW with TE section of the wing shown. FIG. 48 shows a top view of EFs with individual internal ducts 15600 in a BSW with lower surface section of the wing 15000 shown. FIG. 49 is a front view of EFs with individual internal ducts 15600 in a BSW with shared LE inlet between upper and lower surfaces. FIG. 50 shows a rear view of EFs with individual internal ducts 15600 in a BSW with split TE outlet. Also, a wing might be too thin near the tips to accommodate even a small-diameter electric propulsor, meaning that the inboard parts of the wing might lend themselves better to such a solution than the outboard parts.

Electrofan Vs. Electroprop

One can imagine that EFs and EPs will probably share some of the same advantages as their combustion counterparts, the turbofan and the turboprop (Table 10).

TABLE 10
Potential advantages of EFs and EPs.

| | Potential advantage |
|---|---|
| EF | High static thrust. |
| | Inlet diffuser better suited for transonic flight (Mach 0.75-0.95). |
| | Stators and vanes in exhaust can straighten slipstream. |
| | Noise attenuation. |
| EP | Simplicity |
| | Lower weight. |
| | Higher efficiency at high subsonic flight (Mach 0.5-0.6). |
| | Larger diameter of slipstream covers more wing area. |
| | Fewer blades potentially make it easier to include blade pitch |
| | control mechanism. |

ET Density

This section describes possible placement of propulsors on the wings and its effect on aircraft designs in accordance with embodiments of the present invention. A twin-engine airplane with wing-mounted combustion thrustors may present, e.g., 125 positions according to the 5×5×5 slice-based classifications of the previous sections.

When it comes to electric thrustors, regardless of whether one opts for EFs, EPs, or a mixed solution, the distribution of ETs along the wing span may be denser than combustion thrustors. Given the allowable density of ET distribution along the span, the 5 general slices that we used to categorize the positions of traditional combustion thrustors along each of the 3 directions (span, chord and thickness) are still useful in only two of these directions for ETs: chord and thickness, which are incidentally the smaller dimensions of a wing. As for span, it may require more than 5 slices to categorize their locations and one must think in terms of ET density instead.

The smaller size of ETs allows one to mount them in multiple positions along all three directions. The same airplane can have ETs both above the wing and below, at the LE and the TE while distributing them along the span. The ETs may be distributed along the span of the wing with some level of density. The span and the chord being the smaller dimensions, the mounting positions remain relatively more discrete.

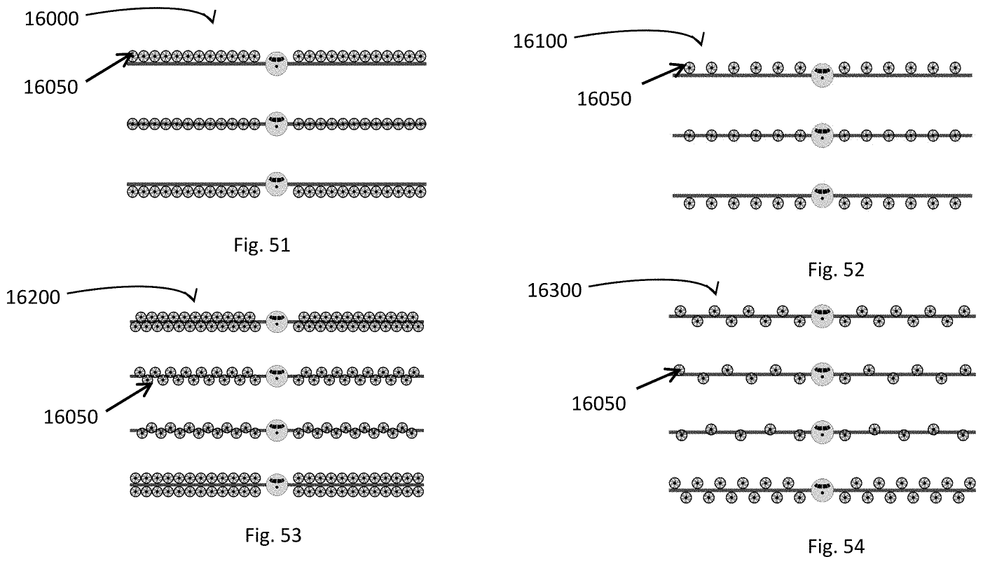

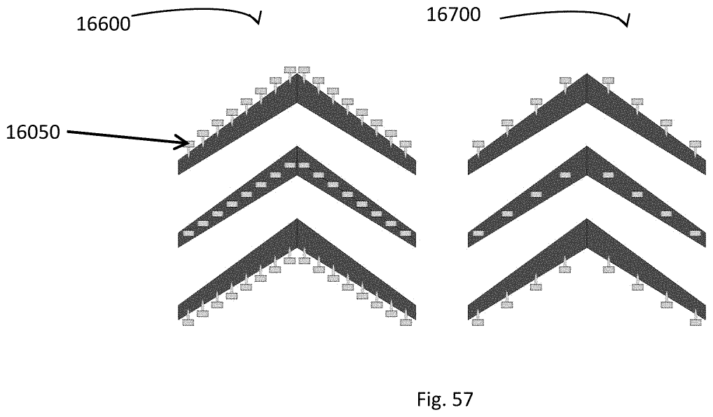

The following are possible mounting configurations in accordance with embodiments of the present invention:
A wing's front view illustrating density along span and thickness simultaneously (shown in FIGS. 51, 52, 53, 54, 55, and 56);
A wing's top/bottom view illustrating density along span and chord simultaneously (shown in FIGS. 57, 58, and 59).

ET Density Along Span and Thickness

Schematic representations of some of the possibilities in accordance with embodiments of the present invention in terms of ET density along span and thickness are shown in the front view sketches of FIGS. 51, 52, 53, 54, 55, and 56. These concepts can apply to both EPs and EFs although EFs 16050 are shown.
FIG. 51 shows ET distribution along the span in a single-row 16000. FIG. 51 shows a schematic representation of how a tangentially/densely packed single row of 24 ETs 16050 (12 on either side) can be spread along the span in a single row 16000, either fully above the wing, fully below the wing, or straddling the upper and lower surfaces.
FIG. 52 shows a sparser version 16100 (12 ETs instead of 24ETs), omitting every other ET.

FIG. 53 shows a dense double-row configuration 16200 (26 to 48 ETs) blowing air onto both the upper surface and the lower surface of the wings. FIG. 54 shows a sparser double-row configuration 16300 with 10-24 ETs.

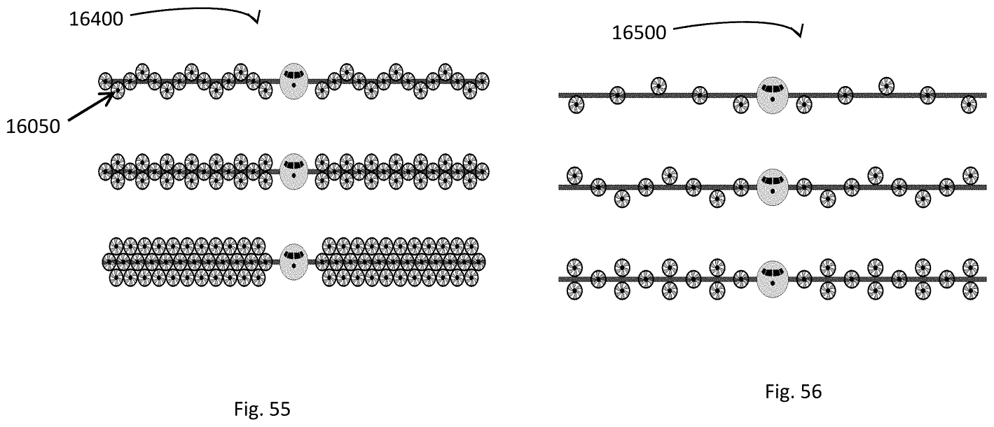

FIG. 55 shows a dense triple-row configuration 16400 (28-72 ETs) blowing air onto both the upper surface and the lower surface of the wings. FIG. 56 shows a sparser triple-row configuration 16500 with 10-24 ETs.

ET Density Along Span and Chord

In a similar fashion, ET distribution in accordance with embodiments of the present invention along span and thickness as shown in FIG. 51-56, ETs 16050 can be distributed in single or multiple rows along the span near the LE, the mid-chord, and/or the TE, in a dense or sparse fashion.

FIG. 57 illustrates single-row ET distribution along the span in 16-ET (denser) 16600 and 8-ET (sparser) 16700 configurations;

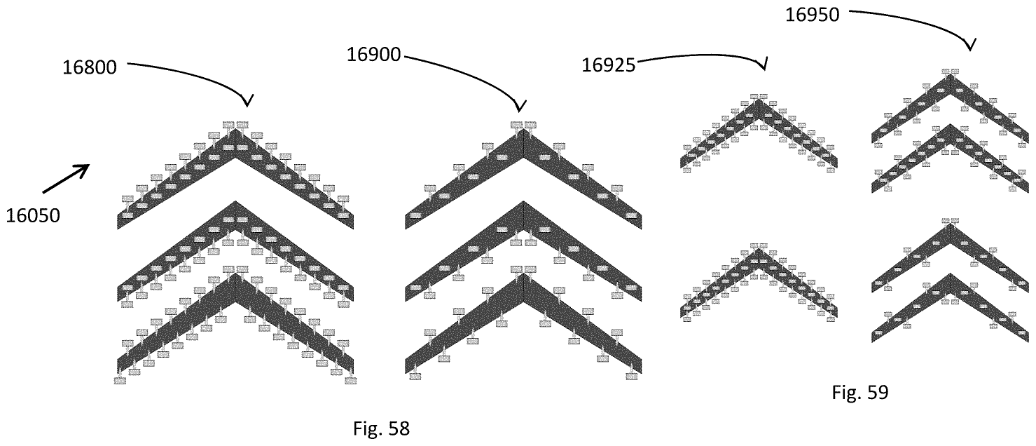

FIG. 58 illustrates double-row ET distribution along the span in 32-ET (denser) 16800 and 16-ET (sparser) 16900 configurations;

FIG. 59 illustrates triple-row ET distribution along the span in dense 48-ET 16925 and 46-ET 16950 down to sparser 30-ET, 24-ET, and 16-ET configurations.

Further Examples of ET Distribution, Particularly on Configuration 400

As stated earlier, there are quasi-infinite possibilities of ET distribution on a single set of wings, let alone two sets of joined wings. If we combine some of the possibilities together, the number of possibilities/configurations are still quite large as seen in Table 11 with 180 total possibilities.

TABLE 11
Simplified number of possibilities in ET distribution.

| | Possibility instance | | | | | 180 Total |
|---|---|---|---|---|---|---|
| | 1 | 2 | 3 | 4 | 5 | Possibilities |
| ET type | EF | EP | Mixed | | | 3 |
| Number | Small | Medium | Large | | | 3 |
| of ETs | (4-12) | (12-36) | (36- | | | |
| | | | 108) | | | |
| ET position | Even | | | | | 1 |
| along | distribution | | | | | |
| span | | | | | | |
| ET position | XLE or | XMS | MST or | Mul- | | 4 |
| along | LMS | | XTE | tiple | | |
| chord | | | | | | |
| ET position | BLS or | XMT | XMTE | AUS | Mul- | 5 |
| along | XLS | | | or | tiple | |
| thickness | | | | XUS | | |

Below are some distribution possibilities for configurations described above such as those wing configurations related to configuration 400 shown in FIG. 2.

ET Configurations

6-ET Configuration

| ET Type & | | Chord | Thickness | |
|---|---|---|---|---|
| number | Span position | position | position | Fuselage |
| 6 EFs | Even distribution | LMC | AUS | Single |

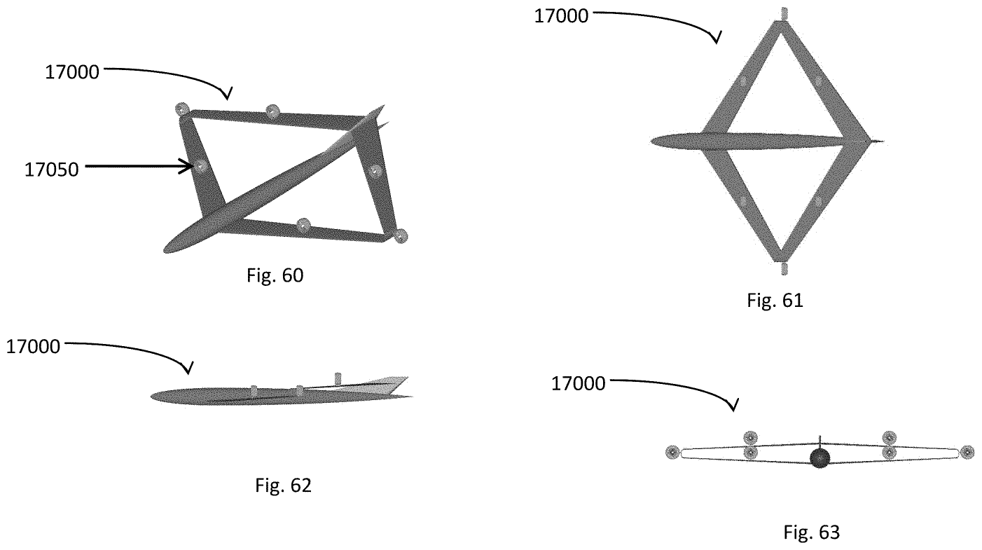

This configuration 17000 with ETs 17050 is shown in FIGS. 60 (isometric), 61 (top), 62 (side), and 63 (front).

14-ET Configuration

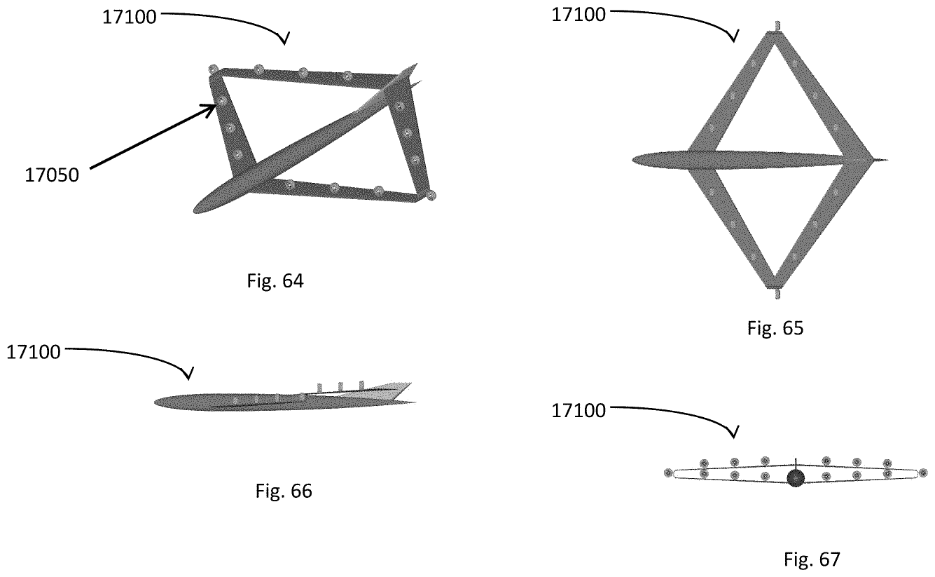

This configuration 17100, shown in FIGS. 64 (isometric), 65 (top), 66 (side), and 67 (front) shows an increase in the number of ETs 17050, from 6 to 14. Note the ET diameters may be smaller.

| ET Type & | | Span | Chord | Thickness | |
|---|---|---|---|---|---|
| number | Span position | density | position | position | Fuselage |
| 14 EFs | Even | Even | LMC | AUS | Single |
| | distribution | | | | |

30-ET Configuration

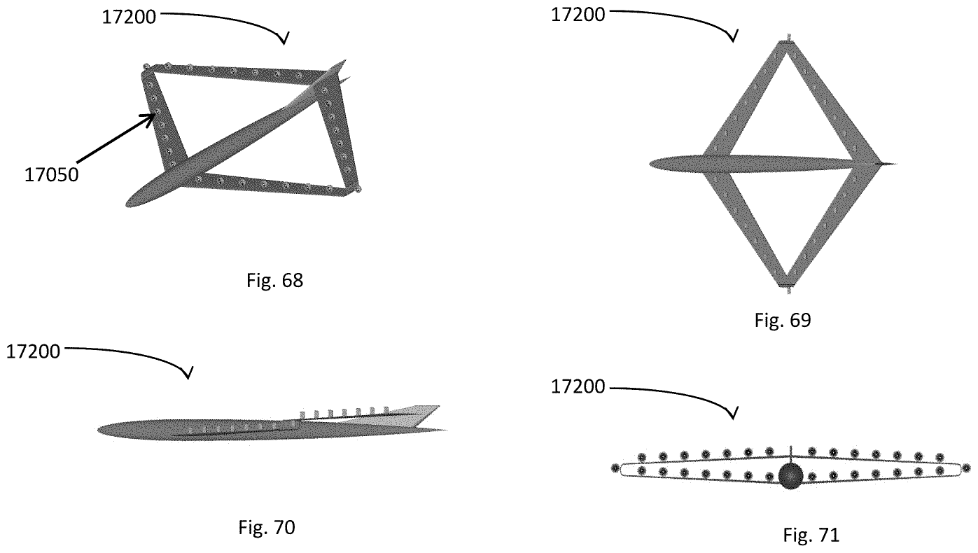

FIGS. 68 (isometric), 69 (top), 70 (side), and 71 (front) shows even more ETs 17050 (30 in number) in configuration 17200. The ET diameter may be smaller still.

| ET Type & | | Span | Chord | Thickness | |
|---|---|---|---|---|---|
| number | Span position | density | position | position | Fuselage |
| 30 EFs | Even | Even | LMC | AUS | Single |
| | distribution | | | | |

x. Varying Multiple Configuration Parameters Simultaneously

Using EPs Instead of EFs

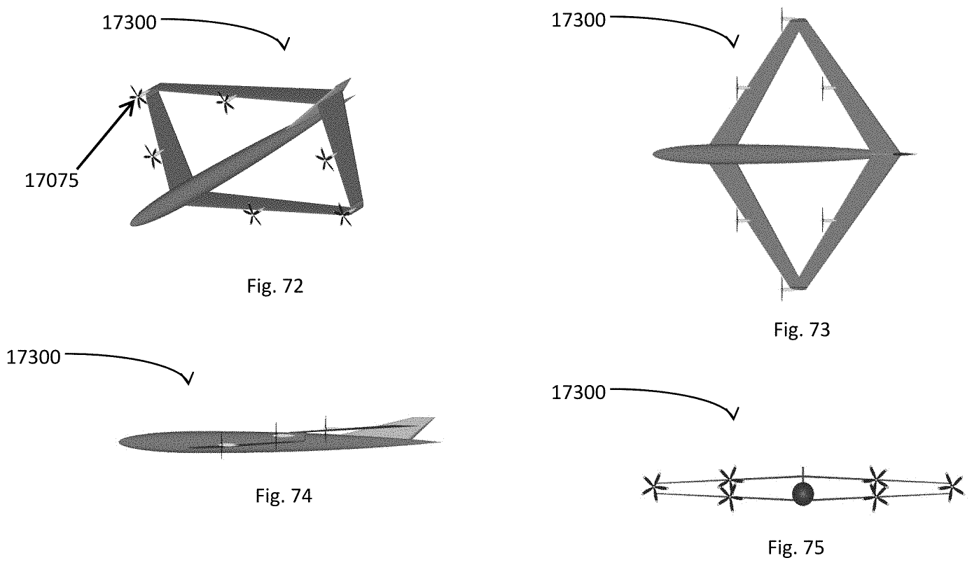

FIGS. 72 (isometric), 73 (top), 74 (side), and 75 (front) of a configuration 17300 that utilize EPs 17075 instead of EFs (e.g. 17050) in embodiments of the present invention.

| ET Type & | | Span | Chord | Thickness | |
|---|---|---|---|---|---|
| number | Span position | density | position | position | Fuselage |
| 6 EPs | Even | Even | XLE | XMTS | Single |
| | distribution | | | | |

Beyond changing EFs 17050 to EPs 17075, the position of the ETs 17075 along the chord and the thickness differ compared to the previous case.

Using a Mixture of EPs and EFs

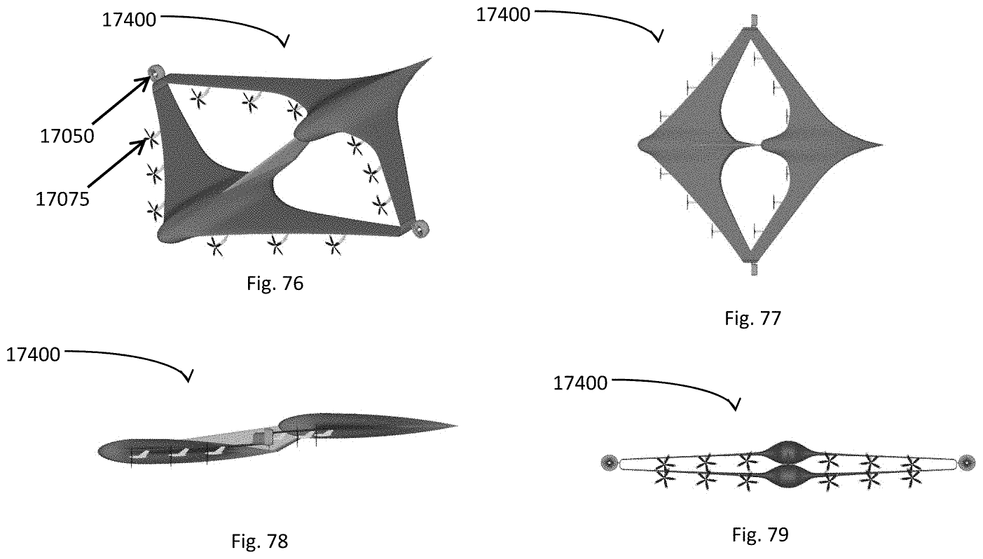

In another embodiment, a mixture of both EPs 17050 and EFs 17075 may be used. Such a configuration 17400 is shown in FIGS. 76 (isometric), 77 (top), 78 (side), and 79 (front).

| ET Type & | | Span | Chord | Thickness | |
|---|---|---|---|---|---|
| number | Span position | density | position | position | Fuselage |
| 12 EPs + | Even | Even | XLE & | BLS | BWB |
| 2 EFs | distribution | | XMC | | |

Beyond mixing EPs 17075 with EFs 17050, the number of ETs have increased, and mixed chord positions were used, and the type of fuselage is BWB such as BWB 4100 as shown in FIG. 11.

Using EPs of Different Sizes Inside and Outside the Wings

EFs 17050 with different sizes may be utilized, including internal EFs 17050 using shared extruded ducts as discussed earlier and shown in FIG. 45.

| ET Type & | | Span | Chord | Thickness | |
|---|---|---|---|---|---|
| number | Span position | density | position | position | Fuselage |
| 60 small internal EFs + | Uneven | Uneven | XLE & LMC | BLS & XMTE | Double |
| 8 medium external EFs + | distribution | | | | |
| 2 large external EFs | | | | | |

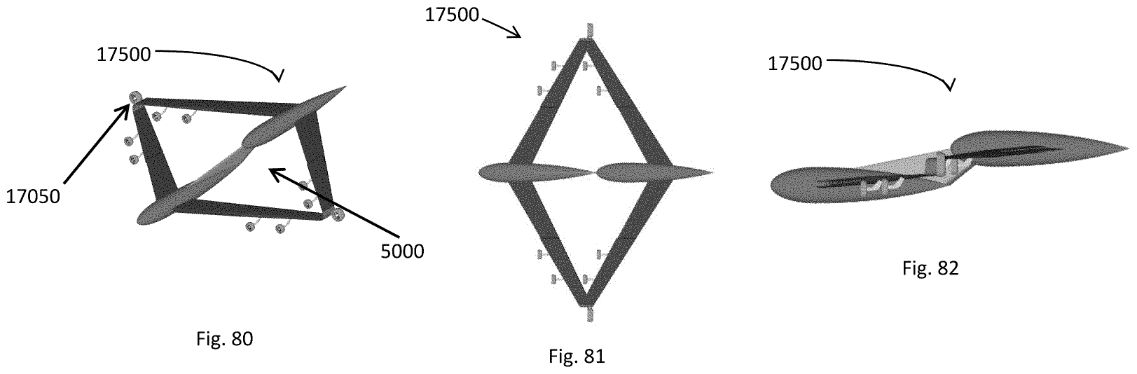

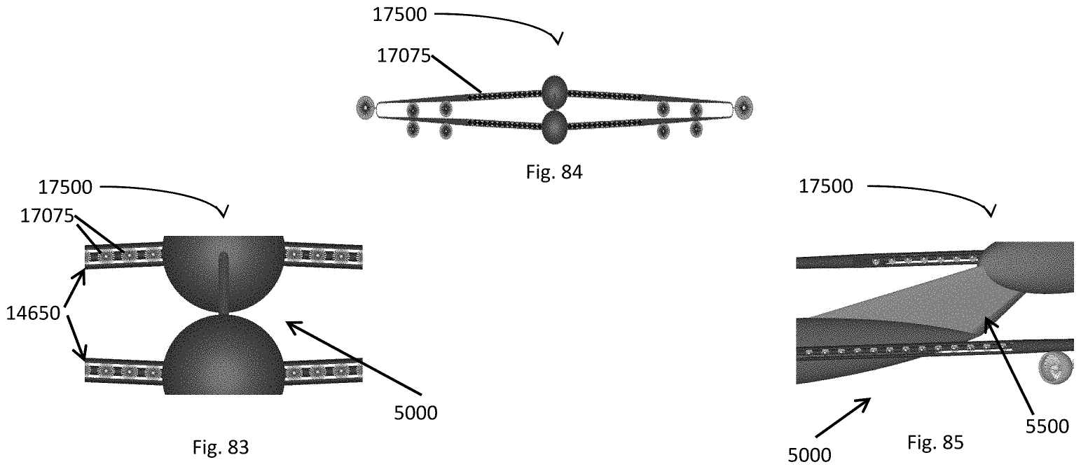

Beyond mixing different EFs 17050, the number of EFs 17050 can be increased. An example of this configuration 17500 in accordance with embodiments of the present invention is shown in FIGS. 80 (isometric), 81 (top), 82 (side), and 84 (front) uses mixed chord positions, mixed thickness positions. FIGS. 83 and 85 show a closer view of the double-fuselage 5000 with internally-mounted EFs in the inboard sections of the wings using extruded shared ducts 14650. Further, configuration 17500 utilizes the fuselage as shown in configuration 5000 shown in FIG. 15.

IV. Control and Stability Through Differential Thrust

i. Aircraft Axes, Moments, and Forces.

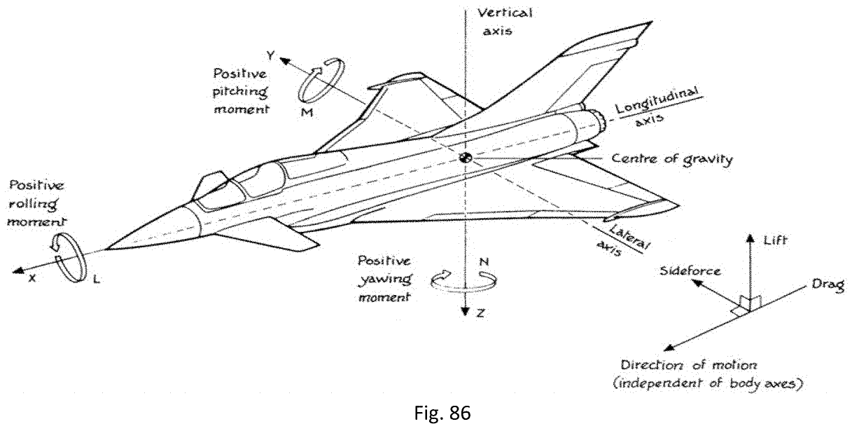

In traditional aircraft design, stability and control along all three axes as shown in FIG. 86 is typically achieved via various types of aerodynamic surfaces:
Lateral axis pitch control is achieved by various forms of horizontal stabilizers such as a tailplanes, elevators, stabilators, elevons, or canards.
Vertical axis yaw control is achieved by some form of vertical stabilizer, typically a rudder.
Longitudinal axis roll control is achieved by some form of horizontal surface near the wing tips such as ailerons, elevons, flaperons, or tail-mounted stabilators.

ii. Differential Thrust

With the wing configurations described above, including configuration 400 as shown in FIG. 2, and a DEP system with thrustors distributed along the spans of the LW and the TW, the above control functions can be augmented or replaced altogether in accordance with embodiments of the present invention by using differential thrust between judiciously chosen thrustors. The full 3-axis control authority is possible through an architecture that allows the distribution of thrustors in all three directions using configurations as those described above, including configuration 400:
There is thrustor distribution along the longitudinal axis between the LW and TW;
There is thrustor distribution along the lateral axis between starboard and port;
There is thrustor distribution along the vertical axis between a low-mounted wing and a high-mounted wing.

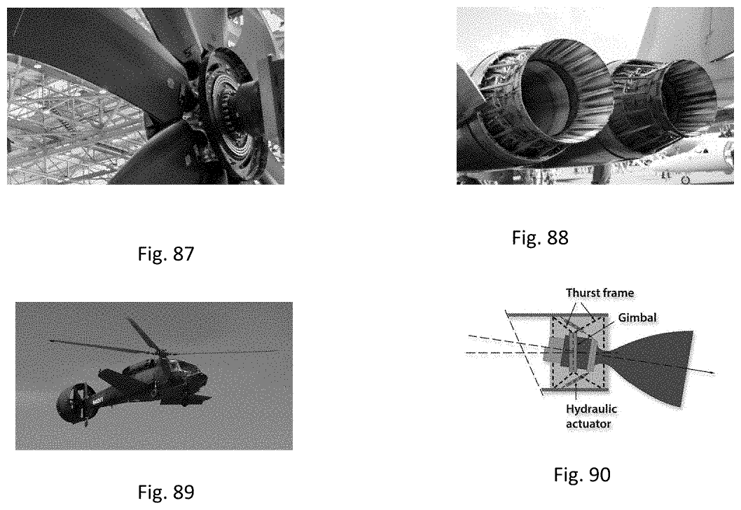

In general, the amount of thrust produced by each individual thrustor can be controlled using two methods:
One method relies solely on varying a propulsor's RPM. This is for example the method used on popular consumer quadcopters.
Another relies on varying a propulsor's blade pitch angle, if such control has been built into the propulsor. This method is available on many propeller-driven airplanes from small general aviation planes to large commercial and military turboprops, as shown in FIG. 87, which shows an Airbus A400M variable pitch propeller.

The above two methods can be combined if need be. Other thrust control possibilities exist but they could add substantial weight and complexity:

Variable geometry inlet/exhaust: if the propulsor has any ducting, the geometry of the inlet and/or outlet can be changed to increase/decrease thrust as shown in FIG. 88, which shows the F-15's variable geometry exhaust nozzles;

Thrust vectoring:
By vectoring the surfaces of the outlet ducts or nozzles, as shown in FIG. 89, which shows a vectored thrust duct propeller on the Piasecki X-49 SpeedHawk;
By 3D-vectoring the entire thrustor or at least its propulsor through gimbal-mounting, as in the case of rocket engines as shown in FIG. 90 or 2D-vectoring as in ship azimuth thrustors

Differential thrust as used in embodiments of the present invention: it is possible to provide control and stability via differential thrust in pitch, roll, and yaw for embodiments of the present invention. This is due to the fact that one can distribute a large number of ETs along all 3 axes of a DEP aircraft using tandem wings. Also, distributing the ETs along the wings allows the fine control of not just thrust, but also the fine control of the lift created locally at the mounting location of the ET on the wing. In other words, differential thrust is accompanied with and benefits from differential induced lift.

Pitch Control

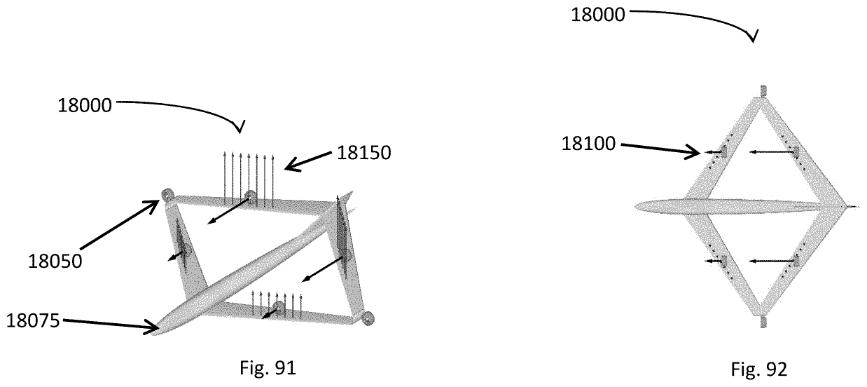

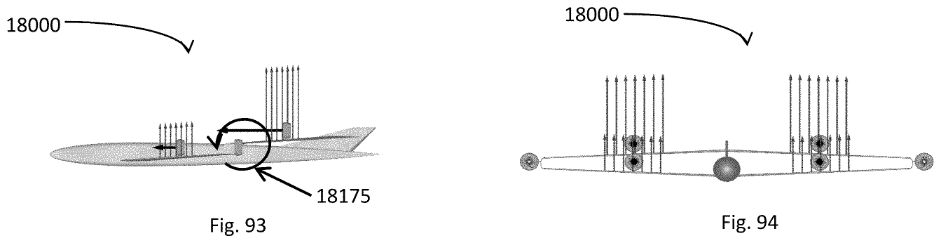

Pitch control can be augmented (or replaced altogether) in accordance with embodiments of the present invention by using one or several high-mounted thrustors producing a different amount of thrust compared to their low-mounted counterpart(s). For example, shown in FIGS. 91 (isometric of pitch down control via differential thrust of 2 high-mounted vs. two low-mounted ETs 18050, 92 (top), 93 (side), and 94 (front) of configuration 18000, which is based on configuration 400 in FIG. 2.

Wings:

1. LW is a low-mounted BSW

2. TW is a high-mounted FSW

Single fuselage 18075 is used.

Propulsion: 6 electrofan thrustors
1. 4 thrustors are mounted at:
   XMS (S3) along the span
   LMC (C2) along the chord
   AUS (T5) along the thickness
2. 2 thrustors are shared by the LW and TW at their common winglets and mounted at
   XTP (S5) along the span
   LMC (C2) along the chord

In embodiments of the present invention, the arrows along longitudinal axis 18100 indicate the direction and intensity of the thrust force vectors, upward arrows 18150 indicate the direction and intensity of the induced lift force vectors, and the circular arrow 18175 indicates the pitching moment.

Pitch down control is achieved when the high-mounted thrustors on the TW produce higher thrust than two low-mounted thrustors on the LW. The pitch down moment is produced by at least two very distinct sources:
The first source is the horizontally directed thrust force vectors and their different vertical positions: higher vertical position of the larger thrust vectors vs. the lower vertical position of the smaller thrust vectors.
The second source is the quasi-vertically directed lift force vectors and their different longitudinal positions: larger lift induced by the larger air flow on the aft-mounted TW, versus the smaller lift induced by the smaller air flow on the front-mounted LW.

This 6-thrustor configuration 18000 above is a minimalistic configuration from the control perspective. Any other configuration with a larger number of thrustors distributed along the 3 aforementioned axes is also possible, with any number of fuselages, and with any type of propulsors mounted at different mounting stations.

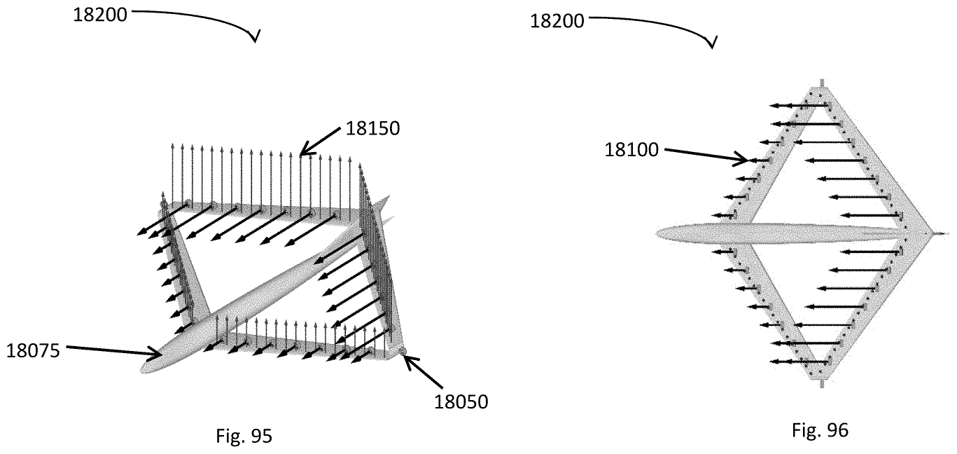

In other embodiments, a configuration with a higher ET 18050 density may produce even finer levels of control. FIGS. 95 (which shows an isometric view of pitch down control via differential thrust of 14 high-mounted vs. 14 low-mounted ETs 18050), 96 (top), 97 (side), and 98 (front) show a 30-thrustor configuration 18200.

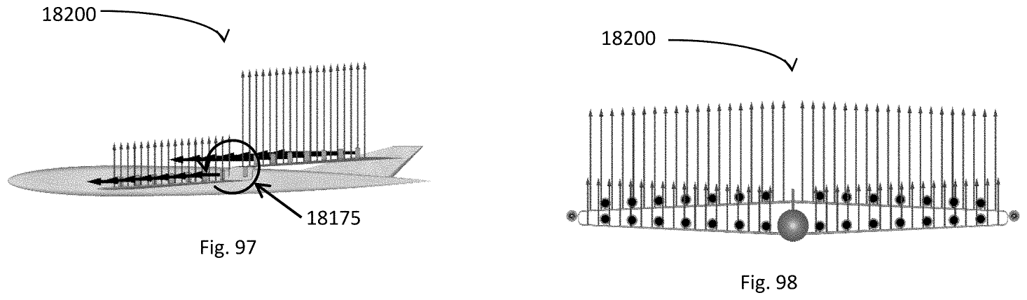

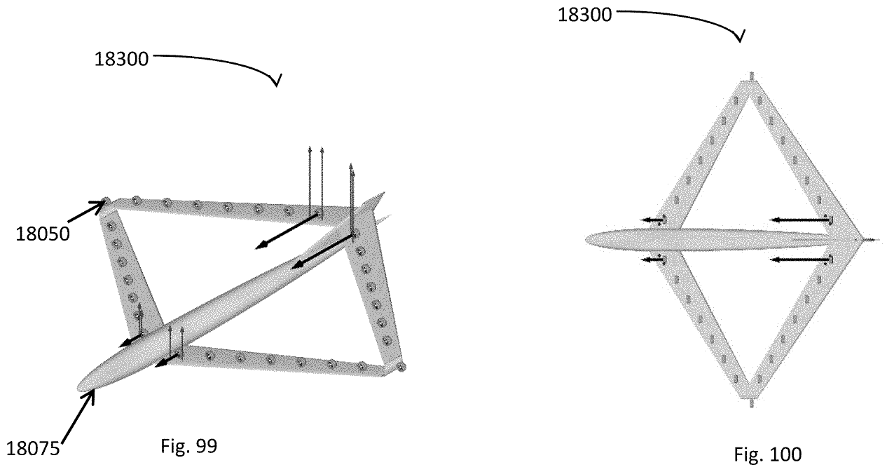

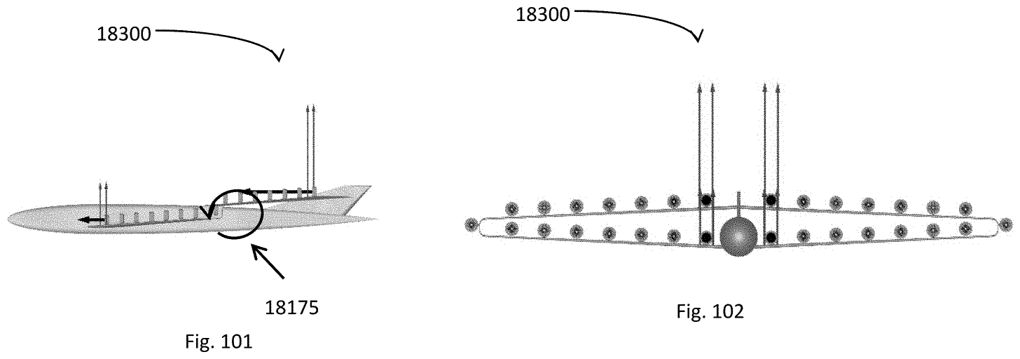

The two wingtip-mounted ETs 18050 do not participate in pitch control. The other 28 ETs 18050 can contribute to pitch control. There are multiple ways to control and fine-tune the intensity of pitching moment. As stated previously, the simplest method of applying differential thrust is to change the RPM of the ETs 18050. If the ET 18050 density is high, one can also adjust the number of ETs 18050 participating in pitch control. In the aforementioned 30-thrustor configuration, one can use as many as 28 ETs (FIGS. 95-98) or as few as 4 ETs (FIGS. 99, 100, 101, and 102) which show configuration 18300.

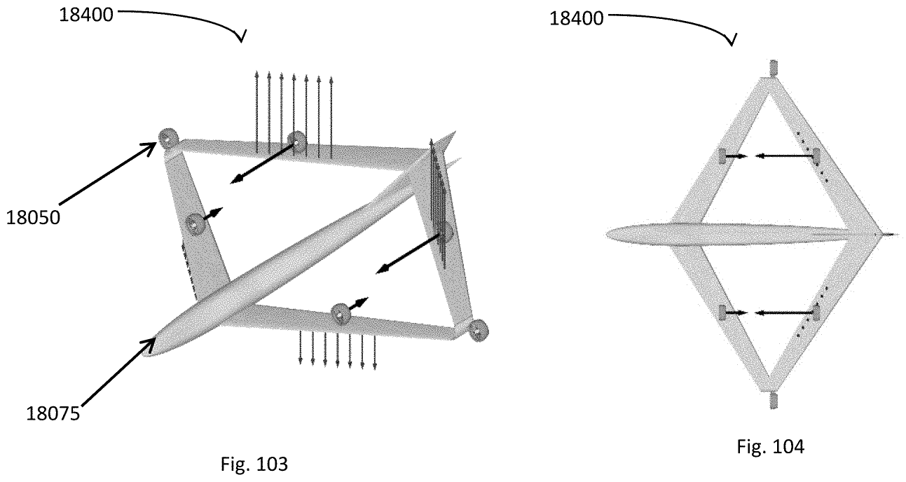

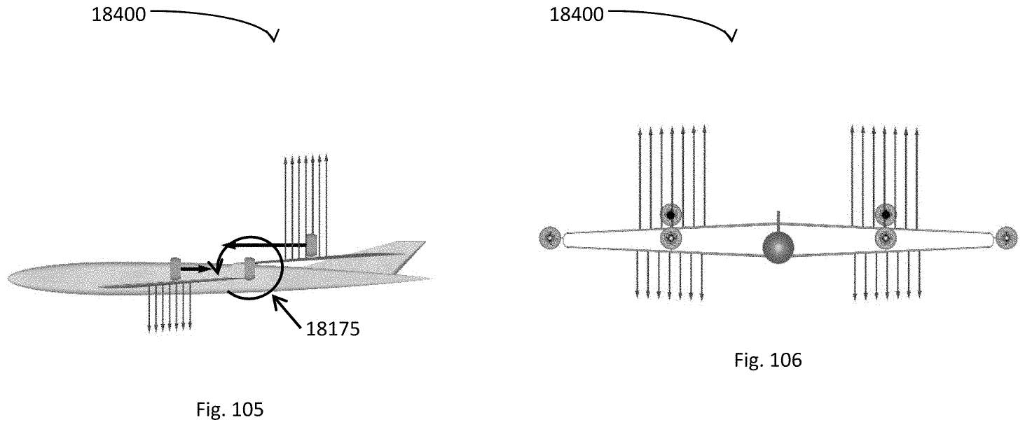

In addition to changing RPM or using a different number of ETs 18050, another method in accordance with embodiments of the present invention relies on changing the blade pitch angles of the propulsors in the ETs, if such mechanism is included. A drastic pitch down moment can be achieved if the low-mounted thrustors reduce their blade pitch angles (windmill mode) or reverse them altogether (thrust reverser mode), thus producing drag instead of thrust as illustrated in FIGS. 103 (Isometric view of drastic pitch down control via differential thrust of 2 high-mounted ETs vs. 2 low-mounted ETs in thrust reversal mode, configuration 18400), 104 (top), 105 (side), and 106 (front). If the ETs 18050 do not include any blade pitch control, a similar effect could potentially be achieved by reversing the RPM of the motors. Beyond the reversal of the LW thrust vectors and turning them into drag vectors, the induced lift would then also be either reduced or possibly even turned into negative lift altogether. This can have potential super-maneuverability applications for emergency maneuvers, aerobatics, or military combat.

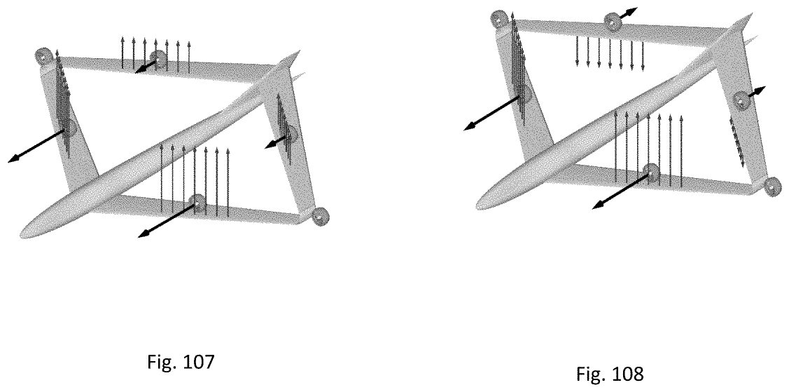

As for pitch up control, the roles of the low-mounted and high-mounted ETs are reversed: it can be achieved with higher thrust (and consequently higher induced lift) at the low-mounted LW thrustors while lower thrust (or even drag) is produced at the high-mounted TW thrustors as illustrated in FIGS. 107 (isometric view of pitch up control via differential thrust of 2 high-mounted ETs vs. 2 low-mounted ETs) and 108 (isometric view of drastic pitch up control via differential thrust of 2 high-mounted ETs in thrust reversal mode vs. 2 low-mounted ETs.

Yaw Control

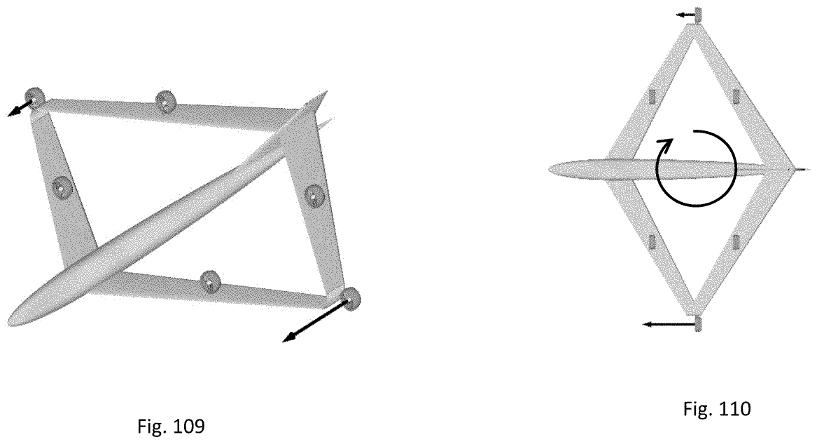

Yaw control can be augmented (or replaced altogether) in accordance with embodiments of present invention by using one or several starboard-mounted thrustors producing a different amount of thrust compared to their port-mounted counterpart(s). In the 6-thrustor illustrative example shown earlier, yaw to starboard is achieved when the wingtip-mounted thrustor on the port side produces higher thrust than the wingtip-mounted thrustor on starboard as shown in FIGS. 109 (isometric view of yaw to starboard control via differential thrust of wingtip mounted ETs) and 110 (top view of yaw to starboard control via differential thrust of wingtip mounted ETs.).

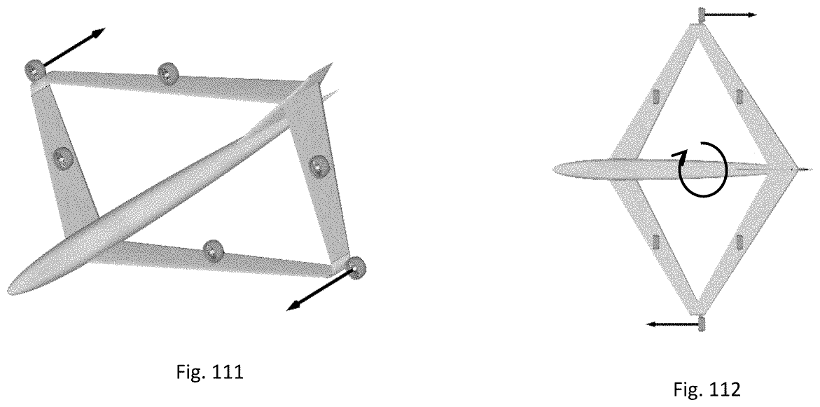

Similarly, in another embodiment a more drastic yaw to starboard moment can be achieved if the starboard-mounted thrustor reduces its blade pitch angles, if propulsor does have blade pitch control (windmill mode) or reverses them altogether (thrust reverser mode), thus producing drag instead of thrust as shown in FIGS. 111 (isometric view of drastic yaw to starboard control via thrust reversal of starboard wingtip-mounted ET), and 112 (top view of drastic yaw to starboard control via thrust reversal of starboard wingtip-mounted ET). Once again, this can have potential super-maneuverability applications.

Roll Control

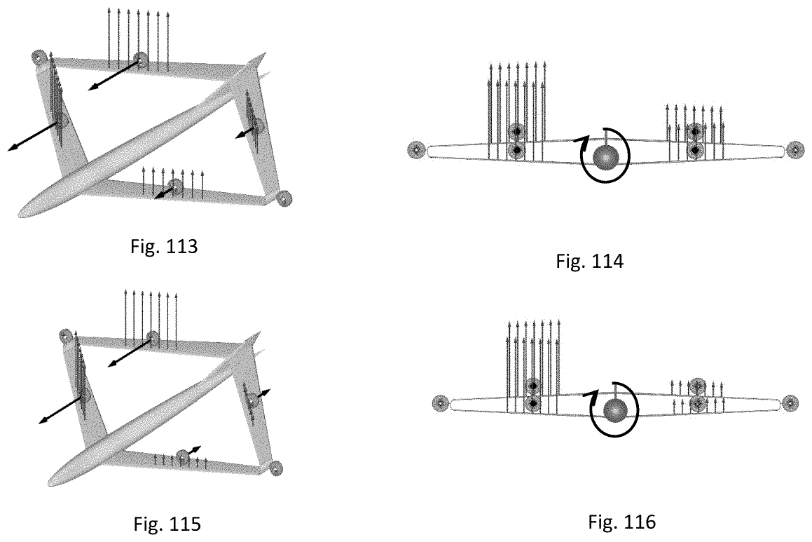

Roll control can be augmented (or replaced altogether) in accordance with embodiments of the present invention by using one or several starboard-mounted thrustors producing a different amount of air flow, and therefore induced lift, compared to their port-mounted counterpart(s). In the 6-thrustor illustrative example shown earlier, roll to port is achieved when the midspan-mounted thrustors on starboard produce higher air flow and therefore induce more lift than the midspan-mounted thrustors on port as shown in FIG. 113 (isometric view of roll to port control via differential thrust and induced lift of midspan-mounted ETs) and FIG. 114 (front view of roll to port control via differential thrust and induced lift of midspan-mounted ETs.)

In another embodiment, more drastic roll to port moment can be achieved if the port-mounted thrustors reduce their blade pitch angles or reverse them altogether thus producing drag instead of thrust and potentially even stalling portions of the port wings as shown in FIG. 115 (isometric view of drastic roll to port control via differential thrust and induced lift of midspan-mounted ETs including thrust reversal of port midspan-mounted ETs) and 116 (front view of roll to port control via differential thrust and induced lift of midspan-mounted ETs including thrust reversal of port midspan-mounted ETs). Once again, this can have potential super-maneuverability applications.

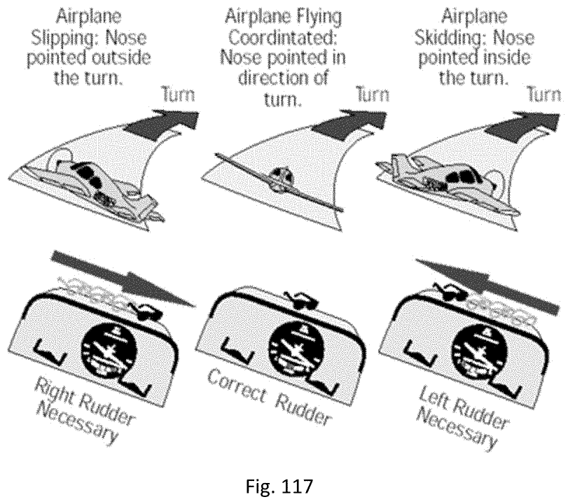

Note that in this method of roll control via induced lift, roll and yaw occur simultaneously, which can be advantageous. In most traditional airplanes, using ailerons produces an adverse roll in the opposite direction that must be compensated by rudder action in order to perform a coordinated turn, as shown in FIG. 117. Failure to do so results in a “slipping turn” where the nose of the aircraft slips outside the turn. In the case of present embodiment, the induced yaw is indeed in the desired direction. If the present embodiment's induced yaw turns out to be excessive however, the craft might “skid” into the turn, which would not be desirable. In such a situation, the wingtip-mounted thrustors in accordance with embodiments of the present invention can negate the excessive yaw accordingly without affecting the airflow on the wings, i.e. without affecting the induced wing lift. In summary, embodiments of the present invention should always be able to perform a coordinated turn either naturally, or by using some assistance from the wingtip-mounted thrustors.

Stability

Traditional approaches to the stability problem lead to designs where the aircraft naturally returns to a stable level attitude upon unintended changes to the desired attitude. This is the basis for aircraft passive stability, but this natural stability comes at the expense of aircraft aerodynamic performance. In a Control Configured Vehicle (CCV), corrections to the aircraft's attitude are carried out by a Flight Control Computer (FCC). This is the basis for active stability, also known as artificial stability. Since the advent of the artificial stability in the 1970s, it has become increasingly possible to provide artificial stability through FCC to aircraft. Present embodiments may not need to be naturally stable as it can make use of state-of-the-art relaxed static stability and fly-by-wire (RSS/FBW) systems as needed, in conjunction with the control system described above. The differential thrust control mechanisms described above are well-adapted to computer-assisted active stability.

V. Takeoff and Landing

Lift Production: Airplane Vs. Helicopter

One of ordinary skill in the art can compare certain aspects of lift production in airplanes vs. helicopters. Fixed-wing airplanes and rotary-wing helicopters produce lift in both similar and different ways. The similarity resides in the fact that both aircraft types move air over and under a lifting surface.

In the case of the airplane, the lifting surface is a fixed wing and air is moved over and under the wing by moving/translating the entire craft forward. There are inherent advantages and disadvantages built into this concept. The advantage is that once the forward movement of the entire craft has gradually built up momentum, it is relatively easy to keep the momentum. The engine must simply produce enough thrust to negate the drag during cruise to conserve the momentum and therefore the lifting force. The disadvantage is that without the gradually acquired and continually maintained forward movement, there is not enough air flowing over and under the wings to keep the airplane afloat, therefore a traditional fixed-wing airplane cannot hover in place.

In the case of the helicopter, initially it is not the entire craft that is moving through the air, it is only its lifting surfaces, i.e. the rotor blades that are moved/rotated with respect to air. This gives the helicopter the ability to hover, albeit at great cost to forward flight efficiency. Even though the rotors are massive compared to an airplane's propeller, the momentum they build is much less than the momentum of the entire craft's movement. When the helicopter is near the ground, the ground effect helps the hover efficiency, but once it moves out of ground effect, the hover efficiency decreases. Once the helicopter starts moving forward, some hover efficiency is regained due to the combined helicopter forward movement and the rotor rotation. Once again, there are inherent advantages and disadvantages built into this concept. The helicopter's inherent advantage of vertical takeoff/landing and hovering in place by rotating its wings, becomes a disadvantage once it starts moving forward at fast speeds. On one side of the craft, the blade advances into the airstream while on the other side the blade retreats requiring complex mechanical solutions that continuously change the pitch angle of the blades as they rotate. Eventually, there are aerodynamic limits to what can be done with this concept. Some of the most challenging limits are that the advancing blade sees higher relative wind velocities that lead to compressibility effects and shock waves near rotor tips, while the retreating blade sees lower relative wind velocities forcing it to adopt ever higher angles of attack that eventually lead to stall.

Modes of Takeoff and Landing

The aircraft configurations described above, featuring tandem wings, distributed propulsion, differential thrust control, etc., lend themselves to improved flight performance for a wide array of applications and mission profiles. Accordingly, the present embodiments can be optimized for various requirements in terms of takeoff and landing operations (Table 12). On the simplest end of the spectrum, the configurations above can be optimized for conventional takeoff and landing (CTOL). On the opposite end, it can be optimized for vertical takeoff and landing (VTOL). In between these two extremes, short takeoff and landing (STOL) is possible. Pushing STOL operations to their limit results in what could be termed as extreme(ly) short takeoff and landing (XSTOL).

TABLE 12
Modes of takeoff and landing ordered by difficulty.

| | |
|---|---|
| CTOL | Conventional Take-Off and Landing. |
| STOL | Short Take-Off and Landing. |
| XSTOL | Extreme(ly) Short Take-Off and Landing. |
| VTOL | Vertical Take-Off and Landing. |

Currently, most fixed-wing aircraft operate in CTOL. Some have STOL capabilities, often military cargo airplanes. Very few have XSTOL capability, usually small bush planes. Despite decades of attempts to produce compelling fixed-wing architectures, VTOL is still heavily dominated by rotary wing aircraft.

CTOL

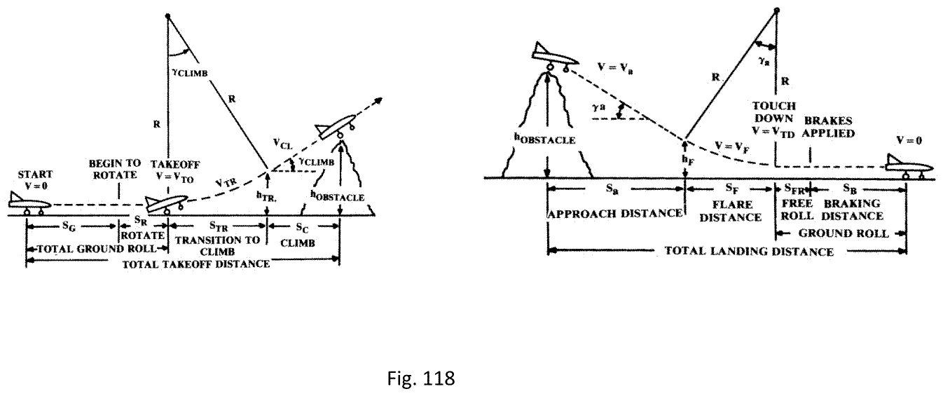

Conventional takeoff and landing (CTOL) involving acceleration and deceleration on a runway is the most widespread method of takeoff and landing (FIG. 118). It allows for relatively small thrust to weight ratios which translates directly into cheaper and more efficient air transport as long as an appropriate runway is available.

High-Lift Devices

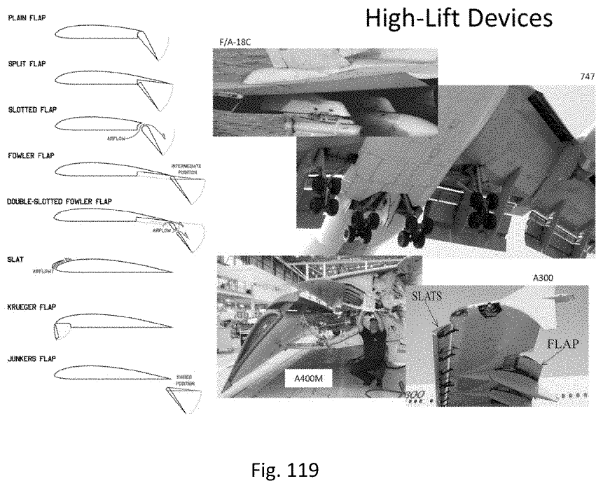

Most airplanes use some form of high-lift device at their trailing edge TE and leading edge LE for takeoff and landing. The most common devices are passive/unpowered and work by altering the shape of the wing/airfoil mechanically. They typically include flaps, slats, and slots (FIG. 119). Less commonly there are active/powered devices to control the boundary layer and prevent it from separating by flow injection or suction.

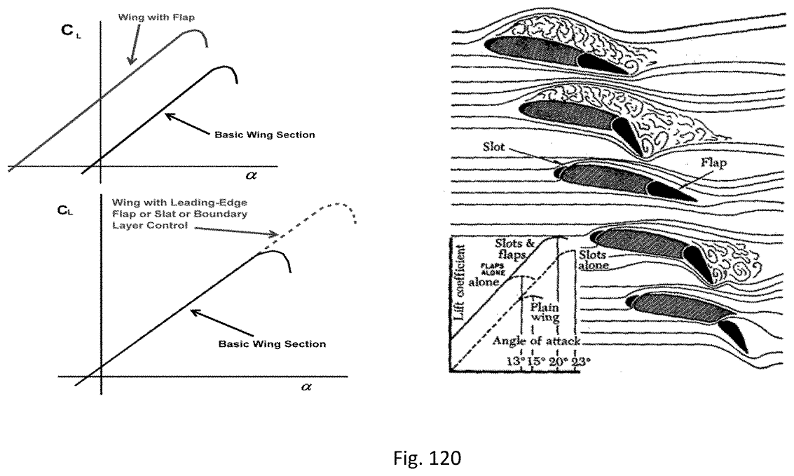

TE devices usually help increase the lift of a wing while flying at the same angle of attack, which essentially allows a plane to produce high lift while flying slower. LE devices push the onset of stall to higher angles of attack. The combined usage of TE and LE devices ultimately allows airplanes to have higher lift at lower velocities allowing them to easily takeoff from and land on shorter runways at safer speeds (FIG. 120).

From CTOL to STOL: Blowing Air onto the Wing

Powered Lift

Airflow behind a propeller is commonly referred to as slipstream. Although traditionally airflow behind a jet engine is referred to as “jet” or “jet exhaust”, in this document we will use the word slipstream regardless of whether the propulsor producing it is ducted or ductless.

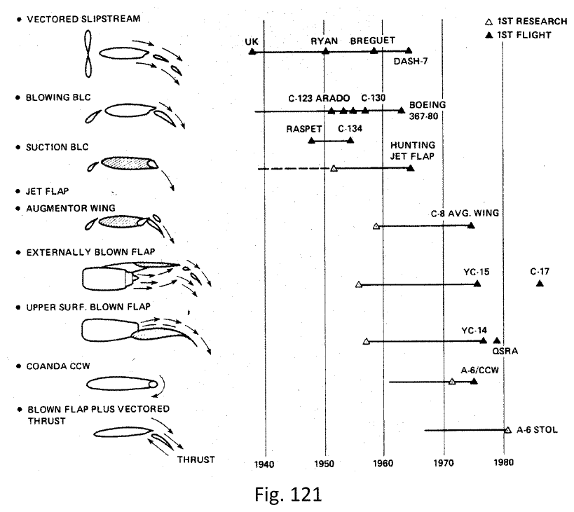

Wings will produce lift whether one moves the wing through the air, or one blows air onto the wing. When lift is produced in the latter form using engine power, we have powered lift. Some powered lift approaches rely on external flow and others on internal flow. FIG. 121 summarizes various approaches to powered lift including the use of slipstream from ductless propellers and ducted fans.

Note that the description of powered lift as stated above might differ from the FAA's definition which is more restrictive as it assumes VTOL capability:

“Powered-lift means a heavier-than-air aircraft capable of vertical takeoff, vertical landing, and low speed flight that depends principally on engine-driven lift devices or engine thrust for lift during these flight regimes and on nonrotating airfoil(s) for lift during horizontal flight.”

Fixed wing airplanes usually have portions of the wings subjected to the slipstream. This could locally increase the lift of the wing in areas where the wing is immersed in the accelerated airflow downstream of the propulsors. STOL airplanes take advantage of propulsor slipstream combined with very elaborate high-lift devices to produce significantly higher lift during takeoff and landing compared to CTOL airplanes.

Externally Blown Wings and Large STOL Airplanes

External methods of powered lift are generally more common than the internal ones. They are widely used on large STOL airplanes and often fall into one of the following three categories.

Blown Lower Surface

The slipstream is blown onto the lower surface of the wing, usually at mounting positions RMS (S2) through MST (S4) along the span, XLE (C1) along the chord, and BLS (T1) or XLS (T2) along the thickness:

This is the most common method when using jet engines, especially for STOL military cargo airplanes.

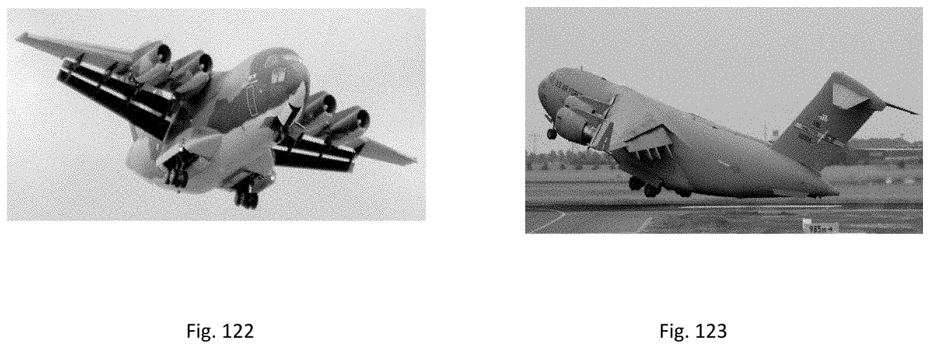

This method was researched in the 1970s on the experimental YC-15 (FIG. 122). Even though the YC-15 was not ordered into production, it became the basis for a future production airplane, the C-17 (FIG. 123).

Blown Upper Surface

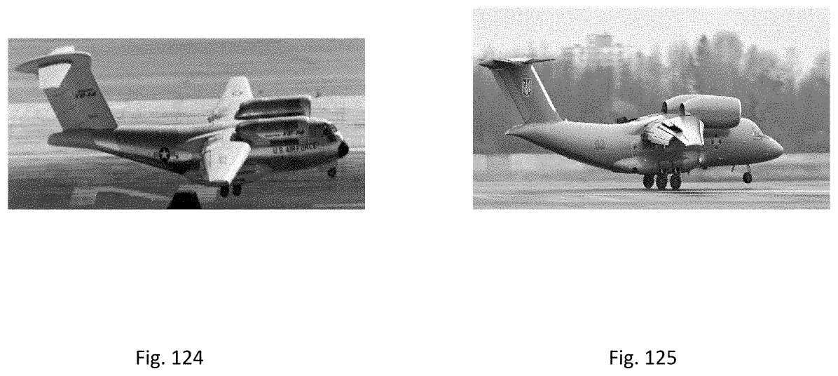

The slipstream is blown onto the upper surface of the wing, usually at mounting positions XRT (S1) or RMS (S2) along the span, XLE (C1) along the chord, and XUS (T4) along the thickness:
This is less common than the above method. It relies on the Coandă effect, the tendency of a fluid jet to stay attached to a convex surface.
This method was also researched in the 1970s on the experimental YC-14 (FIG. 124). Even though the YC-14 or any similar design was not ordered into production in the United States, this design found some production success on its Soviet counterparts, the An-72 and its successor the An-74 (FIG. 125).

Blown upper and lower surfaces

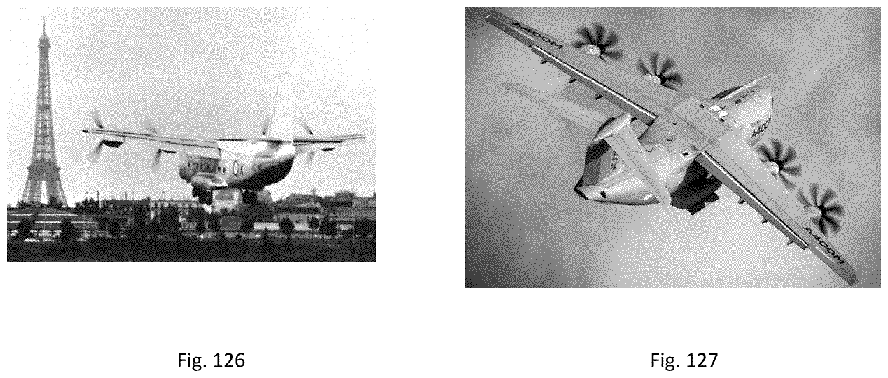

The slipstream is blown onto both the lower and upper surfaces of the wing, usually at mounting positions RMS (S2) through MST (S4) along the span, XLE (C1) along the chord, and XLS (T2) or XMTS (T3S) along the thickness:
This is probably the most common of the three methods.
This method has seen production on a large number of propeller-powered (mostly turboprop) airplanes, both CTOL and STOL.
Due to a propeller's large diameter, there is a natural tendency to blow air onto both the upper and the lower surfaces of a wing, even when the thrustor mounting position along the thickness is S1 or S2.
Pioneers of large military cargo STOL airplanes used this method since the 1950s, especially with the Breguet 941 (FIG. 126). A more recent example is the A400M (FIG. 127).

From STOL to XSTOL

STOL Definition

There may be some degree of vagueness in the way STOL is defined. Typically, the focus is on the total horizontal distance from the start of the takeoff or landing including a 50-foot (15-meter) obstacle to clear. One of the shortcomings of this approach is that there is no requirement on the length of the takeoff or landing roll as seen previously in FIG. 118. There are also no STOL criteria adjustments in terms of airplane weight and/or dimensions. The DOD/NATO definition of STOL reads:

“The ability of an aircraft to clear a 50-foot (15 meters) obstacle within 1,500 feet (450 meters) of commencing takeoff or in landing, to stop within 1,500 feet (450 meters) after passing over a 50-foot (15 meters) obstacle.”

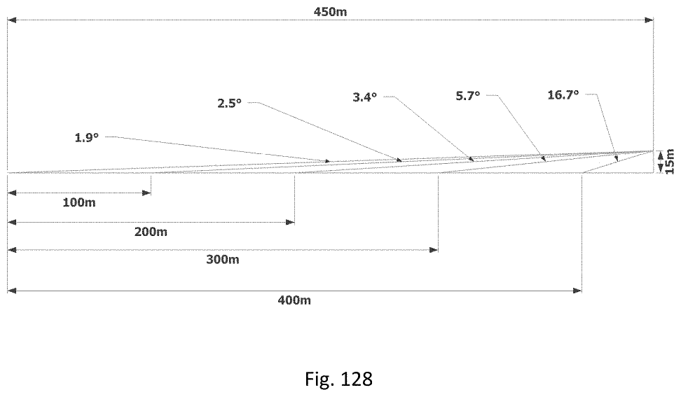

Table 13 and FIG. 128 show various combinations of ground roll distance and climb horizontal distance that would qualify as STOL takeoff STOL landing would be similar. Unlike the sketches of FIG. 118 where the scales were exaggerated for illustration, the sketch of FIG. 128 is closer to scale.

TABLE 13
Various combinations of ground roll and climb
horizontal distance qualifying as STOL takeoff.

| | | |
|---|---|---|
| Ground roll | Climb horizontal | |
| distance | distance | Climb angle |

| (m) | (ft) | (m) | (ft) | (°) | Ratio |
|---|---|---|---|---|---|
| 0 | 0 | 450 | 1500 | 1.9 | 30:1 |
| 100 | 350 | 350 | 1150 | 2.5 | 23:1 |
| 200 | 650 | 250 | 800 | 3.4 | 17:1 |
| 300 | 1000 | 150 | 500 | 5.7 | 10:1 |
| 400 | 1300 | 50 | 150 | 16.7 | 3:1 |
| 450 | 1500 | 0 | 0 | 90 | N/A |

(ft) is rounded to nearest 50 ft increment.

Takeoff and landing in CTOL typically occur at shallow angles in the vicinity of 3 degrees. STOL operations on the other hand could include very steep angles beyond 6 degrees.

STOL performance is highly sensitive to aircraft size/weight. Wikipedia has a list of STOL airplanes, reproduced almost in its entirety with a few additions and deletions in Table 14. Even though the list is incomplete, it allows one to notice a few standout facts:
With a few exceptions, takeoff distance is always longer than landing distance and therefore constitutes the limiting factor in deciding whether an aircraft falls into the STOL category according to the DOD/NATO definition;
Weight:
   The table doesn't have any info on aircraft weights, but checking the “specifications” section for each aircraft in Wikipedia shows that airplanes with the shortest STOL performance are usually the smaller and lightest ones;
   Many of the large military cargo airplanes discussed earlier (YC-14, YC-15, C-17, and A400M) do not even fall under the strict STOL definition, even though they were designed with STOL requirements and have indeed much shorter takeoff and landing capabilities compared to their CTOL counterparts in the same weight category;
Most of the highest-performing airplanes in the table typically share an extremely simple and low-tech configuration:
   Single engine
   Tail-dragger
   Conventional front wing/aft tail
   High-wing
   Leading edge slats

TABLE 14
Wikipedia's (incomplete) list of STOL aircraft (with a few additions and deletions).

| | | | | Take-off to | | Landing from | |
|---|---|---|---|---|---|---|---|
| Type | Country | Date | Role | 50 ft (15 m) | | 50 ft (15 m) | |
| AAC Angel | US | 1984 | Utility | 1,404 ft | (428 m) | 1,046 ft | (319 m) |
| Antonov An-14 | Soviet | 1958 | Transport | 656 ft | (200 m) | 985 ft | (300 m) |
| | Union | | | | | | |
| Antonov An-72 | Soviet | 1977 | Transport | 1,312 ft | (400 m) | 1,148 ft | (350 m) |
| | Union | | | | | | |
| Auster AOP.9 | UK | 1954 | Artillery | 675 ft | (206 m) | 150 ft | (46 m) |
| | | | observer | | | | |
| Australian Aircraft | Australia | 2004 | Ultralight | 656 ft | (200 m) | 623 ft | (190 m) |
| Kits Hornet STOL | | | | | | | |
| Bounsall Super | US | 1990 | Homebuilt | 300 ft | (91 m) | 250 ft | (76 m) |
| Prospector | | | | | | | |
| Breguet 941 | France | 1958 | Transport | 860 ft | (262 m) | 800 ft | (244 m) |
| Britten-Norman | UK | 1970 | Transport | 1,050 ft | (320 m) | 995 ft | (303 m) |
| Defender | | | | | | | |
| Britten-Norman | UK | 1965 | Airliner | 1,100 ft | (335 m) | 960 ft | (293 m) |
| Islander | | | | | | | |
| Conroy Stolifter | US | 1968 | | 450 ft | (137 m) | 400 ft | (122 m) |
| De Havilland Canada | Canada | 1947 | Transport | 1,015 ft | (309 m) | 1,000 ft | (305 m) |
| DHC-2 Beaver Mk 1 | | | | | | | |
| De Havilland Canada | Canada | 1947 | Transport | 920 ft | (280 m) | 870 ft | (265 m) |
| DHC-2 Beaver Mk III | | | | | | | |
| De Havilland Canada | Canada | 1951 | Transport | 1,155 ft | (352 m) | 880 ft | (268 m) |
| DHC-3 Otter | | | | | | | |
| De Havilland Canada | Canada | 1959 | Transport | 1,040 ft | (317 m) | 590 ft | (180 m) |
| DHC-4 Caribou | | | | | | | |
| De Havilland Canada | Canada | 1965 | Utility | 2,100 ft | (640 m) | 2,100 ft | (640 m) |
| DHC-5 Buffalo | | | | | | | |
| De Havilland Canada | Canada | 1966 | Utility | 1,200 ft | (366 m) | 1,050 ft | (320 m) |
| DHC-6 Twin Otter | | | | | | | |
| De Havilland Canada | Canada | 1975 | Airliner | 1,200 ft | (366 m) | 1,050 ft | (320 m) |
| Dash 7 | | | | | | | |
| Dornier Do 27 | Germany | 1955 | Utility | 558 ft | (170 m) | 525 ft | (160 m) |
| Dornier Do 28 | Germany | 1959 | Utility | 1,020 ft | (311 m) | 1,000 ft | (305 m) |
| Evangel 4500 | US | 1964 | Transport | 1,125 ft | (343 m) | 1,140 ft | (347 m) |
| Fieseler Fi 156 Storch | Germany | 1936 | Utility | 350 ft | (107 m) | 310 ft | (94 m) |
| Helio Courier H-295 | US | 1955 | Utility | 610 ft | (186 m) | 520 ft | (158 m) |
| IAI Arava | Israel | 1972 | Transport | 984 ft | (300 m) | 902 ft | (275 m) |
| Javelin V6 STOL | US | 1949 | Homebuilt | 150 ft | (46 m) | 300 ft | (91 m) |
| Maule M-5 | US | 1974 | Utility | 550 ft | (168 m) | 600 ft | (183 m) |
| PAC P-750 XSTOL | New | 2001 | Utility | 1,196 ft | (365 m) | 950 ft | (290 m) |
| | Zealand | | | | | | |
| Peterson 260SE/Wren | US | 1988 | Utility | 1,000 ft | (305 m) | 1,000 ft | (305 m) |
| 460 | | | | | | | |
| Pilatus PC-6 Porter | Switzerland | 1959 | Utility | 600 ft | (183 m) | 550 ft | (168 m) |
| Piper J-3 Cub | US | 1938 | Utility | 755 ft | (230 m) | 885 ft | (270 m) |
| PZL-104 Wilga | Poland | 1962 | Utility | 625 ft | (191 m) | 780 ft | (238 m) |
| PZL-105M | Poland | 1989 | Utility | 1,109 ft | (338 m) | 1,070 ft | (326 m) |
| Quest Kodiak | US | 2005 | Transport | 760 ft | (232 m) | 915 ft | (279 m) |
| Scottish Aviation | UK | 1947 | Transport | 555 ft | (169 m) | 660 ft | (201 m) |
| Pioneer | | | | | | | |
| Scottish Aviation | UK | 1955 | Transport | 1,071 ft | (326 m) | 870 ft | (265 m) |
| Twin Pioneer | | | | | | | |
| ShinMaywa US-2 | Japan | 2007 | Air-Sea | 920 ft | (280 m) | 1,080 ft | (329 m) |
| | | | Rescue | | | | |
| Short SC.7 Skyvan | UK | 1963 | Transport | 1,050 ft | (320 m) | 1,485 ft | (453 m) |
| SIAI-Marchetti | Italy | 1952 | Amphibian | 1,400 ft | (427 m) | 1,100 ft | (335 m) |
| FN.333 Riviera | | | | | | | |
| SIAI-Marchetti | Italy | 1969 | Utility | 1,185 ft | (361 m) | 922 ft | (281 m) |
| SM.1019 | | | | | | | |
| Slepcev Storch | Serbia | 1994 | Ultralight | 126 ft | (38 m) | 110 ft | (34 m) |
| Spectrum SA-550 | US | 1983 | Transport | 675 ft | (206 m) | 675 ft | (206 m) |
| Sukhoi Su-80 | Russian | 2001 | Transport | 2,686 ft | (819 m) | 1,715 ft | (523 m) |
| | Federation | | | | | | |
| Westland Lysander I | UK | 1936 | Utility | 690 ft | (210 m) | 990 ft | (300 m) |
| Zenith STOL CH 701 | US | 1986 | Trainer | 1,257 ft | (383 m) | 1,257 ft | (383 m) |
| Zenith STOL CH 801 | US | 2011 | Homebuilt | 400 ft | (122 m) | 300 ft | (91 m) |

Extreme STOL (XSTOL)

There may not be a clear definition as to what constitutes XSTOL. Previously mentioned is that the definition of STOL had a number of shortcomings:
Lack of distinction between the ground roll distance and the horizontal distance to clear the 50-foot (15-meter) obstacle;
Lack of consideration for airplane size and/or weight.

The Square-Cube law makes the latter particularly challenging in aircraft design. As an aircraft doubles in length/span/height, the surfaces/areas that determine its flight characteristics quadruple and the corresponding volumes octuple. For example, a larger frontal area or a larger wetted area results in more drag. Similarly, a larger volume of material with a fixed density results in a correspondingly larger mass/weight. In the case of weight, the true takeoff and landing performance of an airplane can be measured at maximum takeoff weight (MTOW) and maximum design landing weight (MDLW).

XSTOL may be defined by the following criteria:
1. Have the ability to take off at MTOW and land at MDLW with a ground roll distance shorter than 10 times the aircraft's length;
2. Have the ability to take off at MTOW and land at MDLW with a slope of 9 degrees or higher (instead of the standard 3 degrees). This would give it the ability to clear a 50-ft (15-m) obstacle in ˜315 ft (˜100 m).

Alternatively, a simplified version combining the above two criteria into a single criterion may be expressed as: takeoff to or land from 50 ft (15 m)<10×fuselage length+315 ft (100 m).

TABLE 15
Notable examples of XSTOL airplanes.

| | | | | Landing | | | | | | 10 × fuselage | |
|---|---|---|---|---|---|---|---|---|---|---|---|
| | | Take-off to | | from | | | | | | length + | |
| | | 50 ft/15 | | 50 ft/15 | | | | Fuselage | | 315 ft | |
| Manufacturer | | m | | m | | Mass | | length | | (100 m) | |
| and model | Year | (ft) | (m) | (ft) | (m) | (lbm) | (kg) | (ft) | (m) | (ft) | (m) |
| Zenith STOL | 2011 | 400 | 122 | 300 | 91 | 2,200 | 998 | 24.5 | 7.5 | 560.0 | 170.7 |
| CH 801 | | | | | | | | | | | |
| Fieseler Fi 156 | 1936 | 350 | 107 | 310 | 94 | 2,780 | 1,261 | 32.5 | 9.9 | 640.0 | 195.1 |
| Storch | | | | | | | | | | | |
| De Havilland | 1959 | 1,040 | 317 | 590 | 180 | 28,500 | 12,927 | 72.58 | 22.1 | 1040.8 | 317.2 |
| Canada DHC-4 | | | | | | | | | | | |
| Caribou | | | | | | | | | | | |
| Breguet 941 | 1958 | 860 | 262 | 800 | 244 | 40,000 | 18,144 | 77.9 | 23.7 | 1094.2 | 333.5 |

If we apply the above criterion to the aircraft in Table 14, very few STOL airplanes will make the cut and qualify as XSTOL. Most airplanes that do make the cut fall into the very light category of “bush planes”, homebuilt kit-planes, and Light Sport Aircraft (LSA). We note that a few larger/heavier airplanes do make the cut. Table 15 lists four notable examples in the order of mass/size, two on each end of the mass/size spectrum.

Light XSTOL Examples: Fieseler Fi 156 Storch and Zenith STOL CH 801

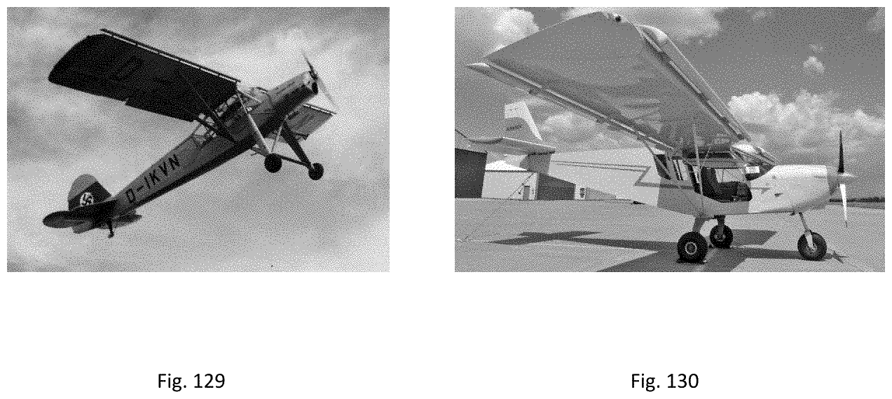

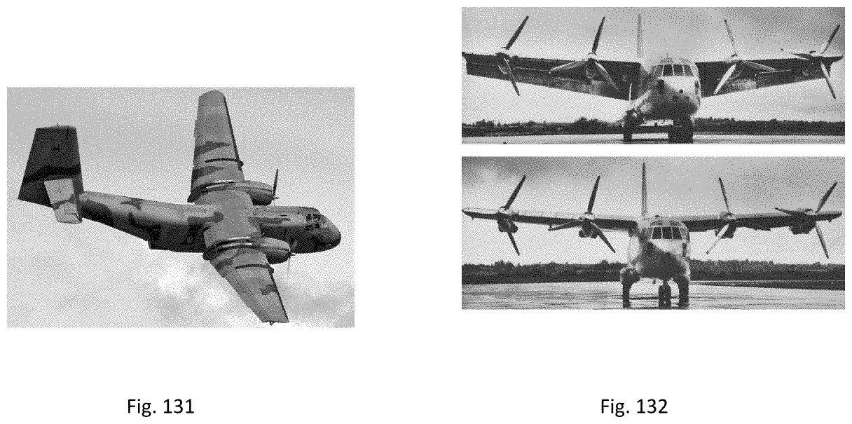

The Storch is probably one of the oldest XSTOL airplanes in history. Beyond a large TE flap, it has a fixed full-length LE slat as seen in FIG. 129. Most light STOL and practically all light XSTOL planes share this feature, including the CH 801 (FIG. 130). One of the aspects that characterizes the CH801 is that in addition to the full-length LE fixed slat, it also has a very rare full-length TE flaperon (a “flaperon” is a term referring to a moveable TE surface that combines the functions of flaps and ailerons). In other words, the entire wing can curve the airflow in its high-lift configuration. Notice that both airplanes share high wings, single nose-mounted propellers and traditional aft-mounted empennage.

Heavy XSTOL Examples: De Havilland Canada DHC-4 Caribou and Breguet 941

The Caribou (131) and the Breguet 941 (132) both have TE flaps running along their entire wingspans.

Unlike the CH 801, they don't use one-piece flaperons. The inboard flaps are separate from the outboard flaperons and extend down to different angles.

When comparing the performances of these two larger airplanes, there is a surprising performance number hidden in the details: the Breguet 941 weighs 1.5 times more than the Caribou and yet has similar takeoff and landing distances. It even outperforms the Caribou in takeoff at 800 ft (244 m) vs. 860 ft (262 m) despite being a 40,000-lb airplane. The Breguet 941 did not see large-scale production, but it was the more revolutionary of the two and some of the lessons learned from that airplane can be adapted to powered lift for distributed electric propulsion.

Unique Features of the Breguet 941

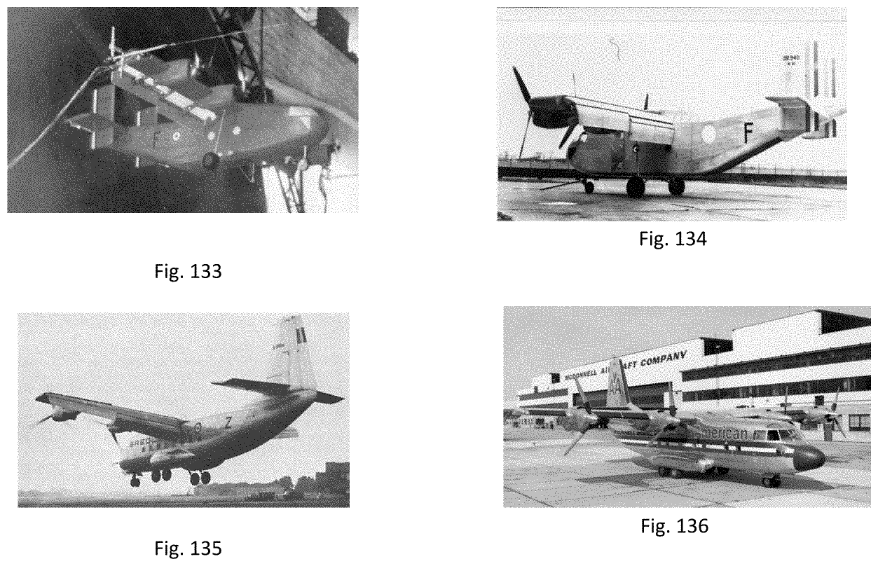

There were 4 key airplanes involved in the development of the Breguet 941:
An unmanned RC 1/6 scale free flying laboratory tethered model (FIG. 133);
The Breguet 940 Integral: a sub-scale manned technology demonstrator (FIG. 134);
The Breguet 941: initial full-scale version (FIG. 135);
The Breguet 941S: final improved and more powerful full-scale version (FIG. 136).

In a sign of being ahead of its time, the unmanned RC model was flown by 4 electric motors in 1954 in Breguet's private wind tunnel. It was coupled to an analog flight simulator that the future pilot could use for training.

Table 16 summarizes some of the characteristics of the three manned versions. Between 1958 and 1967, the 940, 941, and 941S demonstrated that XSTOL is not just a gimmick reserved for very light airplanes.

TABLE 16
Characteristics of the XSTOL Breguet 940, 940, and 941S.

| | MTOW | | | Power | | |
|---|---|---|---|---|---|---|
| | (ton) | (lbm) | Powerplant | (hp) | (kW) | First flight |
| Breguet 940 | 7 | 15,432 | 4 × Turboméca Turmo II | 4 × 400 | 4 × 298 | 1958 |
| Breguet 941 | 20 | 44,092 | 4 × Turboméca Turmo III D | 4 × 1,250 | 4 × 932 | 1961 |
| Breguet 941S | 26.5 | 58,422 | 4 × Turboméca Turmo III D3 | 4 × 1,450 | 4 × 1081 | 1967 |

The numbers in Table 15 correspond to performance evaluations conducted in the US using the initial Br-941 at 4,000-5,000 lbs below its MTOW.

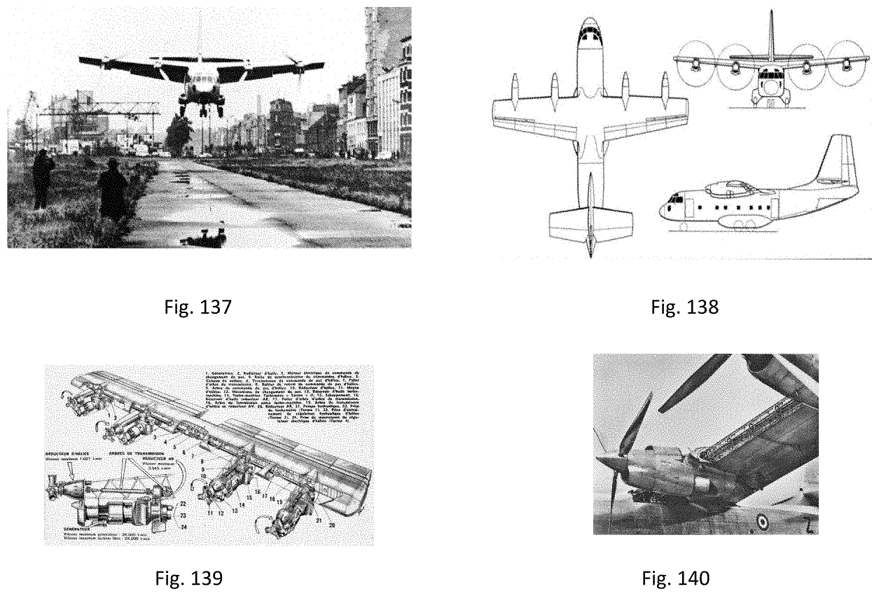

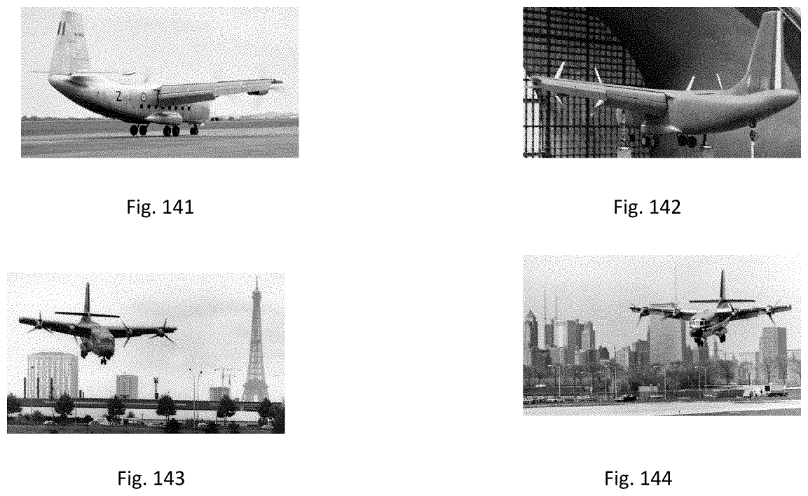

On the technological side, the Breguet 941 demonstrated a number of unique features that embodiments of the present invention innovate upon:
1. The airplane's front and top views show that its entire wing was immersed in the propellers' slipstream (FIG. 137 and FIG. 138). Other STOL airplanes only blew air onto the inboard portions of the wings. Louis Breguet coined the term “aile soulflée” or blown wing for this concept.
2. The Breguet 941 had an innovative system of mechanical shaft power distribution (FIGS. 139 and 140):
   “[ . . . ] engines drove an independent shaft which was connected to a master shaft, and in return, this master shaft was connected to the propellers. With this concept, the power of the engines was distributed uniformly to the four propellers, even if the engines did not have the same rotational speed. Therefore, if an engine failed, its turbine was isolated but the corresponding propeller kept on rotating at the same speed as the others. This concept also provided equal distribution of the power to the propellers, independently of engine speed”
   This system was crucial in ensuring the airplane does not suddenly roll to the side in case one engine fails during taking off or landing at slow speeds and high angles of attack
3. TE flap (FIGS. 141 & 142)
   It ran across the full wingspan with the outboard sections being flaperons;
   The flaps could be deflected to extreme angles: the inboard flaps to 97 degrees and the outboard flaperons to 65 degrees;
   This method of powered lift is known as deflected slipstream.

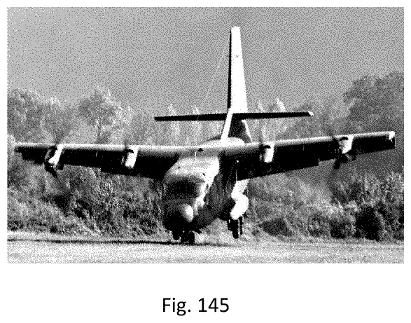

On the operational side, it had somewhat helicopter-like qualities and demonstrated feats that lend themselves surprisingly well to the quickly evolving field of Urban Air Mobility:
1. It could take off from and land in dense urban areas (FIG. 137, FIG. 143, and FIG. 144);
2. It could take off from and land on unprepared runways (FIG. 137 & FIG. 145);
3. It could take off and land at extreme slopes with a distinctive nose-down landing attitude (FIGS. 143-145).

One of the innovations that enabled the Breguet 941 to achieve its unparalleled XSTOL feats is probably also one of the reasons it failed to achieve its full potential. The mechanical shaft power distribution system required extensive repair and maintenance (this constitutes an operational shortcoming). It also occupied prime real estate in the LE of the wing (this constitutes a technical shortcoming). Embodiments of the present invention address these issues.

Bridging the Gap Between XSTOL and VTOL

XSTOL Competitions

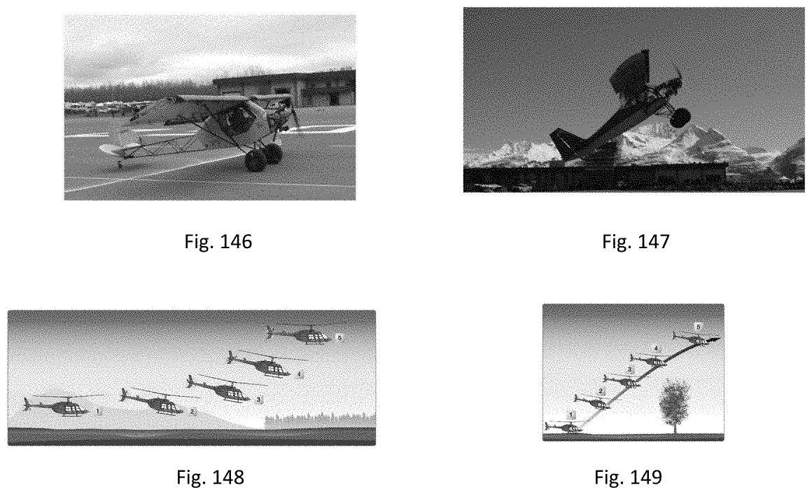

There is a community of enthusiasts that compete in XSTOL with bush planes, LSA, and various light planes modified with LE slats, TE flaps and other simple and low-tech devices. The Valdez, Alaska airport hosts such events (FIGS. 146 and 147) and witnessed the world record shortest landing distance of 10′5″ (3.2 meters) in May 2017. The winner was a modified 1939 Piper J-3 Cub (146). The same airplane achieved a short takeoff in 14′7″ (4.4 meters). When an airplane achieves takeoff and landing ground rolls of the same order of magnitude as the airplane's fuselage length, it becomes increasingly difficult to distinguish it from a helicopter.

How Vertical is Vertical Enough?

The feats achieved by small airplanes at XSTOL competitions is to some degree attributed to their low weight or perhaps, their unusually high thrust to weight ratios. But then again, the same can be said about helicopters. The previous sections covered XSTOL airplanes in some detail in order to convey a number of key messages:
Impressive XSTOL performance has been achieved with extremely old designs and old technological solutions from the 1930s to 1950s;
These performances cover a rather wide and useful spectrum of mass/weight/size with an MTOW range of ˜2,000-60,000 lbm (˜1-27 tons).
Heavier XSTOL with modern propulsion, control systems, aerodynamics, etc. have not been properly explored yet;
Lighter XSTOLs are achieving quasi-VTOL behavior and increasingly rivaling helicopters in takeoff and landing performance despite their antiquated designs.

But do helicopters actually takeoff or land vertically? Helicopters certainly enter hover vertically, but they usually do not clear a 50-ft obstacle vertically unless they really have to. As seen in the takeoff maneuvers of FIGS. 148 and 149, once they enter hover, they try to stay in ground effect before choosing a climb angle depending on obstacle proximity.

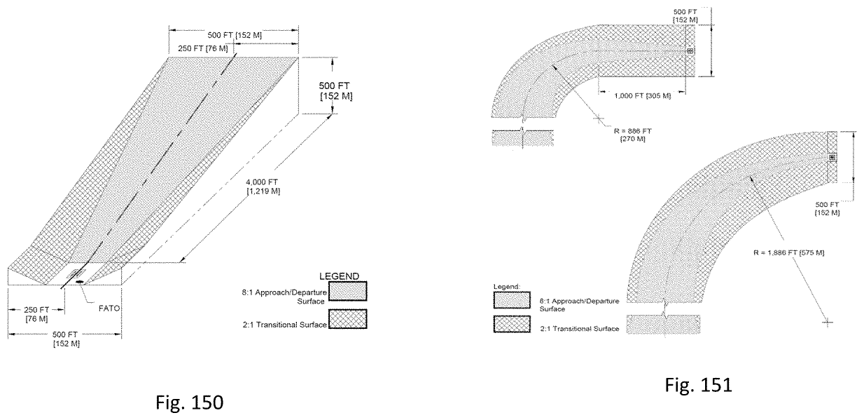

Typical approach and departure surfaces around heliports use 8:1 slopes, corresponding to 7.1 degrees as shown in FIGS. 150 and 151.

If clearing a 50-ft obstacle in a takeoff or landing operation is included, it could be argued that helicopters usually do not takeoff or land vertically. It is only their ability to eliminate the ground roll portion of the operation that gives helicopters the edge in takeoff and landing.

Outside of takeoff and landing operations, it is the helicopter's hover in-place ability that also gives it an edge that has eluded fixed-wing aircraft.

Hover in-Place Vs. Forward Creep

Whether one considers light XSTOL airplanes such as bush planes or heavier ones such as the Breguet 941, they cannot hover in-place. They must creep forward for at least two reasons:
1. Control: the forward movement, albeit slow, is required to provide stability and control using the traditional aerodynamic control surfaces (ailerons, tailplane, and rudder).
2. Thrust vector: the forward movement cannot be eliminated altogether with traditional approaches to single wing high-lift devices, because the forward direction and amplitude of the engine thrust vector cannot be fully cancelled by the rearward lift and drag vectors unless there is significant tilting. Therefore, most convertiplane designs use some form of tilting. Most designs rely on either tilting the wings, or the propulsors 90 degrees, or in the rare case of the Opener Blackfly, tilting the entire aircraft in a such a way that the propulsors turn momentarily 90 degrees upward.

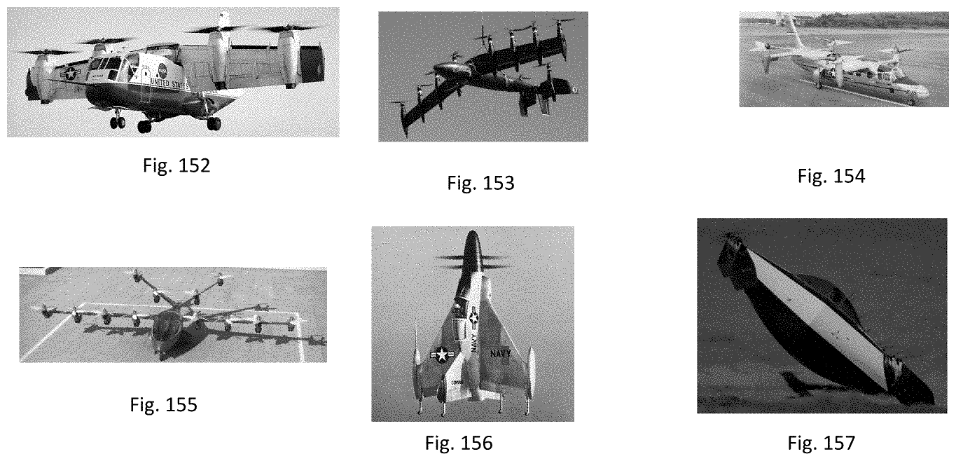

Present embodiments address the above without tiltwing (FIGS. 152 and 153), without tiltrotor (FIGS. 154 and 155), and without tilting the entire aircraft to extreme angles (FIGS. 156, and 157).

Aircraft Configurations with VTOL and/or XSTOL Capabilities

Slipstream Deflection on JSW

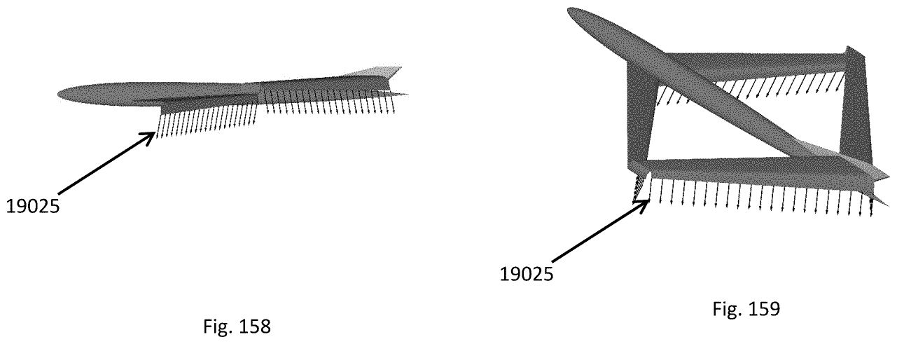

One basic idea is to deflect the slipstream in ground effect mode on both the LW and the TW. If one chose to deflect the slipstream of the LW down (and slightly forward if needed) while the slipstream of the TW is deflected down (and slightly backward if needed), the two flows should in principle have minimum interference and provide ample control points along the longitudinal and the lateral directions due to the large number of thrustors. Arrows 19025 shown in FIGS. 158 and 159 indicate slipstream deflection from LW and TW.

Basic Configuration

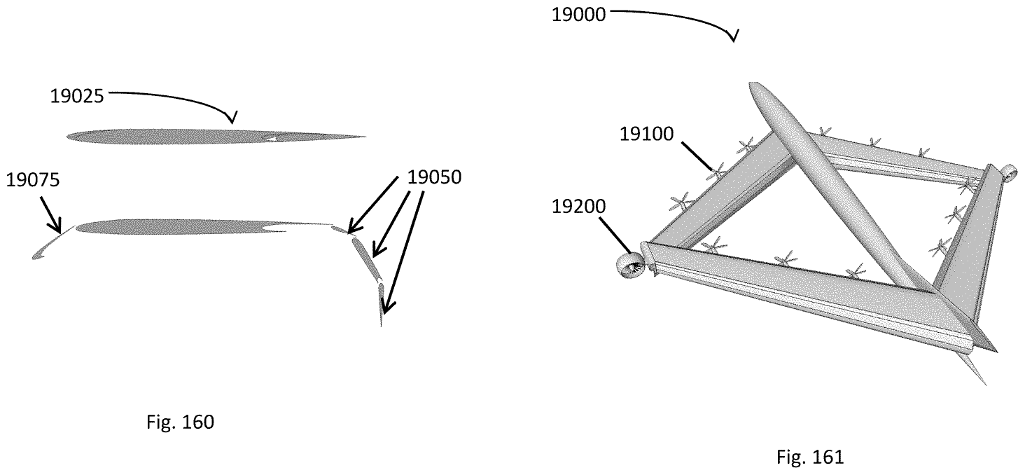

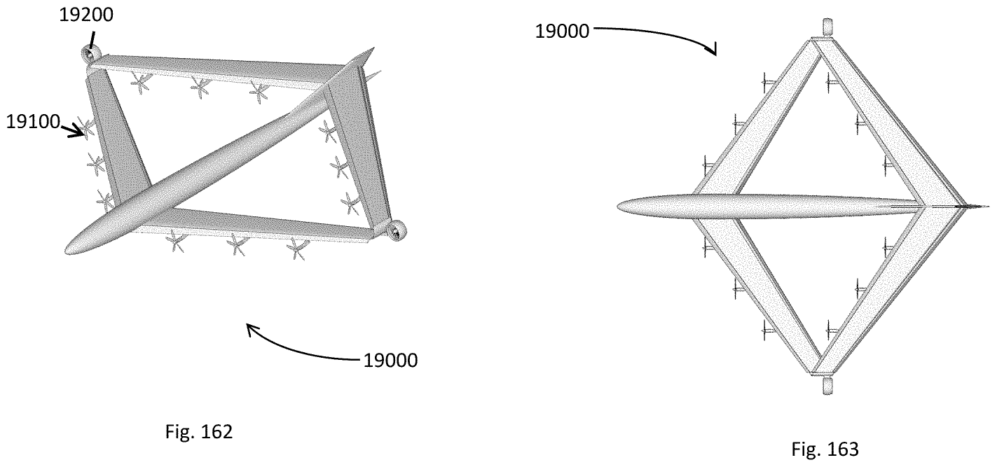

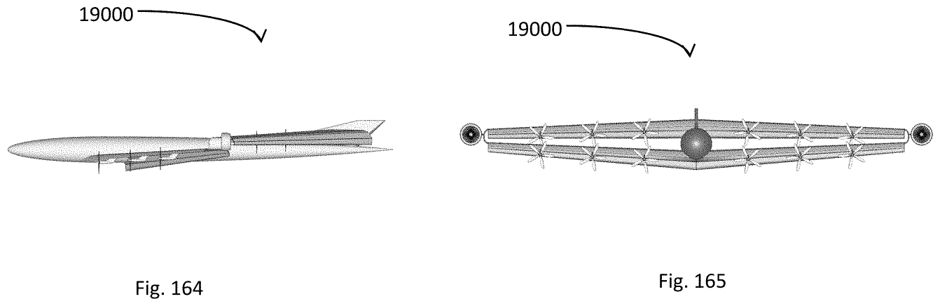

Using DEP in tandem wing configurations such as those described above, including configuration 400 in FIG. 2 may bridge the gap between current state-of-the-art fixed-wing STOL or XSTOL airplanes and their VTOL helicopter counterparts without resorting to tiltwing, tiltrotor, tilt-fuselage, or dedicated lift rotors. The configurations above, including configuration 400 lends itself very well to pushing the XSTOL capabilities of old designs from the 1930s to 1950s to the next level. Consider the following configuration in accordance with embodiments of the present invention as a solution to XSTOL and VTOL capabilities (shown in FIGS. 160 thru 165):

| ET Type & | | Chord | Thickness | |
|---|---|---|---|---|
| number | Span position | position | position | Fuselage |
| 12 EPs + | Even | XLE for EPs | XLS for EPs | Single |
| 2 EFs | distribution | LMC for EFs | AUS for EFs | |

In one embodiment, FIG. 160 shows an airfoil 19025 with a 3-element TE Fowler flap 19050 and a one-element LE slat 19075. In this figure, the flaps 19050 are extended 90 degrees, but higher angles are possible. The flaps 19050 and slats 19075 run along the entire spans of both the LW and the TW. This provides the opportunity to place the airplane into extreme ground effect. This also provides separate and precise differential high-lift control front and aft along the longitudinal axis. Powered lift is provided on both wings fully immersed in deflected slipstream. The slipstreams of each wing are deflected down (and slightly forward if needed) when the aircraft flies at high pitch angle. This may advantageously provide excellent XSTOL capabilities for the configurations above.

For VTOL capability consider the following:

Due to the differential thrust control mechanism discussed in previous section, forward movement is not necessary for stability and control along any of the 3 axes. Stability and control can be instead provided and/or augmented actively, through real-time precise propulsor thrust adjustments.

If hover in-place without forward creep is required, it can be achieved in 2 different ways
i. By the 2 wingtip-mounted thrustors 19200 providing reverse thrust. Their special mounting location does not affect the flow over the wings. The 12 EPs 19100 (shown in FIG. 161 with aircraft configuration 19000) create the necessary lift while the 2 tip-mounted EFs 19200 prevent the forward creep movement.
ii. Without the need for wingtip thrustors in reverse mode, by controlling simultaneously a small pitch angle of the aircraft 19000 and the extension of the high-lift devices, namely the flaps 19050 and slats 19075 of the LW and TW, including flap and slat extensions that deflect the slipstream down and forward simultaneously if need be.

If flight at very high pitch angles are needed, the tip mounted EFs 19200 can include some level of thrust vectoring as discussed earlier, preferably by moving surfaces at their ducts' inlets and outlets. Although not necessary, gimballing or minor tilting like an azimuth thrustor can be included.

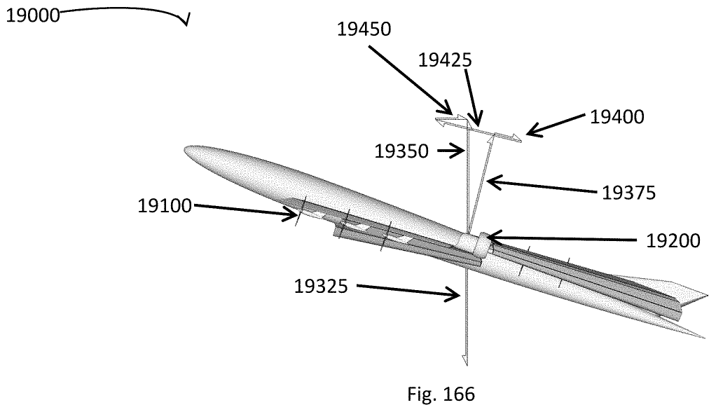

FIG. 166 illustrates an embodiment of the present invention 19000 hovering in-place at a given pitch angle. As described above, this aircraft configuration 19000 includes 12 EPs 19100 that create the necessary lift while the 2 tip-mounted EFs 19200 can prevent the forward creep movement if necessary. Alternatively, the extension of the high-lift devices along with gentle pitching can also provide the same anti-forward creep function. The weight vector 19325 is negated by an equal and opposite vector 19350 that results from the vector addition of the combined lift 19375 of both the TW and LW, the combined drag 19400, the forward thrust 19425 of the thrustors bathing the wing in their slipstream which happen to be EPs 19100, and the anti-forward creep force 19450 (for example reverse thrust of the wingtip thrustors which happen to be EFs 19200).

While hovering using the above method, the aircraft is “hanging” from its fixed wings, rather than from a set of rotors, propellers, or fans tilted upward. The fixed wings (rather than a set of rotary wings) produce the hovering lift force by slipstream deflection, upper surface suction (Coandă effect), and lower surface overpressure helped by ground effect. The same wings that carry the aircraft during cruise, carry it during hover, in contrast to all other VTOL inventions.

Note that the above configuration uses a mixture of EPs 19200 and EFs 19100 for illustration. Other configurations with only EPs 19200, or only EFs 19100 could work similarly.

Internal EF and High-Lift

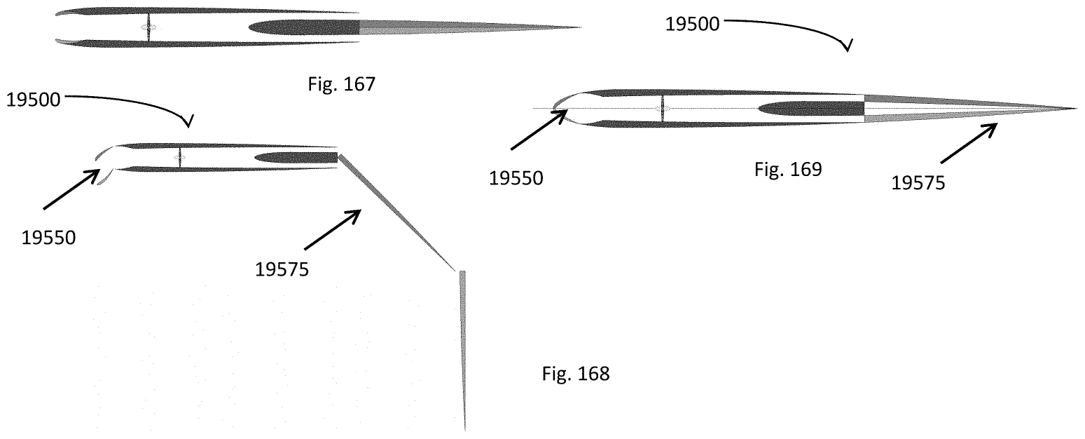

The internal EF system discussed previously (and shown in FIGS. 44 through 50) can be used in conjunction with a high-lift system. Turning to FIGS. 167, 168, and 169, the inlet 19550 of the ducting system can tilt down and slide forward like a LE flap while the exhaust 19575 of the ducting system can move and extend like a TE Fowler flap. A simple representation of configuration 19500 is shown in FIG. 168.

This configuration 19500 should allow the flow to curve along the entire wing while passing through the wing.

Low Drag Cruise

The system described above can selectively turn off one of several EFs and provide a low-profile position for low-drag cruise by closing some or all of the inlets 19550 and outlets 19575 as shown in FIG. 169.

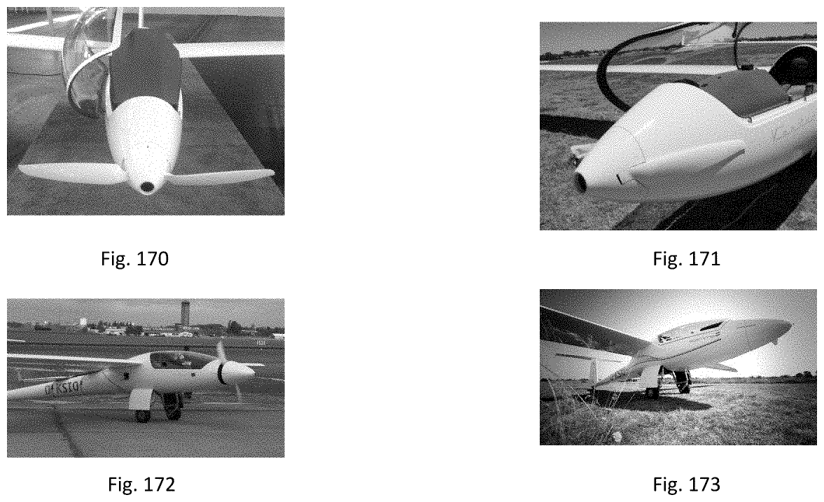

Similarly, EPs can also be used in a low-profile position for low-drag cruise by folding back (FIGS. 170, which shows a front electric sustainer on a Ventus glider with extended propeller, and 171, which shows a front electric sustainer on a Ventus glider with the propeller folded back) or retracting (FIGS. 172, which shows a Stemme 10 glider with propeller extended, and 173, which shows the Stemme 10 glider with propeller retracted behind the nose cone) the propeller blades if need be as in the case of various motor gliders.

The following are some advantages of preferred embodiments of the present invention.

TABLE 17
Selected advantages of an XSTOL/VTOL aircraft in accordance with preferred
embodiments of the present invention over other types of XSTOL and VTOL,

| | | | XSTOL/VTOL | | | |
|---|---|---|---|---|---|---|
| | | | aircraft of | Typical | Medium | Typical |
| | | | preferred | light XSTOL | XSTOL (e.g. | helicopter |
| | | | embodiment | bush plane | Breguet 941) | VTOL |
| Aerodynamics | Number of wing sets | | 2 | 1 | 1 | N/A |
| | Negative tailplane lift | | No | Yes | Yes | N/A |
| | Rudder required | | No | Large | Large | Medium |
| | Stalled portions of wings | | No | Yes | Yes | Yes |
| | Wing aspect ratio | | High | Low | Low | N/A |
| | L/D | | High | Medium | Medium | Low |
| High-lift takeoff | Wing in slipstream | | Full | Partial | Full | N/A |
| and landing | Full-span LE slat | | Yes | Yes | No | N/A |
| | Full-span TE flaps | | Yes | Rare | Yes | N/A |
| | TE flap deflection to | | Yes | No | Yes | N/A |
| | 90 degrees and beyond | | | | | |
| Structure | Construction materials | | Modern lightweight | Old | Old | Lightweight |
| | | | including topology- | traditional | traditional | composites |
| | | | optimized 3D-printed | | | and metals |
| | | | metals, composites, and | | | |
| | | | polymers | | | |
| | Structural strength of | | Strong and stiff | Aeroelastic | Aeroelastic | Aeroelastic |
| | wing | | torsion box through | traditional | traditional | |
| | | | joined wings | cantilever | cantilever | |
| Propulsion | Number of thrustors | | Typically more | 1 | 4 | 1 |
| | | | than 6 (e.g. 14 as | | | |
| | | | illustrated above) | | | |
| | Sudden thrust control | | Possible | No | No | No |
| | through RPM change | | | | | |
| | Mechanical maintenance | | Low | Medium | High | High |
| Stability | Control | | Differential | Conventional | Conventional | Complex |
| and Control | | | thrust | aerodynamic | aerodynamic | mechanical |
| | | | | surfaces | surfaces | |
| | Stability | | Active electronic | Passive | Passive | Complex |
| | | | fly-by-wire | aerodynamic | aerodynamic | mechanical |
| | Redundancy in case of | | Simple electrical | None | Complex | Low. |
| | single engine failure | | distributed balancing | | mechanical | Some |
| | | | via electronic quick- | | shared shaft | autorotation |
| | | | response RPM change and/ | | | |
| | | | or blade pitch control | | | |
| Operation | Hover in-place | | Yes (e.g. | Impossible | Impossible | Yes |
| | | | through wingtip | | | |
| | | | EF forward | | | |
| | | | creep control) | | | |
| | Payload | | Medium | Small | Medium | Small |
| | Range | | Long | Medium | Medium | Small |
| | Max cruise | (mph) | ~560-600 | ~100-125 | 250 | ~125-155 |
| | speed | (kph) | ~900-965 | ~160-200 | 400 | ~200-250 |

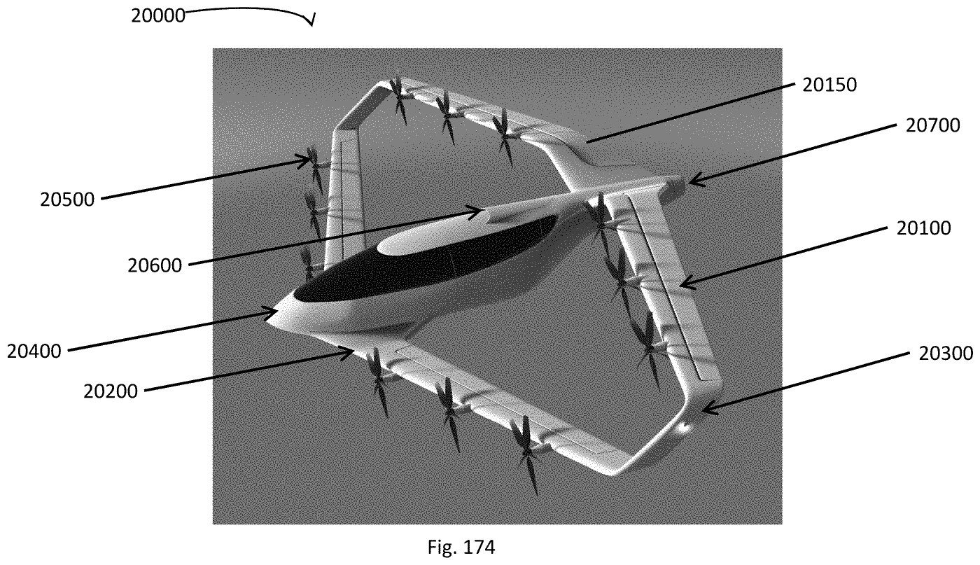

Turning to FIG. 174, an aircraft 20000 in accordance with a preferred embodiment is shown. Aircraft 2000 includes a high-mounted forward-swept trailing wing 20100 with a gullwing shape and a low-mounted backward-swept leading wing 20200 with an inverted gullwing shape. (Note that wings 20100 and 20200 are shown with retracted flaps 20150). The aircraft includes fuselage 20400 designed to carry four passengers and one pilot. The trailing wing 20100 and leading wing 20200 share winglet 20300. This winglet 20300 has substantial height. During level flight, the leading wing 20200 creates downwash. Having a taller winglet 20300 helps ensure that the downwash from the leading wing 20200 does not affect the flow over the trailing wing 20100. Aircraft 20000 further includes 12 EPs 20500, distributed along the wingspans of wings 20100 and 20200. The electric current for the EPs 20500 is provided by a combustion engine, such as a turbine, driving an electric generator, the air inlet of which 20600 is located on top of fuselage 20400. The exhaust 20700 of said combustion engine is located at the tail of fuselage 20700.

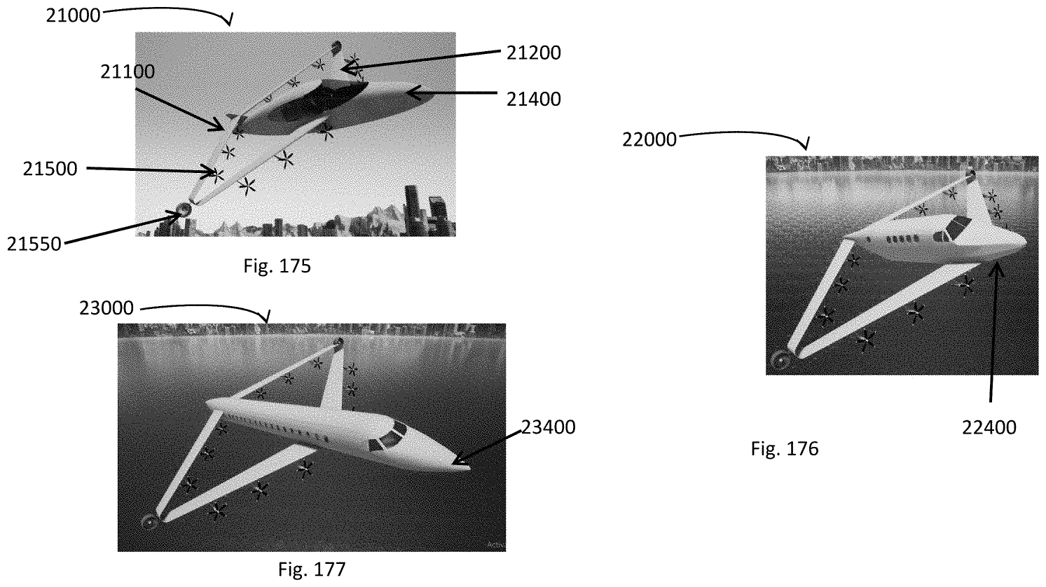

Turning to FIG. 175, aircraft 21000 is shown. Like aircraft 20000, aircraft 21000 includes a high-mounted forward-swept trailing wing 21100 and a low-mounted backward-swept leading wing 21200 and a fuselage 21400 that can carry four occupants. Aircraft 21000 also includes six EPs 21500 distributed along the wingspans of wings 21100 and 21200. Aircraft 21000 further includes two EFs 21550 located at the winglets.

Turning to FIG. 176, aircraft 22000 is shown, which has a similar wing configuration as 21000 but includes fuselage 22400, which can hold 9 passengers and two pilots.

Turning to FIG. 177, aircraft 23000 is shown, which has a similar wing configuration as 21000 but includes fuselage 23400, which can hold more than 19 passengers and two pilots.

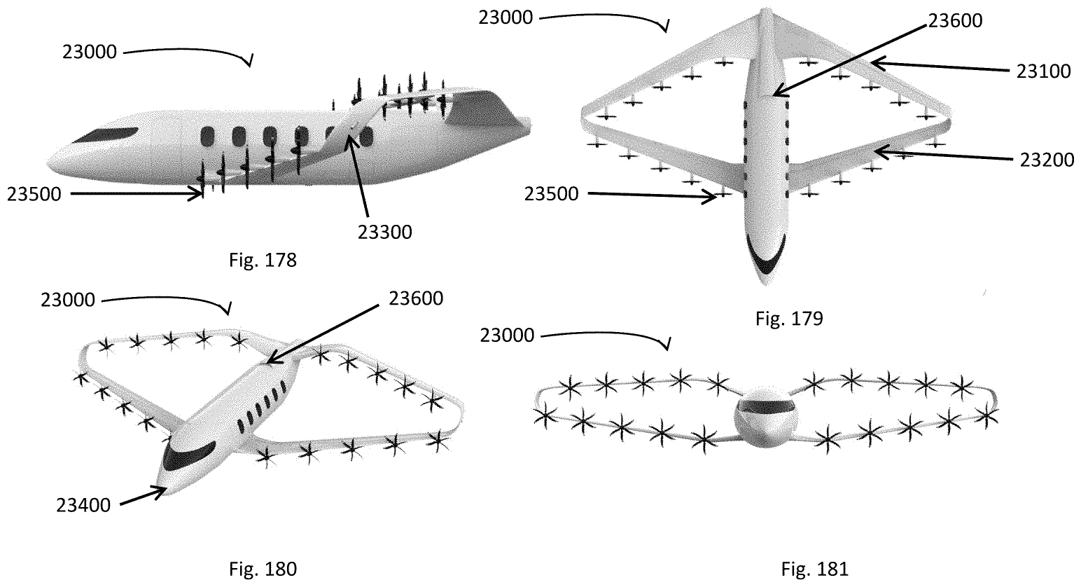

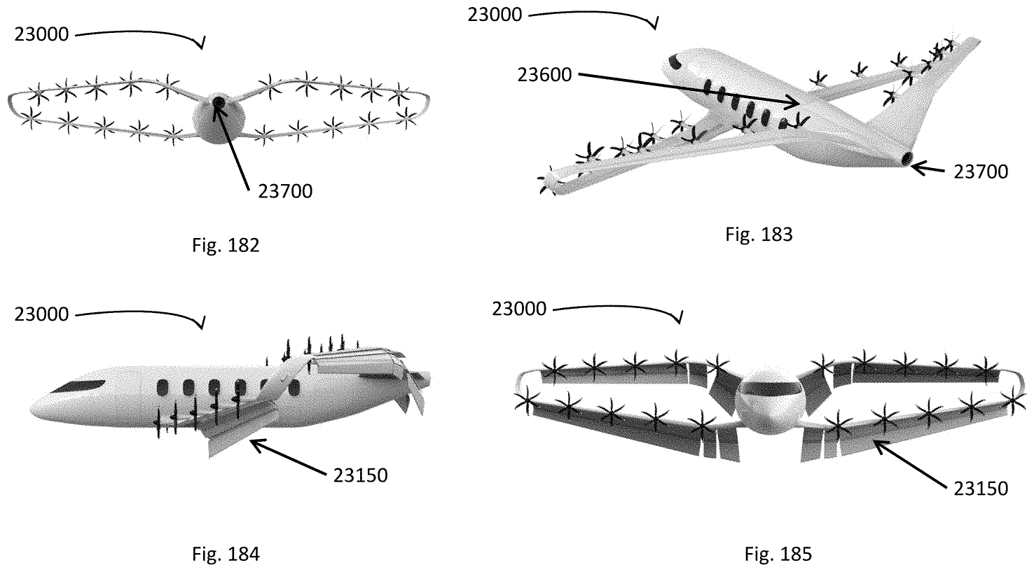

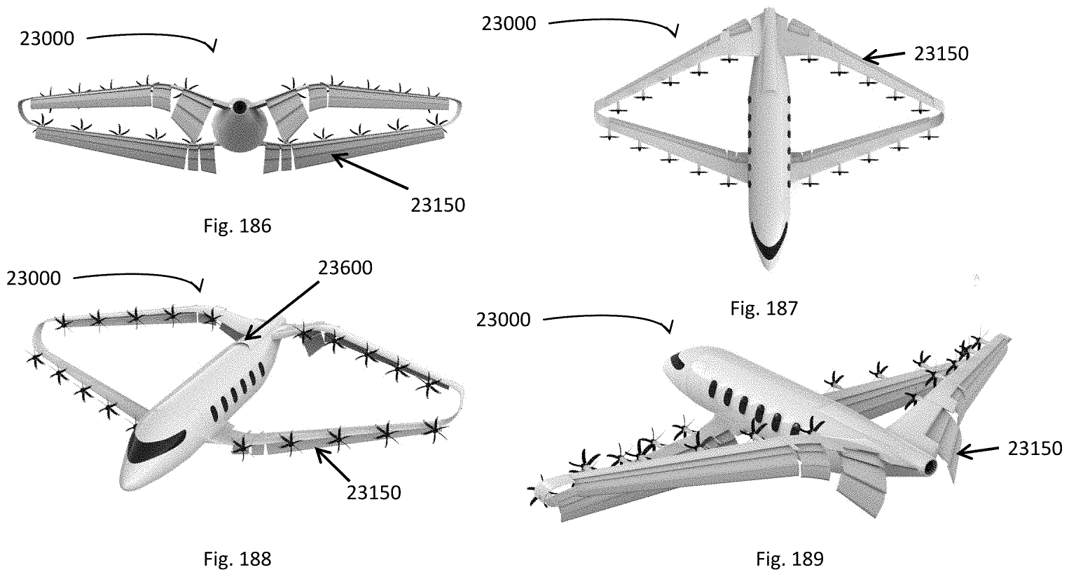

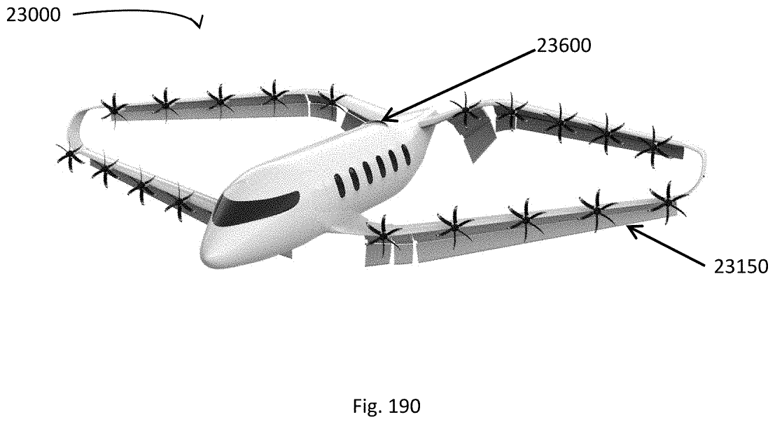

Turning to FIGS. 178, 179, 180, 181, 182, 183, 184, 185, 186, 187, 188, 189, and 190, aircraft 23000 is shown. Aircraft 23000 includes a high-mounted forward-swept trailing wing 23100 with a gullwing shape, a low-mounted backward-swept leading wing 23200 with an inverted gullwing shape and tall winglets 23300, a fuselage 23400, and twenty EPs 23500 distributed along the wings 23100 and 23200, ten EPs on the LW 23200 and ten EPs on the TW 23100. Aircraft 23000 further includes a combustion engine such as a turbine to drive an electric generator powering the EPs, with an inlet 23600 and exhaust 23700. FIGS. 184, 185, 186, 187, 188, 189, and 190 show aircraft 23000 with extended 3-element, 3-section Fowler flaps 23150 on each wing.

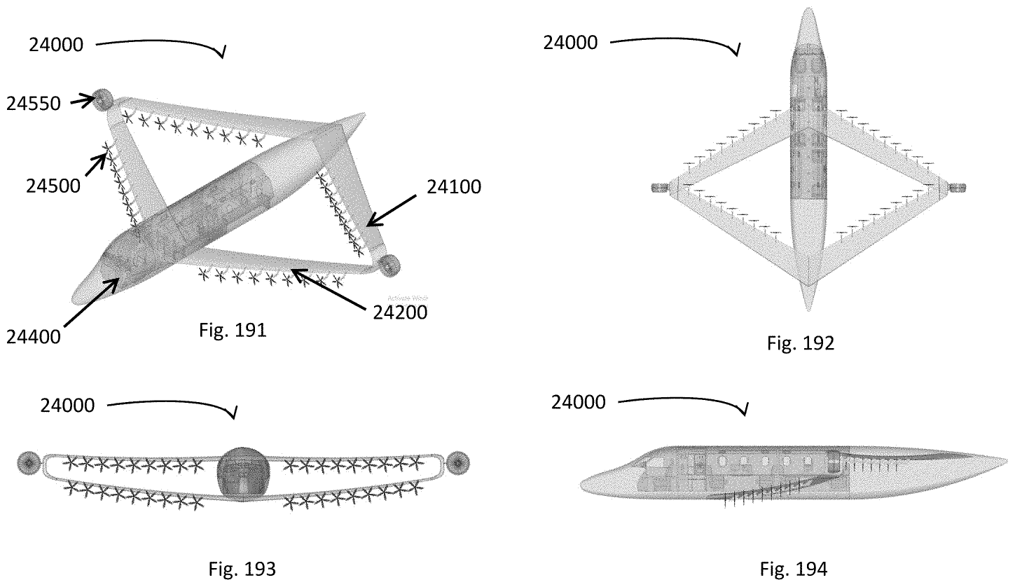

FIGS. 191, 192, 193, and 194 show aircraft 24000. Aircraft 24000 includes a high-mounted TW in FSW configuration 24100, a low-mounted LW in BSW configuration 24200, a fuselage 24400, 36 EPs 24500 distributed along the wings 24100 and 24200, and two EFs 24550 at the winglets.

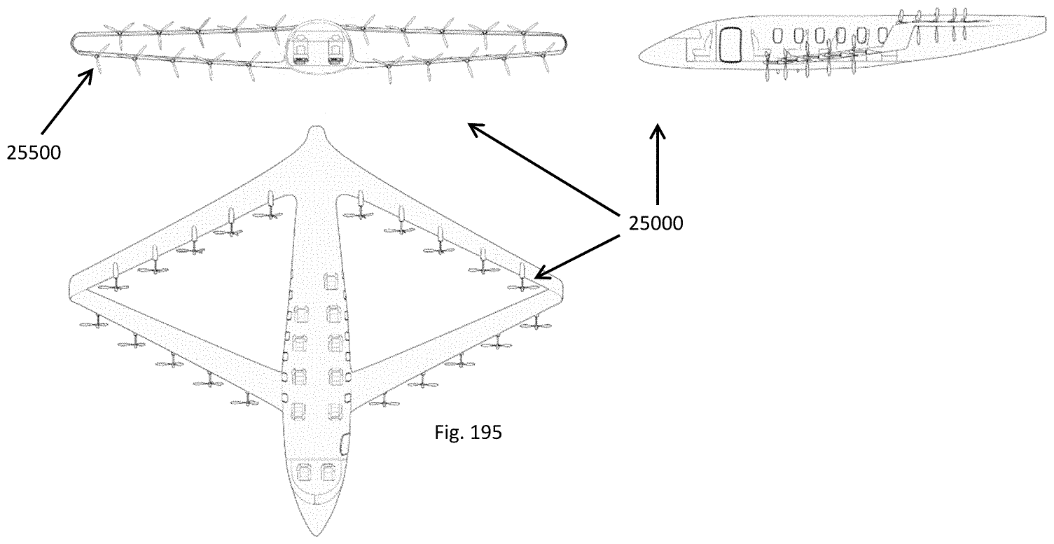

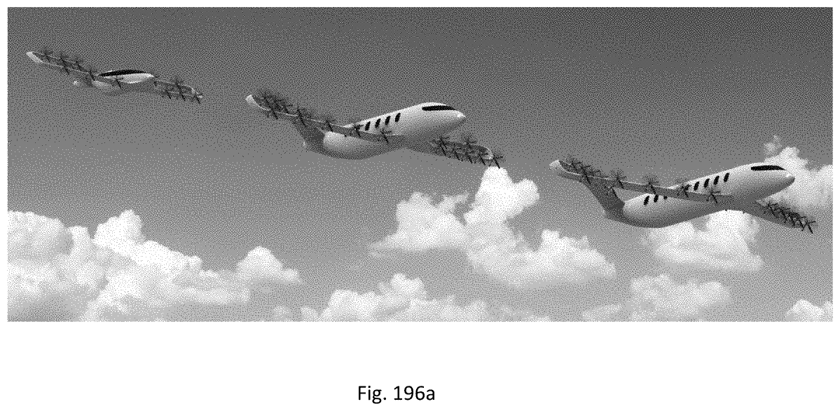

FIG. 195 shows a 9-passenger aircraft 25000, which includes 20 EPs 25500 distributed along the wings.

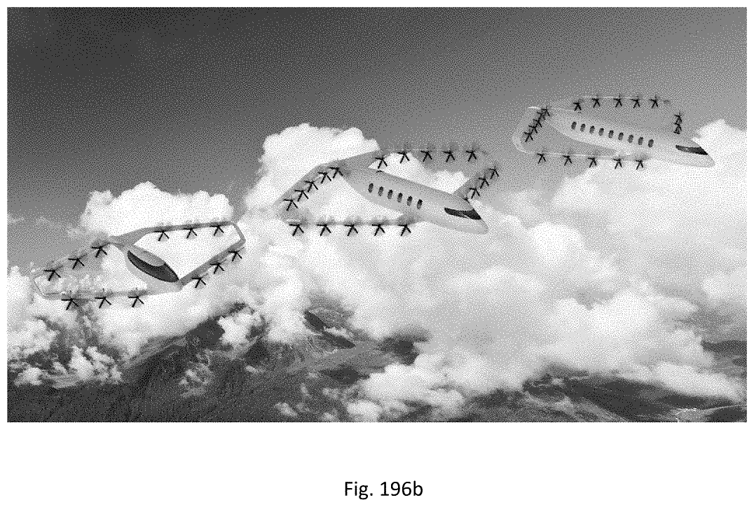

FIGS. 196a and 196b provide additional illustrations of aircraft in accordance with preferred embodiments of the present invention. The aircraft on the left of both figures can correspond to an Urban Air Mobility design with 4 passengers and 1 pilot. The aircraft in the middle of both figures can correspond to a mid-range design with 9 passengers and 2 pilots. The aircraft on the right of both figures can correspond to a mid-range design with 19 passengers and 2 pilots. All these designs would correspond to aircraft certifiable under the FAA's 14 CFR Part 23 regulations.

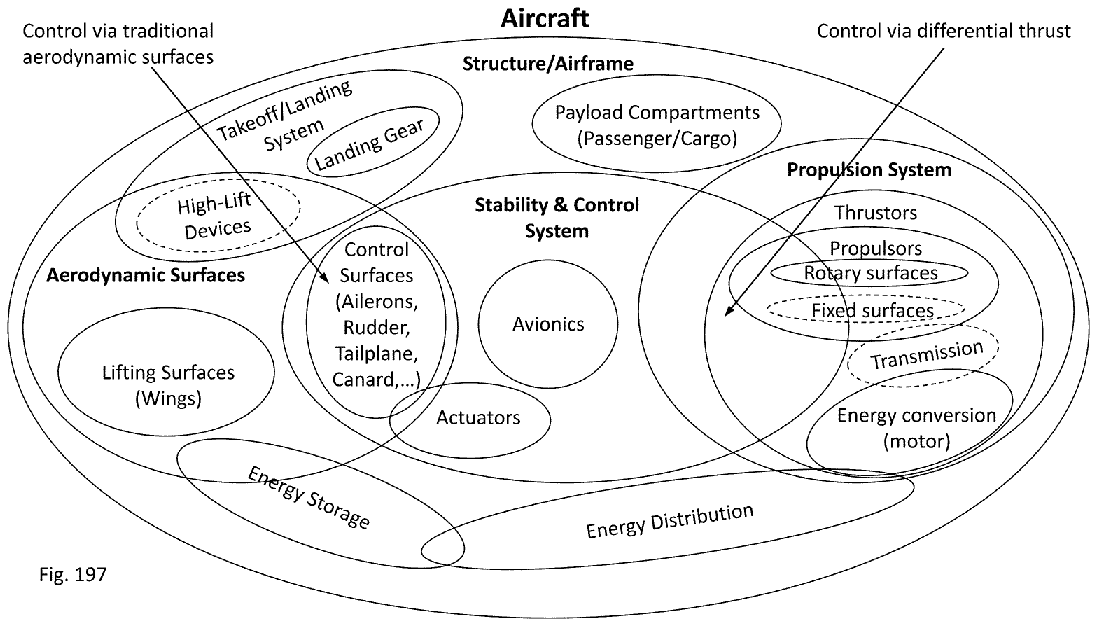

Referring to FIG. 197, a diagram of an aircraft in accordance with embodiments of the present invention may include multiple subsystems within the aircraft that interact with one another to enable the aircraft to function as desired. In selected embodiments, the primary subsystems of an aircraft may include a structure/airframe, a propulsion system, aerodynamic surfaces, and a stability and control system. Working together, these four subsystems may enable the resulting aircraft to transport a payload or perform some other desired function.

The structure/airframe may provide the mechanical structure for the aircraft. In certain embodiments, the structure may include a fuselage, and one or more aerodynamic surfaces. A fuselage may form the main body of the aircraft.

Aerodynamic surfaces may include one or more lifting surfaces (or wings), one or more flight control surfaces, one or more high-lift devices, and the like or a sub-combination thereof. A lifting surface may be a surface that generates lift when an airframe is propelled through the air. A flight control surface may be a surface that is selectively manipulated (e.g., pivoted) to generate aerodynamic forces that adjust or control the flight attitude of an aircraft. In certain embodiments, as described above, the flight attitude of an aircraft may be controlled primarily or exclusively using differentials in thrust or the like, rather than control using traditional aerodynamic surfaces. Accordingly, in selected embodiments, an airframe may have fewer flight control surfaces than is conventional (e.g., less than a full complement of ailerons, elevator, rudder, trim tabs, and the like), flight control surfaces of relatively small size (e.g., when compared to conventional airplanes of similar weight and size), or no flight control surfaces at all.

A high lift device may be a structure that is selectively moved or deployed in order to produce greater lift (and sometimes greater drag) when it is needed or desired. High-lift devices may include mechanical devices such as flaps, slats, slots, and the like or combinations thereof. In certain embodiments, the amount of lift may be controlled primarily or exclusively using differentials in thrust, redirections of thrust-producing flows of air, or the like. Accordingly, in selected embodiments, an airframe may have fewer high-lift devices than is conventional (e.g., less than a full complement of flaps, slats, slots, and the like), high-lift devices of relatively small size (e.g., when compared to conventional airplanes of similar weight and size), or no high-lift devices at all.

A takeoff/landing system may provide a desired interface between an aircraft and the support surface upon which the aircraft may rest. In selected embodiments, a takeoff/landing system may include rolling landing gear, retractable landing gear, landing skids, floats, skis, or the like or a sub-combination thereof. Accordingly, a takeoff/landing may be tailored to meet the particular demands of the desired or expected use to which the corresponding aircraft may be applied.

A propulsion system may propel an aircraft in a desired direction. In selected embodiments, a propulsion system may include one or more thrustors, one or more other components as desired or necessary, and the like or sub-combination thereof and may interface with an energy-storage system via an energy-distribution system.

An energy-storage system may be or provide a reservoir of energy that may be used to power one or more thrustors. In certain embodiments, an energy-storage system may comprise one or more fuel tanks storing fuel (e.g., a hydrocarbon fuel, or hydrogen fuel). Alternatively, or in addition thereto, an energy-storage system may comprise one or more electric batteries.

A thrustor may be a system that generates thrust. In selected embodiments, a thrustor may comprise a motor, a transmission, a propulsor, and the like or a sub-combination thereof. A motor may convert one form of energy into another form of energy. For example, a motor may be an internal combustion engine that converts fuel (i.e., chemical energy) into mechanical energy. Alternatively, a motor may be an electric motor that converts electricity (e.g., electrical energy in the form of electric current) into mechanical energy.

A propulsor may be a rotary blade system that creates thrust by increasing the velocity and/or pressure of a column of air. In selected embodiments, a propulsor may further include ducting that conducts air to control and optimize the thrust, the velocity, the pressure, and sometimes the direction of the air flow. Accordingly, a propulsor may be a propeller, fan (sometimes referred to as a ducted fan), or the like.

An energy-distribution system may distribute energy from an energy-storage system to one or more thrustors. The configuration or nature of an energy-distribution system may depend on the configuration or nature of an energy-storage system. For example, when an energy-storage system comprises fuel tanks, an energy-distribution system may comprise one or more fuel lines, fuel pumps, fuel filters, and the like or a sub-combination thereof. When an energy-storage system comprises one or more batteries or generators, an energy-distribution system may comprise electrical cables, power electronics, electrical transformers, electrical switches, and the like or sub-combination thereof.

In certain embodiments, an energy-distribution system may simply distribute fuel, electrical power, and the like. For example, an energy-distribution system may conduct electrical power from one or more electric batteries, generators, or fuel cells to one or more thrustors. In other embodiments, an energy-distribution system may also convert energy from one form to another form. For example, when a propulsion system is a hybrid system, an energy-distribution system may convert fuel (i.e., chemical energy) into electricity (i.e., electrical energy) using a generator.

A transmission may interface between two rotary components. Accordingly, a thrustor transmission may conduct the mechanical energy produced by a motor to a propulsor. In certain embodiments, a transmission may simply be or comprise a drive shaft that induces one revolution of a propulsor for every revolution imposed thereon by a motor. Alternatively, a transmission may include a gear box or the like that enables the revolutions produced by a motor to be different than revolutions applied to a propulsor. Accordingly, a transmission may enable a propulsor to rotate faster or slower than a corresponding motor to provide a desired thrust, efficiency, overall performance, or the like.

A control system may control the various operations or functions of an airplane. In selected embodiments, a control system may include a power source, avionics (aviation electronics), one or more actuators, one or more other components as desired or necessary, and the like or sub-combination thereof.

A power source may supply the electrical, mechanical, hydraulic, pneumatic, or other power needed by the various other components or sub-systems within a control system. In certain embodiments, a power source may comprise one or more electric batteries.

Avionics may be or include various electrical systems supporting or enabling operation of an airplane in accordance with the present invention. In selected embodiments, avionics may include a flight-control system, one or more power-management systems, one or more communication systems, one or more other systems as desired or necessary, and the like or a sub-combination thereof.

One or more actuators may convert into action or movement one or more commands or the like communicated through or originating with the avionics. For example, one or more actuators may be positioned and connected to deploy or retract an undercarriage, manipulate the position of one or more control surfaces, deploy or retract one or more high-lift devices, adjust the pitch of various blades of one or more propulsors, or the like. In selected embodiments, one or more actuators corresponding to an aircraft may be hydraulic actuators, pneumatic actuators, electric actuators (e.g., servomotors, linear electric actuators, solenoids), or the like or a combination thereof or sub-combination thereof.

While the primary subsystems of an aircraft may be discussed as separate components or as comprising separate components, it should be understood there may be significant overlap, integration, or shared multifunction use between such subsystems, and/or the components thereof. For example, in selected embodiments, certain features within a wing may be key structural members imparting rigidity and strength to the wing and, at the same time, form ducting corresponding to one or more propulsors. Accordingly, those features may simultaneously be part of an airframe and part of a propulsion system. Similar overlap or dual function may exist between other subsystems or components of an aircraft in accordance with the present invention.

Throughout this disclosure, the preferred embodiment and examples illustrated should be considered as exemplars, rather than as limitations on the present inventive subject matter, which includes many inventions. As used herein, the term “inventive subject matter,” “system,” “device,” “apparatus,” “method,” “present system,” “present device,” “present apparatus” or “present method” refers to any and all of the embodiments described herein, and any equivalents.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

When an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the inventive subject matter. As used herein, the term “and/or” includes any and all combinations of one or more of the associated list items.

The terminology used herein is for the purpose of describing particular embodiments only and is not intended to be limiting. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the inventive subject matter.

The foregoing is intended to cover all modifications, equivalents and alternative constructions falling within the spirit and scope of the invention as expressed in the appended claims, wherein no portion of the disclosure is intended, expressly or implicitly, to be dedicated to the public domain if not set forth in the claims. Furthermore, any features, functions, steps, or elements of the embodiments may be recited in or added to the claims, as well as negative limitations that define the inventive scope of the claims by features, functions, steps, or elements that are not within that scope.

What is claimed is:

1. A tandem fixed-wing aircraft comprising:
a leading wing set and a trailing wing set, each wing set having a starboard wing and a port wing, and each wing having a wingtip,
a plurality of fixed thrustors distributed over the span of the leading wing set, and
a plurality of fixed thrustors distributed over the span of the trailing wing set.

2. The aircraft of claim 1 wherein each of the plurality of the fixed thrustors comprise a motor, a direct or indirect transmission, and a propulsor.

3. The aircraft of claim 2 wherein the motor comprises an electric motor.

4. The aircraft of claim 2 or 3 wherein each propulsor comprises a rotary blade system.

5. The rotary blade system of claim 4 comprises a ductless set of rotary blades including a propeller, a rotor, or a proprotor.

6. The rotary blade system of claim 4 comprises a ducted set of rotary blades including a ducted fan, a ducted liftfan, or a ducted proprotor.

7. The aircraft of claim 1 wherein each of the wingtips of the leading wing set is connected to a corresponding wingtip of the trailing wing set by a shared winglet.

8. The aircraft of claim 1 or 7 wherein the fixed thrustors are distributed evenly over the span of each of the wing sets.

9. The aircraft of claim 7 wherein at least one thrustor is located at each of the shared winglets.

10. The aircraft of claim 1, 7 or 9 further including a fuselage, and each wing set has two roots, wherein the fuselage is connected to each wing by the two roots.

11. The aircraft of claim 10 wherein the two roots for the leading wing set are mounted low on the fuselage along the vertical direction of the vehicle.

12. The aircraft of claim 11 wherein the two roots for the trailing wing set are mounted on the fuselage higher than the two roots of the leading wing set along the vertical direction of the vehicle.

13. The aircraft of claim 1 wherein at least one of the wing sets has at least two high-lift devices, at least one high-lift device on the starboard wing and at least one high-lift device on the port wing.

14. The aircraft of claim 13 wherein the at least two high-lift devices are mechanical devices including flaps, slats, or slots.

15. The aircraft of claim 13 wherein the at least two high-lift devices are powered lift devices.

16. The aircraft of claim 13 wherein the at least two high lift devices are at least one of blown flaps, slats, and slots.

17. The aircraft of claim 13 wherein the aircraft is a Short Take Off and Landing (STOL) type aircraft.

18. The aircraft of claim 13 wherein the aircraft is an Extreme Short Take Off and Landing (XSTOL) type aircraft.

19. The aircraft of claim 13 wherein the aircraft is a Vertical Take Off and Landing (VTOL) type aircraft.

20. The aircraft of claim 19, wherein the aircraft is configured to hover using one or more of the fixed thrustors.

21. The aircraft of claim 13 wherein the aircraft is a Short Take Off and Vertical Landing (STOVL) type aircraft.

22. The aircraft of claim 1, 4 or 8 wherein the fixed thrustors of the leading wing set and the fixed thrustors of the trailing wing set provide differential thrust and induced lift for providing pitch control and stability to the aircraft.

23. The aircraft of claim 1, 4 or 8 wherein the fixed thrustors of the leading wing set and the fixed thrustors of the trailing wing set provide differential torque for roll control and stability to the aircraft.

24. The aircraft of claim 9 wherein the wingtip thrustors provide differential thrust for providing yaw control and stability to the aircraft.

25. The aircraft of claim 1 or 8 wherein the fixed thrustors of the leading wing set and the fixed thrustors of the trailing wing set provide differential thrust and induced lift for providing roll control and stability to the aircraft.

26. The aircraft of claim 9, 22, 23 or 24 wherein the wingtip thrustors provide differential thrust to prevent the aircraft from skidding or slipping during a coordinated turn.

27. The aircraft of claim 22, 23, 24, 25 or 26 including a control system, the control system further controlling an amount of thrust and induced lift produced by each of the plurality of thrustors.

28. The aircraft of claim 27 wherein the control system further controls the directions of thrust and induced lift produced by each of the plurality of thrustors.

29. The aircraft of claim 28, wherein the directions of thrust and induced lift enable the aircraft to move in two-dimensional and three-dimensional directions.

30. The aircraft of claim 27, 28, or 29 wherein at least one of the plurality of thrustors comprises an electric motor and the control system controls an amount of electric current provided to each of the plurality of thrustors.

31. The aircraft of claim 27, 28, or 29, wherein at least one of the plurality of the thrustors includes a propulsor comprising a rotary blade system, the control system capable of varying the propulsor's blade pitch angle in the at least one of the plurality of thrustors.

32. The aircraft of claim 27, 28, 29, 30, or 31 wherein at least one of the plurality of the thrustors includes a propulsor comprising a ducted system and the control system capable of varying the geometry of the inlet or the exhaust of the propulsor's ducting for the at least one of the plurality of thrustors.

33. The aircraft of claim 32 wherein the control system uses thrust vectoring by vectoring surfaces of the propulsor's ducting for at least one of the plurality of thrustors.

34. The aircraft of claim 9, 27, 28, 29, or 30 wherein the control system uses thrust vectoring by 3D-vectoring the wingtip thrustors or their propulsors.

35. The aircraft of claim 9, 27, 28, 29, or 30 wherein at least one propulsor is gimbal-mounted and the control system uses thrust vectoring by 3D-vectoring the at least one gimbal-mounted propulsor.

36. The aircraft of claim 9, 27, 28, 29, or 30 wherein at least one propulsor is capable of 2D rotation on its lateral axis and the control system uses thrust vectoring by 2D-vectoring the at least one propulsor.

37. The aircraft of claim 35 wherein the control system uses 3D thrust vectoring by a gimbal-mounted propulsor for each of the wingtip thrustors.

38. The aircraft of claim 36 wherein the control system uses 2D thrust vectoring for each of the wingtip thrustors.

39. The aircraft of claim 30 further including a combustion engine for converting fuel chemical energy into mechanical shaft rotational motion, and an electric generator for converting the mechanical shaft rotational motion into electric power to be used in each of the thrustors.

40. The aircraft of claim 30 further including a hydrogen fuel cell system to convert the chemical energy of hydrogen fuel into electric current to be used in each of the thrustors.

41. The aircraft of claim 39 wherein the combustion engine is a turbine, an internal combustion reciprocating piston engine, or an internal combustion rotary Wankel engine.

42. The aircraft of claim 30, 39, 40, or 41 further including at least one rechargeable battery for storing and delivering electric power.

43. A tandem fixed-wing aircraft comprising:
a leading fixed wing set and a trailing fixed wing set, each wing set having a starboard wing and a port wing;
a plurality of fixed thrustors distributed over the span of the leading wing set; and
a plurality of fixed thrustors distributed over the span of the trailing wing set, wherein the aircraft is configured to hover-in-place using lift from the leading and trailing fixed wing sets.

44. The aircraft of claim 43, wherein at least one of the leading fixed wing set and trailing fixed wing set includes a high-lift device.

45. The aircraft of claim 44, wherein the high-lift device is at least one of a flap, slat, and slot.

46. The aircraft of claim 43, wherein each wing has a wingtip, and the aircraft further comprises at least one fixed thrustor coupled to each wingtip, and further wherein the at least one fixed thrustor is configured to generate reverse thrust.

47. The aircraft of claim 43 or 46, wherein the plurality of fixed thrustors provide differential thrust, thereby enabling control and stability in three dimensions.

48. The aircraft of claim 43, 44, 45, 46, or 47, wherein the lift from the leading and trailing fixed wing sets used for the hover-in-place is generated by slipstream deflection from the fixed thrustors.
